(19) United States
(12) Patent Application Publication
(10) Pub. No.: US 2015/0130749 A1
(43) Pub. Date: May 14, 2015

(54) TOUCH PAD, CORRESPONDING TOUCH POSITION DETERMINING UNIT AND ASSCOCIATED METHOD

(71) Applicant: Ronald Peter Binstead, Nottingham (GB)

(72) Inventor: Ronald Peter Binstead, Nottingham (GB)

(21) Appl. No.: 14/398,373

(22) PCT Filed: May 2, 2013
(86) PCT No.: PCT/GB2013/051154

§ 371 Date: Oct. 31, 2014

(30) Foreign Application Priority Data
May 2, 2012 (GB) 1207712.9
Aug. 17, 2012 (GB) 1214682.5

(51) Int. Cl. G06F 3/044; G06F 3/041

(52) U.S. Cl. CPC G06F 3/044; G06F 3/0416; G06F 2203/04104
USPC 345/174

(57) ABSTRACT

The disclosure relates to a touch pad and a corresponding touch position determining unit (TPDU). The touch pad comprises a plurality of sensing elements that each extend in a first direction and are displaced from one another in a second direction, wherein the plurality of sensing elements is provided in a single layer. The TPDU comprises a sensing element configured to present an electrical property associated with one or more touch properties of one or more fingers along a length of the sensing element, the TPDU configured to: set an attenuation setting to a plurality of different attenuation settings; generate a plurality of touch signals, wherein each of the plurality of touch signals is generated in accordance with the electrical property at a different attenuation setting; and determine the one or more touch properties using the plurality of touch signals.

The invention relates to touch pads, and to touch pads and corresponding touch position determining units in particular.

Touch pads, which may also be referred to as touch screens or touch sensors, that use multiplexed arrays of horizontal and vertical sensor elements, are known as described in U.S. Pat. No. 6,137,427 (Binstead), for example. Such touch sensors work well with one finger operation, where one peak is identified by elements in the horizontal direction (x) and one peak is identified in the vertical direction (y). Self-capacitive and mutual capacitive systems are known in the art. The mutual capacitive technique readily lends itself to the detection of many fingers at the same time.

A touch pad may be provided using wire or indium tin oxide (ITO) sensing elements. The manufacture of ITO self-capacitive touch pads can be complicated by the need for multiple, isolated conductive layers, for example one layer comprising a series of conductors in an ‘x’ direction and another in the ‘y’ direction. The requirement to provide two crossing elements also complicates the design of touch pads implemented using wires due to the possible shorting of wires where they cross over each other.

The relatively high resistance of ITO compared to metal wires can restrict the maximum possible size of an ITO touch screen. Usually, sensing elements have to be less than about 10,000 ohms, otherwise some parts of the touch screen become much less sensitive than other parts

According to a first aspect of the invention there is provided a touch pad for detecting a position of a finger disposed at a touch position, the touch pad comprising a plurality of sensing elements that each extend in a first direction and are displaced from one another in a second direction, wherein the plurality of sensing elements is provided in a single layer.

Embodiments of the present invention can be used to determine the two dimensional position of a touch on the surface of the touch screen using only one layer of sensor elements. Providing a sensor with such functionality, but that only occupies a ‘x’ layer, without the requirement for a ‘y’ layer, greatly simplifies the touch pad manufacture process. Some embodiments of the present invention relate to a capacitive system that overcomes the above problem of prior art systems by eliminating the need for cross-over points. This advantage can be achieved by providing elements in a single layer, or by using sensing elements that all extend only in a single direction (the x direction). Such embodiments make use of the resistivity of the sensing element material to determine the position of one or more fingers, along the length of the sensing element, thereby eliminating the need for sensing elements in the y direction.

The touch pad may be a self-capacitive touch pad. The plurality of sensing elements may be the only sensing elements of the touch pad. Each sensing element may be configured to present an electrical property indicative of a first direction coordinate of the touch position when that element is proximal to the touch position. The electrical property may be an impedance of the respective sensing element. The first direction may be perpendicular to the second direction. The plurality of sensing elements may be associated with a single second direction coordinate of the touch position. The plurality of sensing elements may each be displaced from one another in the second direction along an entirety of their length in the first direction. Each sensing element may be configured to present an electrical property in accordance with a plurality of touch positions, each touch position associated with a different finger. The plurality of sensing elements may each be electrically conductive. The plurality of sensing elements may each have a minimum electrical resistance of 10, 100 or 1000 ohms along its length in the first direction. The plurality of sensing elements may have an insulating coating. The touch pad may comprise one or more shielding elements that each extend in the first direction and are disposed between the plurality of sensing elements. The one or more shielding elements may be coupled to ground, a fixed potential, an active backplane signal or an anti-active back plane signal. One or more of the sensing elements may comprise, or can alternately act as, a shielding element. Each of the plurality of sensing elements may be arranged with no electrical connection at an extremity in the first direction. Each of the plurality of sensing elements may be arranged to be connected to a fixed potential, a varying potential or ground at an extremity in the first direction. Each of the plurality of sensing elements may comprise a wire, fibre, bar, rod, gel, plastic, rubber, metal film, printed track, metal oxide layer such as indium tin oxide, graphene, an individual carbon fibre, or any mixture of these. The plurality of sensing elements may comprise one or more emitting elements for a mutual capacitance circuit. Each emitting element may be configured to capacitively transmit a signal to a sensing element proximal to that emitting element. The sensing elements may comprise shielding elements. The transmitting elements may have a lower resistivity than the sensing elements.

According to a further aspect of the invention there is provided a touch pad for detecting a position of a finger disposed at a touch position, the touch pad being self-capacitive, comprising a single electrically conductive sensing element which extends in a first direction and has a minimum electrical resistance of 10 ohms along its length in the first direction.

According to a further aspect of the invention there is provided a touch pad for detecting a position of a finger disposed at a touch position, the touch pad being self-capacitive, comprising a single electrically conductive sensing element which extends in a first direction and has a minimum electrical resistance of 10 ohms along its length in the first direction, which is sensed from both ends alternately.

According to a further aspect of the invention there is provided a touch pad for detecting a position of a finger disposed at a touch position, the touch pad being self-capacitive, comprising a single electrically conductive sensing element which extends in a first direction and has a minimum electrical resistance of 10 ohms along its length in the first direction, which is sensed from both ends alternately, the end not being sensed being connected to an active backplane signal through a resistor.

According to a further aspect of the invention there is provided a touch pad for detecting a position of a finger disposed at a touch position, the touch pad being self-capacitive, comprising a single electrically conductive sensing element which extends in a first direction and has a minimum electrical resistance of 10 ohms along its length in the first direction, which is sensed from both ends alternately, the end not being sensed being connected to ground through a resistor.

According to a further aspect of the invention there is provided a touch pad for detecting a position of a finger disposed at a touch position, the touch pad being self-capacitive, comprising a single electrically conductive sensing element which extends in a first direction and has a minimum electrical resistance of 10 ohms along its length in the first direction, which is sensed from both ends alternately, the end not being sensed being left electrically floating.

A touchpad may be provided with the means to calculate the position of a finger by comparing the ratio of the results from measurements taken at both ends of the sensing element.

According to a further aspect of the invention there is provided a touch position determining unit, TPDU, for a touch pad comprising a sensing element configured to present an electrical property associated with one or more touch properties of one or more fingers along a length of the sensing element, the TPDU configured to:

set an attenuation setting to a plurality of different attenuation settings;

generate a plurality of touch signals, wherein each of the plurality of touch signals is generated in accordance with the electrical property at a different attenuation setting; and

determine the one or more touch properties using the plurality of touch signals.

The touch properties may comprise the position and/or strength of the one or more touches. The TPDU can enable a touch pad comprising only a single layer of rows of sensing elements to be used to determine a touch position in 2 dimensions (or 3 dimensions, if the touch strength is considered). The TPDU therefore enables the provision of a simplified touch pad.

The touch pad or the TPDU may comprise a variable resistance unit. Each attenuation setting may be associated with a resistance setting of the variable resistance unit.

The TPDU may be configured to generate a background touch signal when no finger is present for each attenuation setting. The TPDU may be configured to calculate a corrected touch signal using the background touch signal associated with the respective attenuation setting for each touch signal. The TPDU may be configured to determine the touch property using the corrected touch signals. The TPDU may be configured to store the background touch signals and/or periodically update the background touch signals.

Each touch property may comprise a touch position. The TPDU may be configured to determine the presence of a plurality of touch positions of the one or more fingers by comparing the corrected touch signals with each other. The TPDU may be configured to determine the number of touch positions of the one or more fingers by comparing a first differentiation of the touch signal, or corrected touch signal, with respect to resistance setting, dS/dR, at different resistance settings. The TPDU may be configured to determine each touch position by interpolating or extrapolating the resistance setting at which functions associated with two different signal strength against resistance settings meet. The TPDU may be configured to calculate or look-up touch position values associated with the resistance settings at which the functions meet. The functions may be linear functions plotted using touch signal, attenuation setting coordinates. The TPDU may be configured to determine a number of touch positions of the one or more fingers by identifying the number of resistance settings where the second differentiation of the touch signal, or corrected touch signal, with respect to the change in resistance setting, d²S/dR², is above a threshold. The TPDU may be configured to determine the one or more touch positions using the plurality of touch signals by calculating or looking-up touch positions associated with each of the resistance settings at which d²S/dR² is above the threshold.

Each touch property may comprise a touch strength. The TPDU may be configured to determine each touch strength of the one or more fingers using the plurality of touch signals and associated resistance settings. Each touch strength may be proportional to the first differentiation of the touch signal, or corrected touch signal, with respect to resistance setting, dS/dR, at a resistance setting associated with the corresponding touch position.

The sensing element may be resistive. The TPDU may be configured to, when a finger is touching the sensing element at a single touch position, determine a null resistance setting for the touch position. The null resistance setting may be the resistance setting at which the associated touch signal is substantially equal to the background, or “no touch”, touch signal. The TPDU may be configured to calculate or look-up a touch position associated with the null resistance setting.

The TPDU may comprise a touch signal generator configured to generate the plurality of touch signals. The touch signal generator may have an input coupled to the sensing element to detect the electrical property. The variable resistance unit may be coupled between the sensing element and the input of the touch signal generator or on a feedback path between the input and an output of the touch signal generator. The touch signal generator may comprise a touch signal oscillator with an input that is coupled to the sensing element. The touch signal oscillator may be configured to output the touch signal having a frequency in accordance with the electrical property and/or to determine the touch position using the frequency of the touch signal oscillator. The electrical property may be an impedance of the sensing element. The touch signal generator may comprise a fixed time voltage charging circuit with an input that is coupled to the sensing element. The charging circuit may be configured to output the touch signal having a voltage in accordance with the electrical property after a fixed charging time. The electrical property may be a resistive/capacitive time constant of the sensing element.

The touch signal generator may comprise a variable time voltage charging circuit with an input that is coupled to the sensing element, the charging circuit configured to output the touch signal having a charging time in accordance with the electrical property. A variable time voltage charging circuit may be referred to as a time domain measurement circuit. The electrical property may relate to the time taken to charge the sensing element to a predetermined voltage. The touch signal generator may comprise a current source oscillator with an output that is coupled to the sensing element. The touch signal generator may be configured to measure an electrical property related to the capacitance of the sensing element.

The electrical property of the sensing element may be presented at one of a plurality of connection points that are each disposed at different positions along the length of the sensing element, such as at two opposing ends of the sensing element. Each attenuation setting may be associated with one of the connection points. The TPDU may be configured to set the attenuation setting to a plurality of different attenuation settings by selecting a different connection point or a plurality of different connection points.

The TPDU may be configured to set the attenuation setting to a plurality of different attenuation settings by selecting a different connection point and/or a different resistance setting. The TPDU may comprise a multiplexer configured to selectively couple the input of the touch signal generator to one or more of the plurality of connection points. The multiplexer may be configured to couple a subset of the plurality of connection points which are not selectively coupled to the input of the touch signal generator to ground or to an active back plane signal. The touch pad may comprise a plurality of sensing elements. Each sensing element may be configured to present an electrical property associated with one or more touch positions of one or more fingers along a length of that sensing element. The TPDU may be configured to set the attenuation setting to a plurality of different attenuation settings for each of the plurality of sensing elements. The TPDU may be configured to generate a plurality of touch signals for each of the plurality of sensing elements.

According to a further aspect of the invention there is provided a method of determining the touch position one or more touch positions of one or more fingers along a length of a sensing element of a touch pad that is configured to present an electrical property associated with the one or more touch positions, the method comprising:

setting an attenuation setting of the touch pad to a plurality of different attenuation settings;

generating a plurality of touch signals, wherein each of the plurality of touch signals is generated in accordance with the electrical property at a different attenuation setting; and

determining the one or more touch positions using the plurality of touch signals.

According to a further aspect of the invention there is provided a touch pad device comprising a touch pad and a TPDU.

According to a further aspect of the invention there is provided a touch pad device comprising a TPDU and a sensing element configured to present an electrical property associated with a touch position of a finger along a length of the sensing element.

The touch pad device may be a self-capacitive touch pad device or a mutual-capacitive touch pad device. The touch pad device may be a self-capacitive touch pad device during a first period and a mutual-capacitive touch pad device during a second period. The touch pad device may have a first set of elements that are self-capacitive and a second set of elements that are mutual-capacitive.

Embodiments of the invention may be better understood by reference to the following examples. The examples illustrated in the figures relate to capacitive touch sensors using projected capacitance and self capacitance techniques.

Examples of the invention will now be described with reference to the figures, in which:

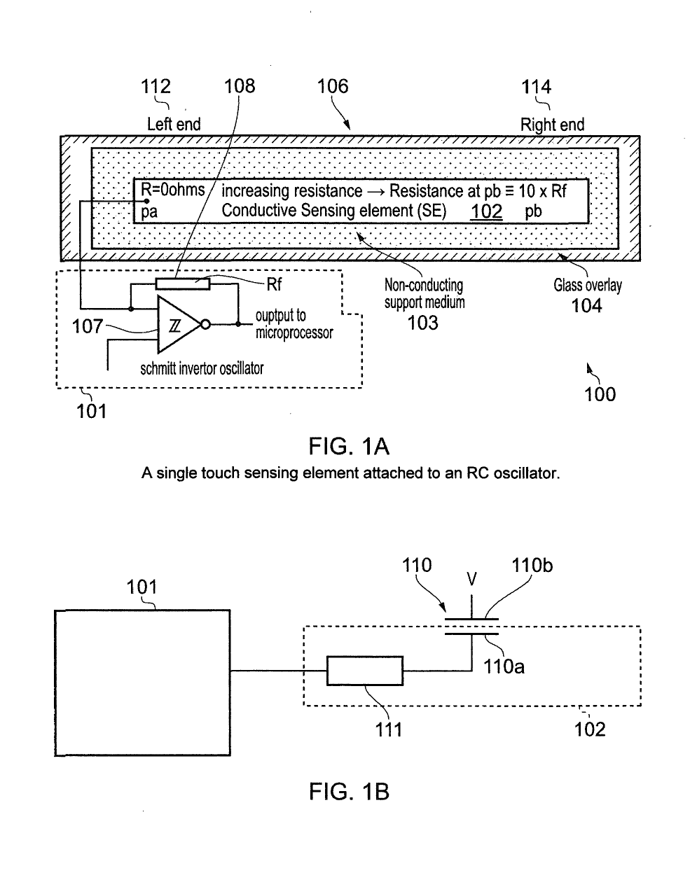

FIG. 1A illustrates a schematic for a touch pad comprising a touch pad detection unit and a sensing element;

FIG. 1B illustrates an alternative representation of the touch pad of FIG. 1a where a finger is present in close proximity to the sensing element;

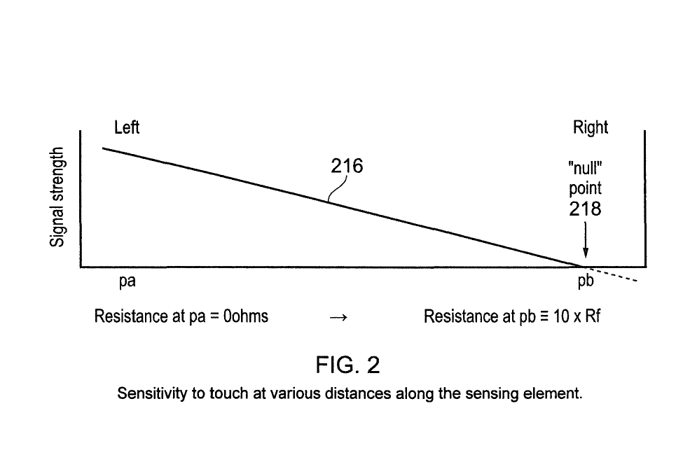

FIG. 2 illustrates a touch signal output by the touch detection unit of FIG. 1 plotted as a function of position along the sensing element;

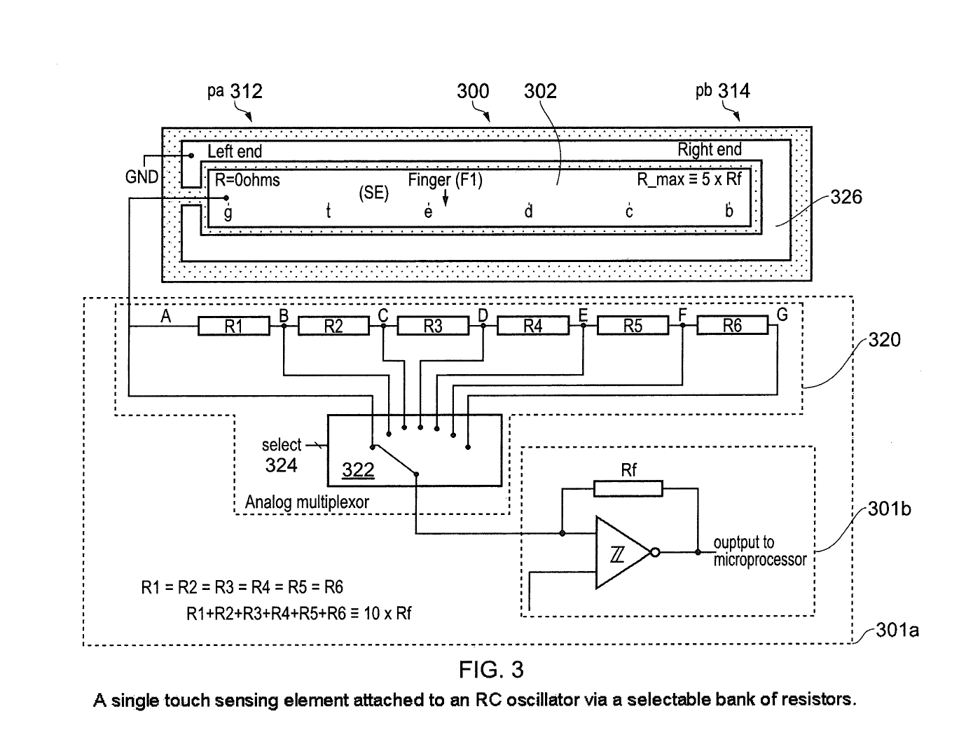

FIG. 3 illustrates an improved touch pad comprising a touch pad position determining unit (TPDU) and a sensing element;

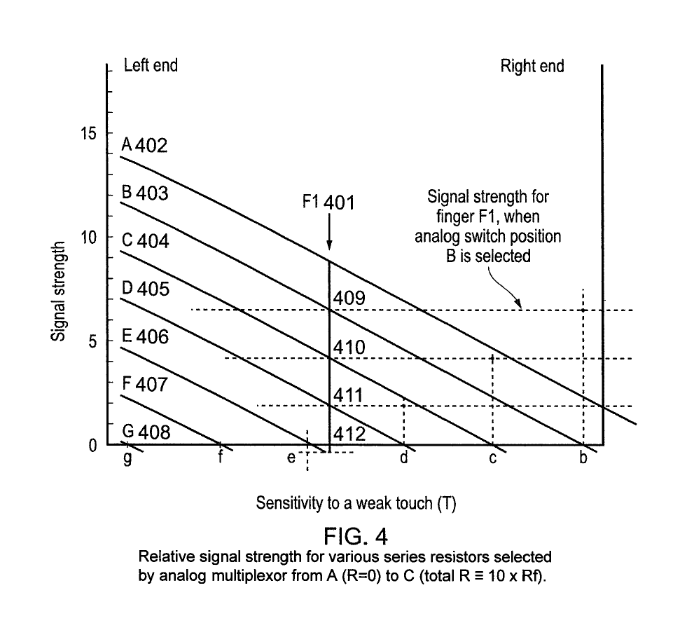

FIG. 4 illustrates a touch signal output by the TPDU of FIG. 3 plotted as a function of position of a “weak” finger touch along the sensing element for a number of different settings of the TPDU, one example of a weak finger touch being shown by finger F1;

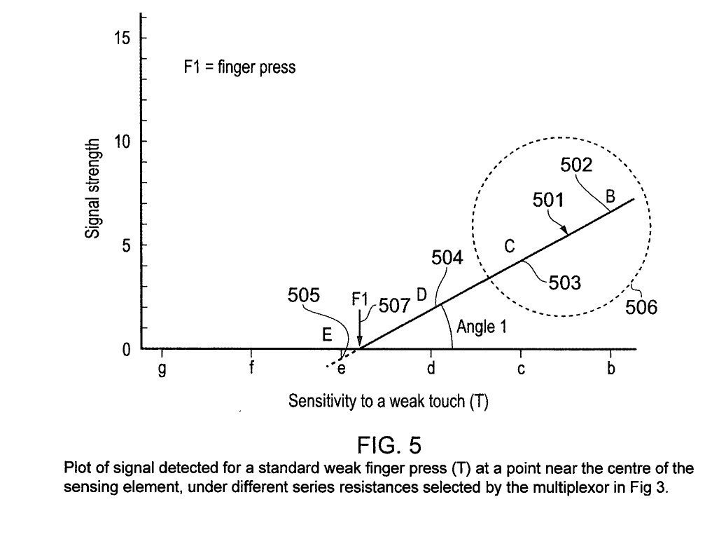

FIG. 5 shows how the data of FIG. 4 may be transposed to produce a graph that intersects the position where no signal is detected;

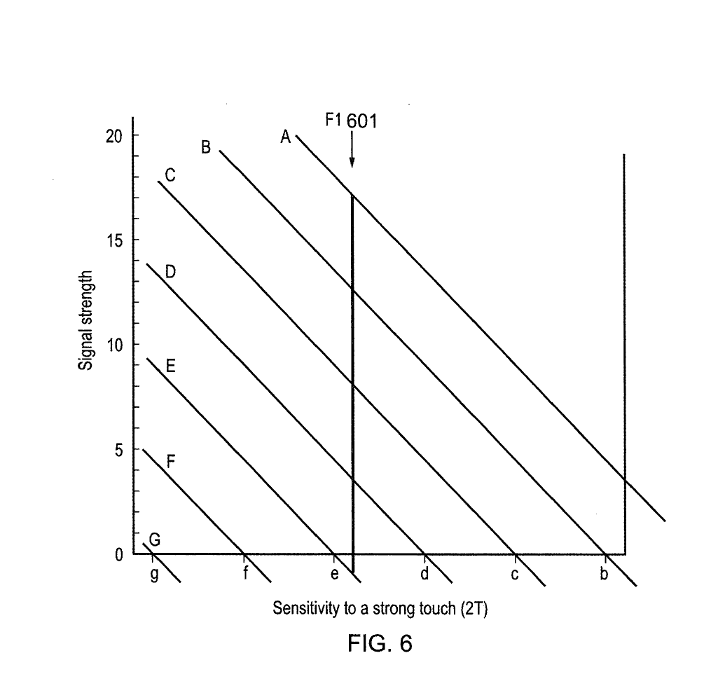

FIG. 6 illustrates a profile of the type illustrated in FIG. 4 for a strong touch;

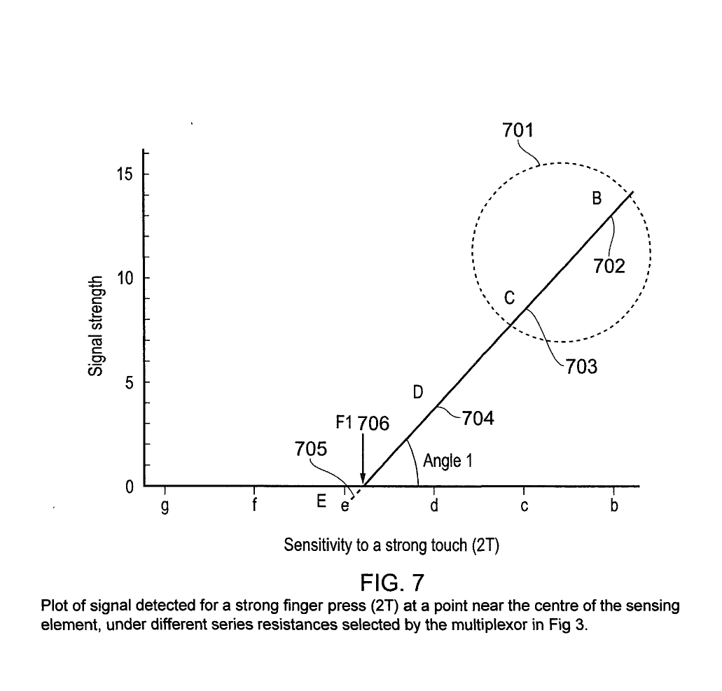

FIG. 7 illustrates a profile related to a “strong” touch of a finger F1 for a number of different settings of the TPDU shown in FIG. 6;

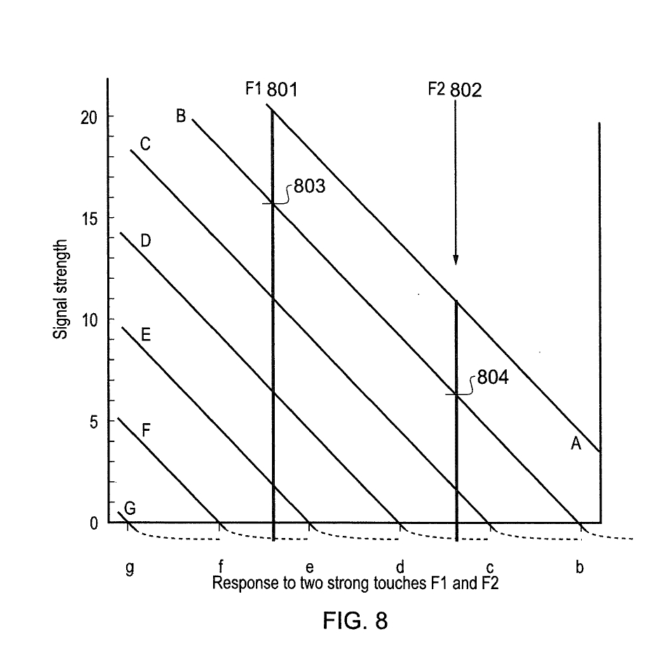

FIG. 8 illustrates a profile of the type illustrated in FIG. 6 for two fingers, F1 and F2, touching the sensing element with a strong touch;

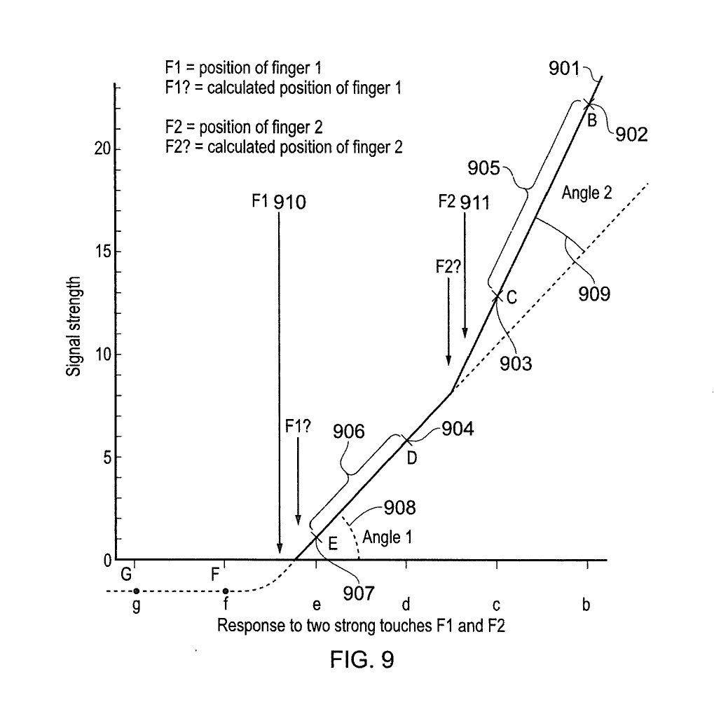

FIG. 9 illustrates a profile produced by the two fingers F1 and F2 for a number of different settings of the TPDU as shown in FIG. 8;

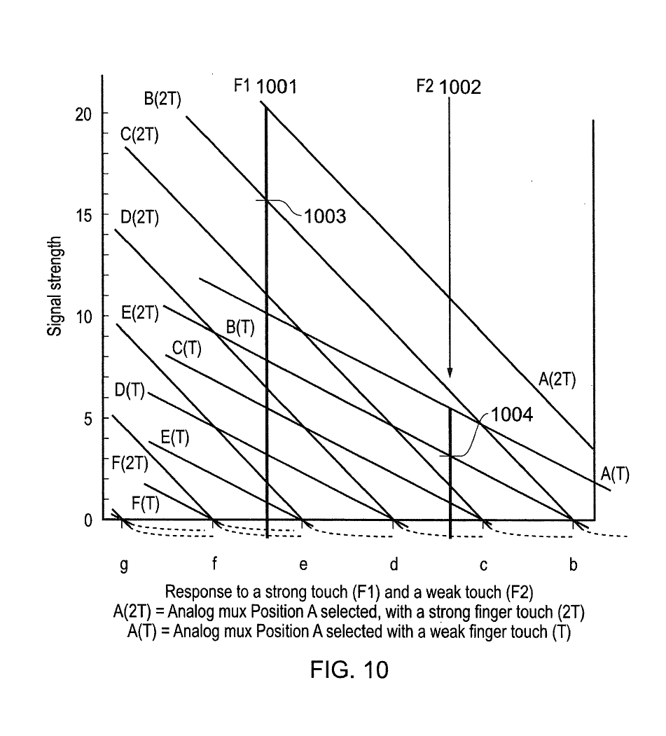

FIG. 10 illustrates a representation of a complex touch signal output by the TPDU when simultaneously presented with two fingers F1 and F2, one strong (F1) near to the sensing input of the sensing element, and one weak (F2) at the far end of the sensing element;

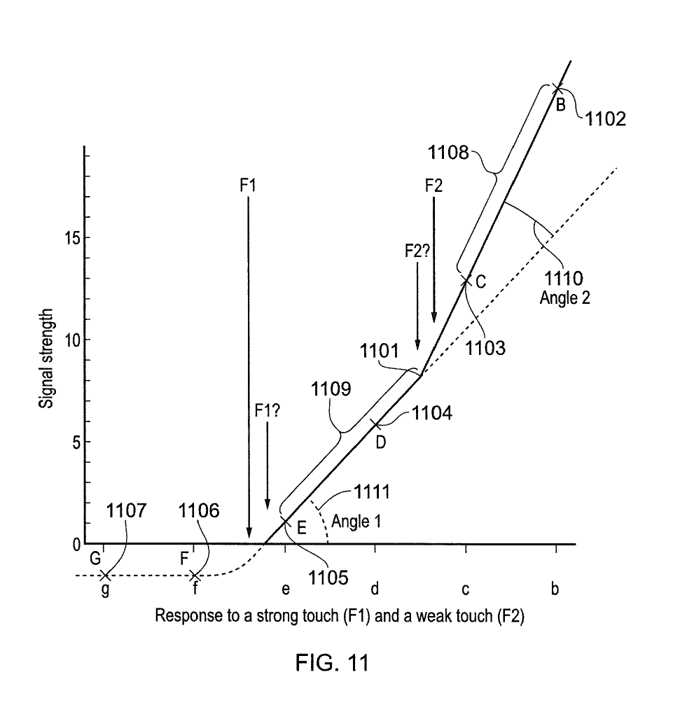

FIG. 11 illustrates the touch signal output by a TPDU for the two fingers (F1, F2) of FIG. 10;

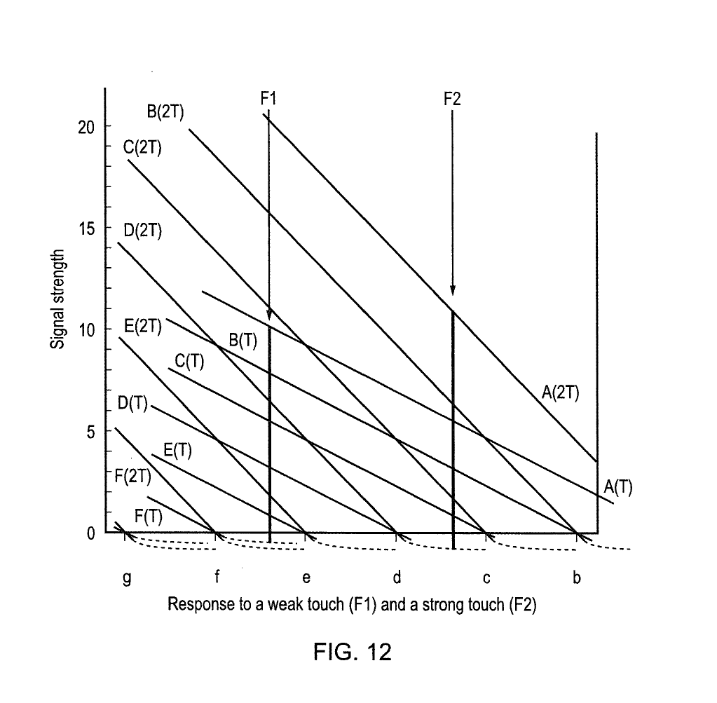

FIG. 12 illustrates a representation of a complex touch signal output by the TPDU when simultaneously presented with two fingers, one weak (F1) near to the sensing input of the sensing element, and one strong (F2) at the far end of the sensing element;

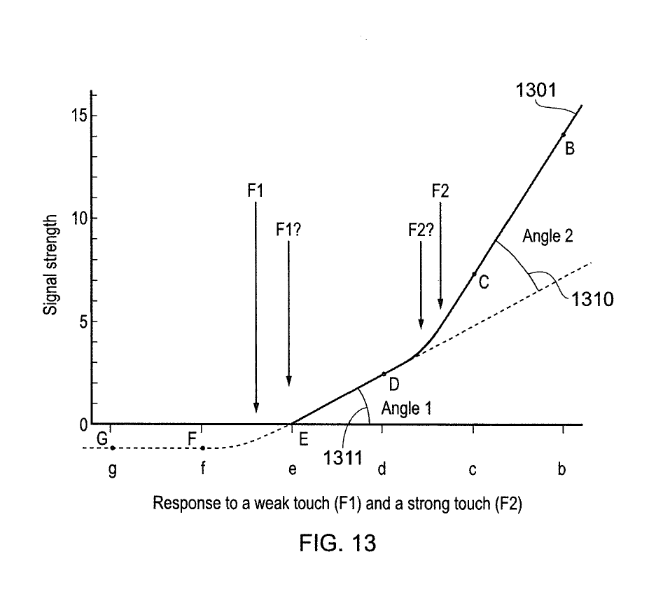

FIG. 13 illustrates the touch signal output by a TPDU for the two fingers (F1, F2) of FIG. 12;

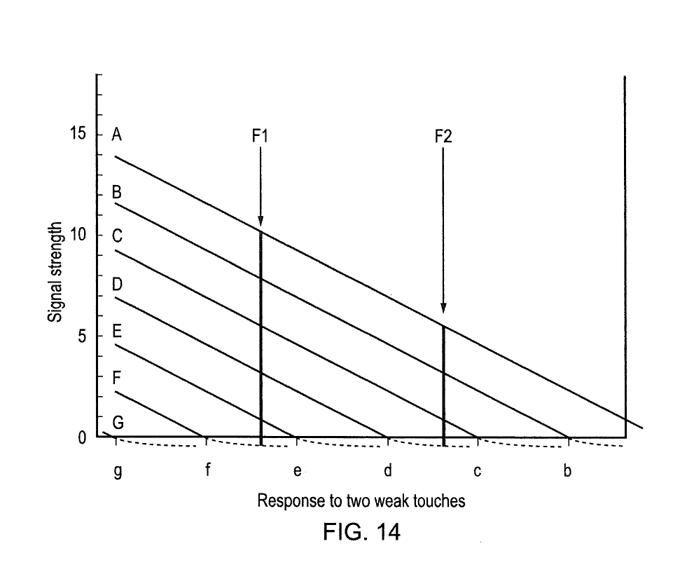

FIG. 14 shows the strength of a touch signal produced by a TPDU, under different resistor settings, by two weak finger touches F1 and F2;

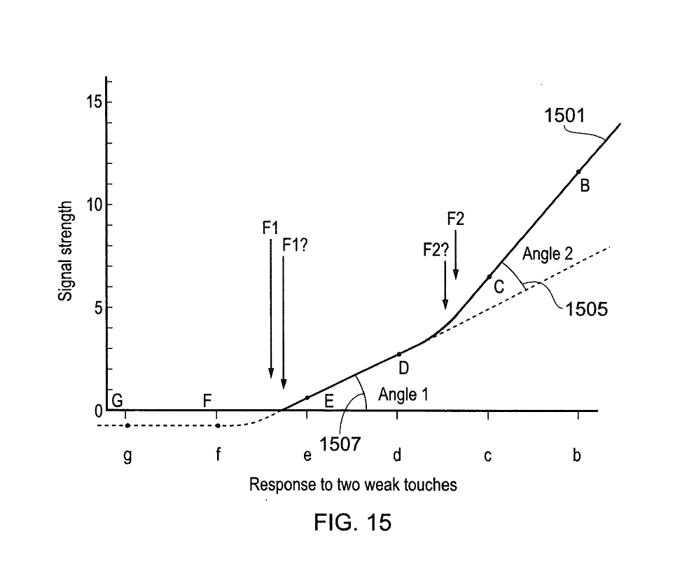

FIG. 15 shows the additive effect of the touch signals produced by the fingers F1 and F2 in FIG. 14;

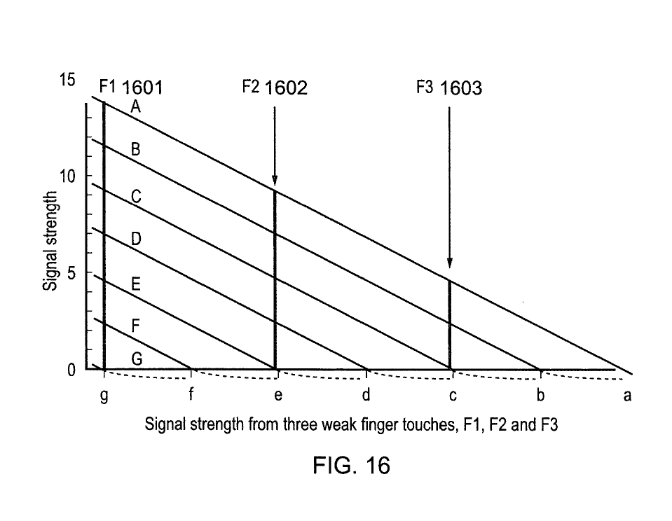

FIG. 16 shows the strength of signal produced by a TPDU at various different resistor settings by three weak finger touches F1, F2 and F3;

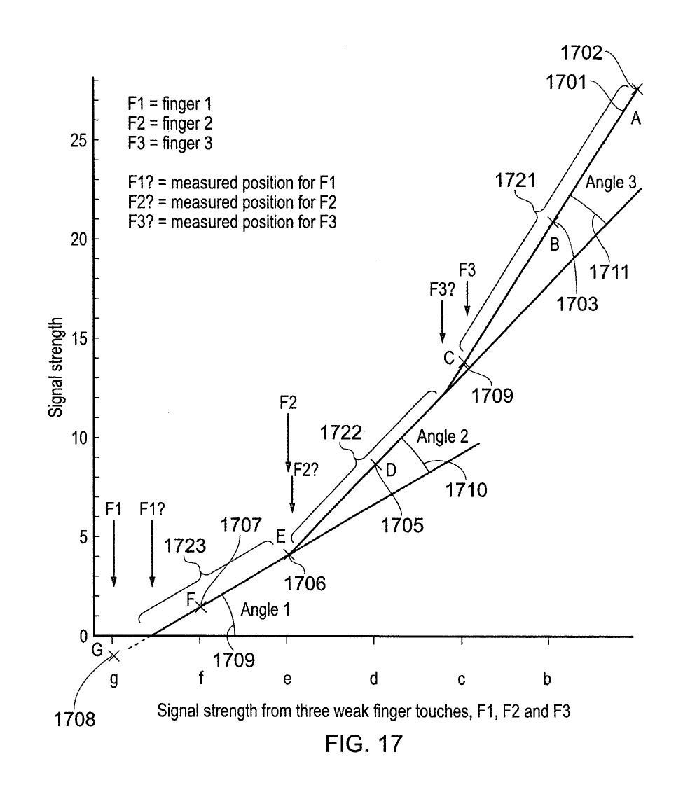

FIG. 17 shows the additive effect of the touch signals produced by fingers F1, F2 and F3 in FIG. 16;

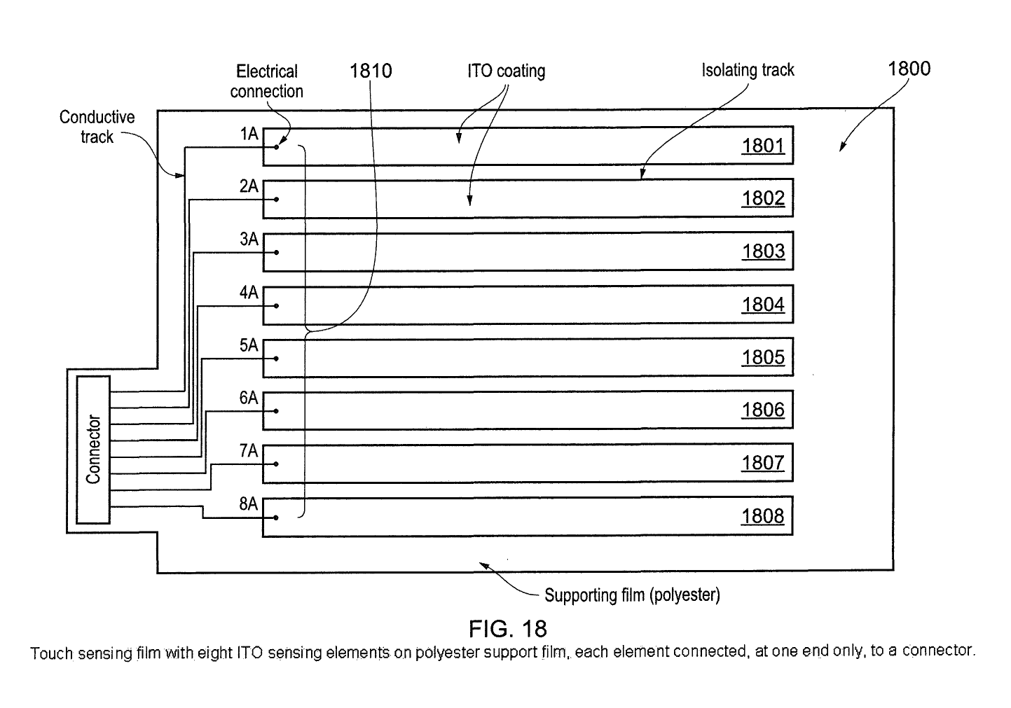

FIG. 18 illustrates a touch sensor suitable for use with a touch pad;

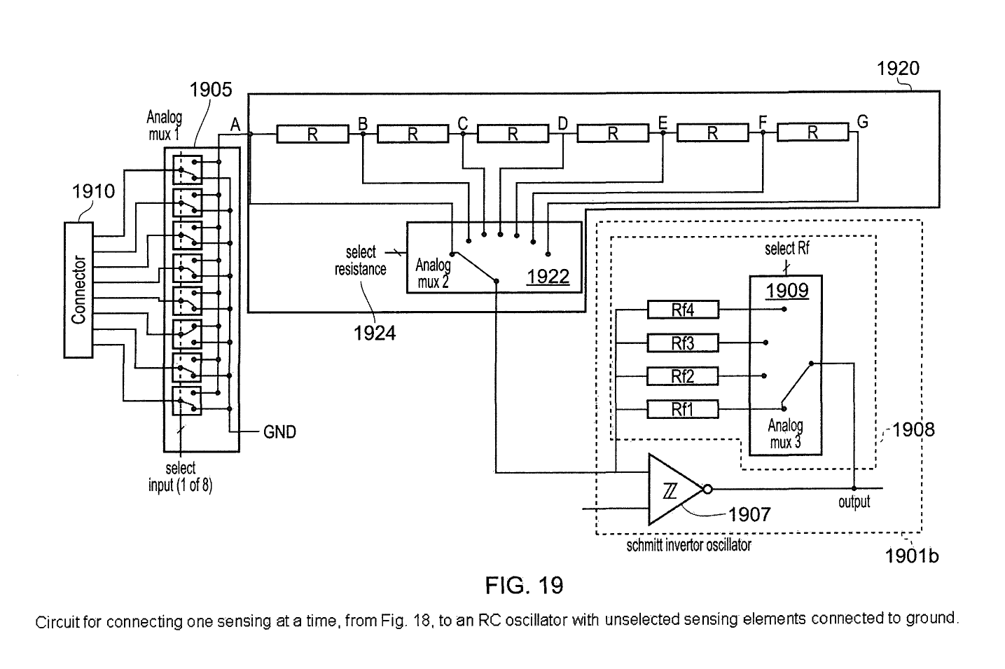

FIG. 19 illustrates an improved touch position detection unit (TPDU) suitable for use with the touch sensor of FIG. 18;

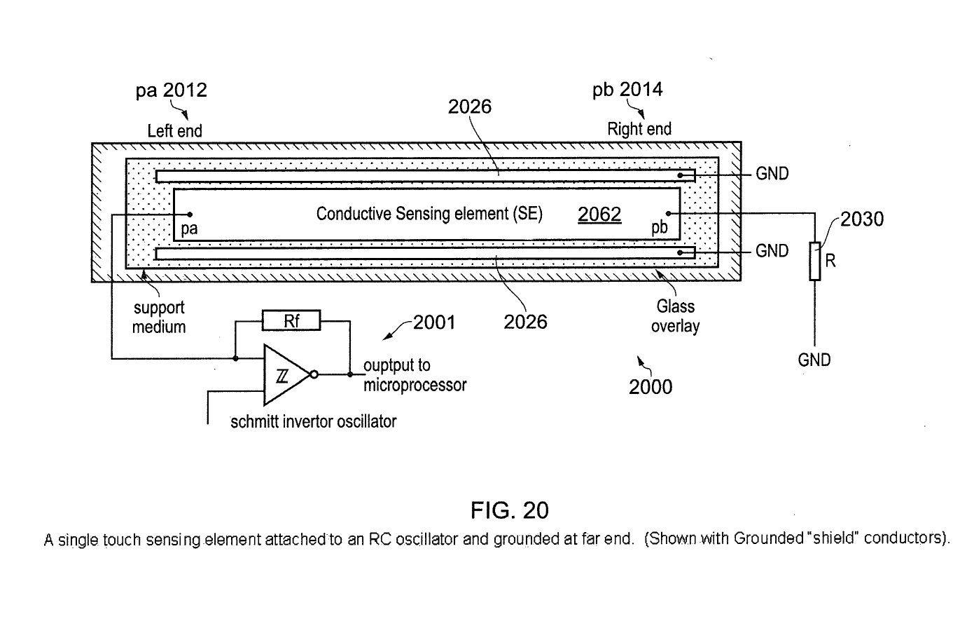

FIG. 20 illustrates a touch pad where a “non-sensing” end of the sensing element is connected to ground through a resistor;

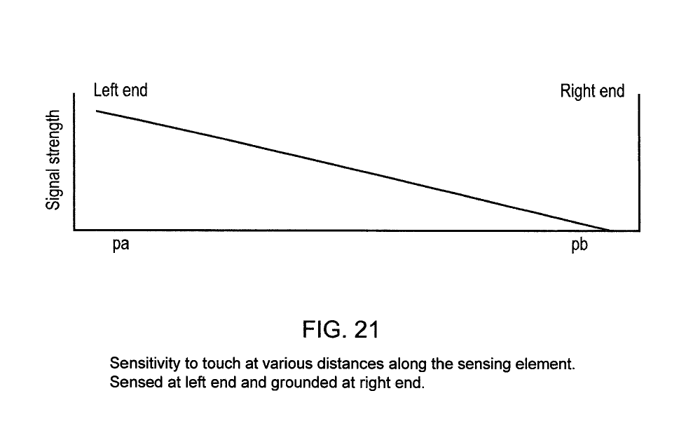

FIG. 21 illustrates a profile of the type illustrated in FIG. 2 for the system of FIG. 20;

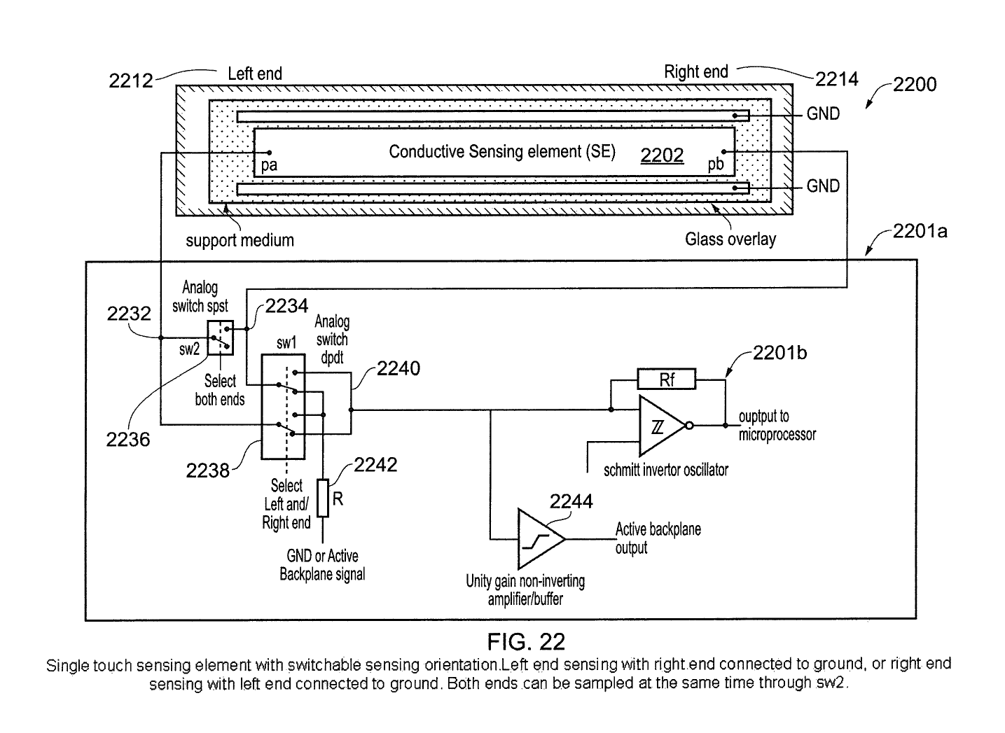

FIG. 22 an improved touch pad comprising a sensing element with connections to a TPDU at both ends of the sensing element;

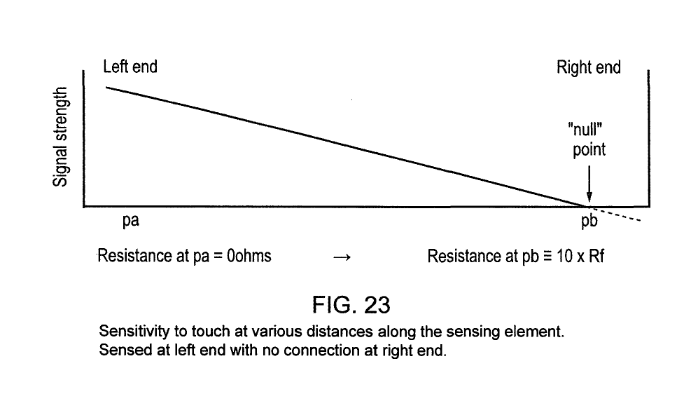

FIG. 23 illustrates a profile of the type illustrated in FIG. 2 for the system of FIG. 22;

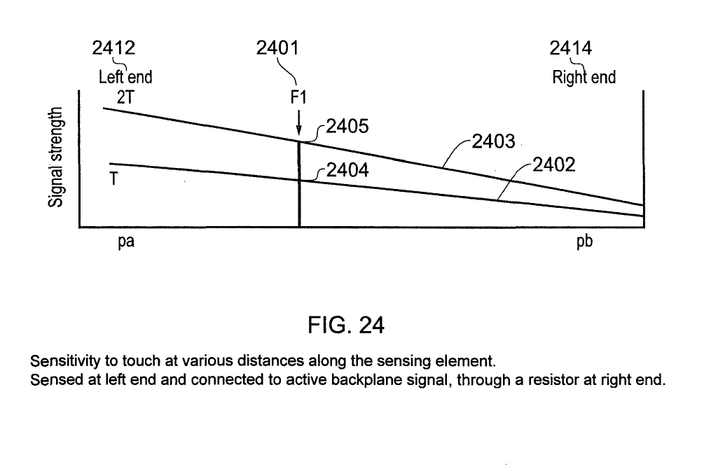

FIG. 24 illustrates a profile of the type illustrated in FIG. 2 for the system of FIG. 22 measured from the left end of the sensing element, with signal strength shown for a weak touch (T) and a strong touch (2T);

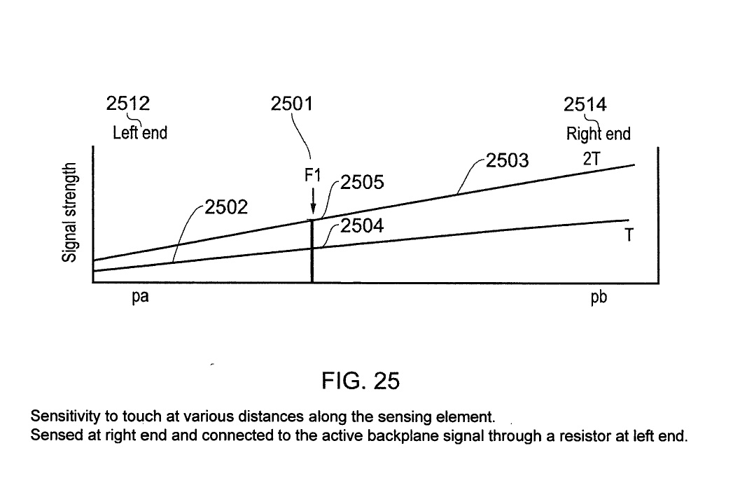

FIG. 25 illustrates a profile of the type illustrated in FIG. 2 for the system of FIG. 22 measured from the right end of the sensing element, with signal strength shown for a weak touch (T) and a strong touch (2T);

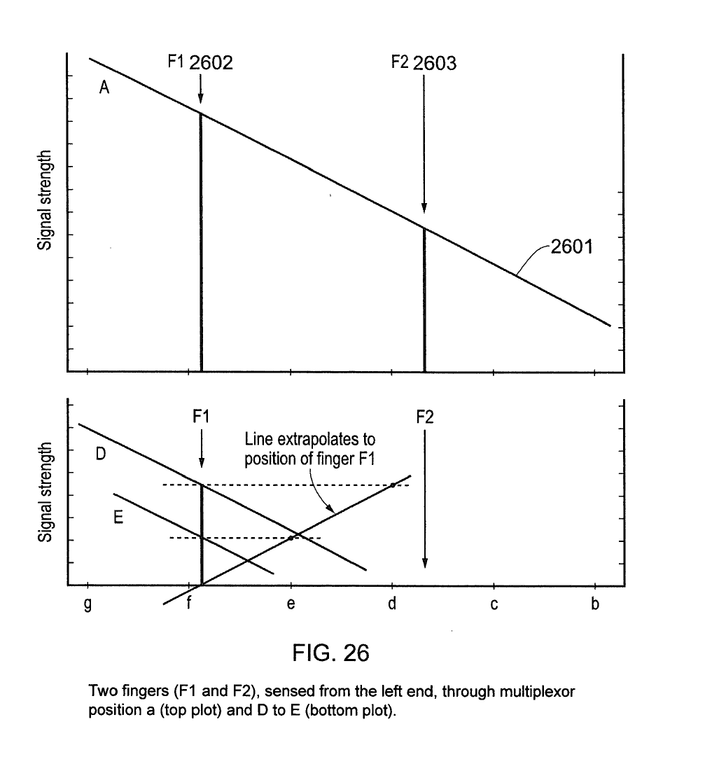

FIG. 26 illustrates how, when sensed from the left end, different settings of the TPDU can be used sequentially to mask out the second finger (F2), which is detectable when the TPDU is set to position A, (top graph) but undetectable when set to position D (bottom graph);

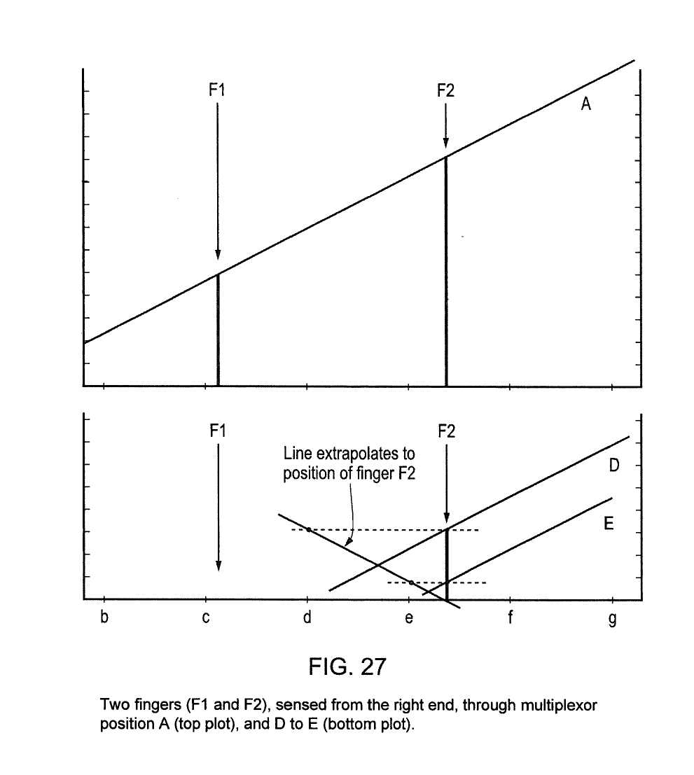

FIG. 27 illustrates how different settings of the TPDU, when sensed from the right end, can be used sequentially to mask out the first finger (F1), which is detectable when the TPDU is set to position A, (top graph) but undetectable when set to position D (bottom graph);

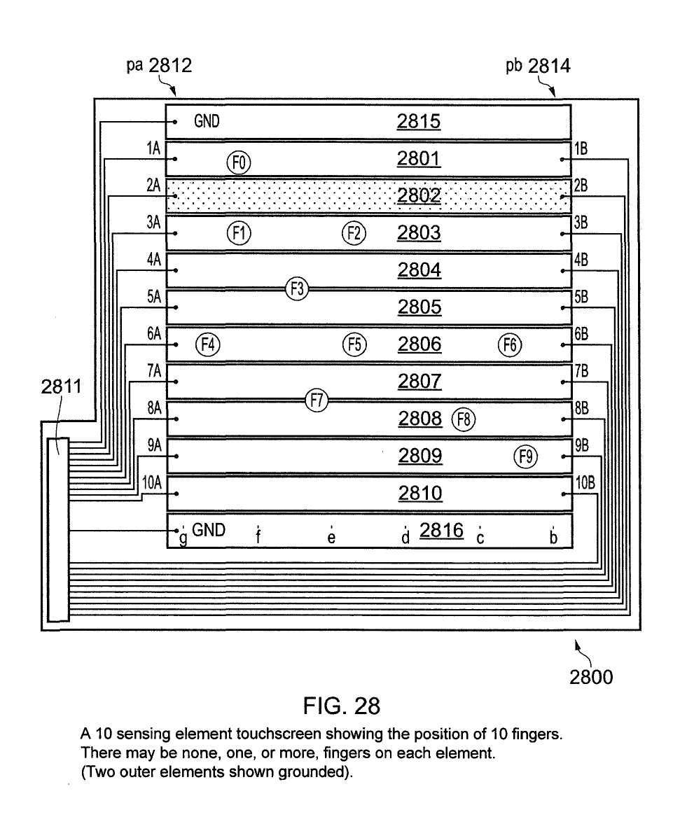

FIG. 28 illustrates a touch sensor, possibly using ITO as the sensing medium, with connections at either end of sensing elements of the touch sensor, suitable for use with a touch pad, showing a range of 10 possible finger detection situations (F0 to F9);

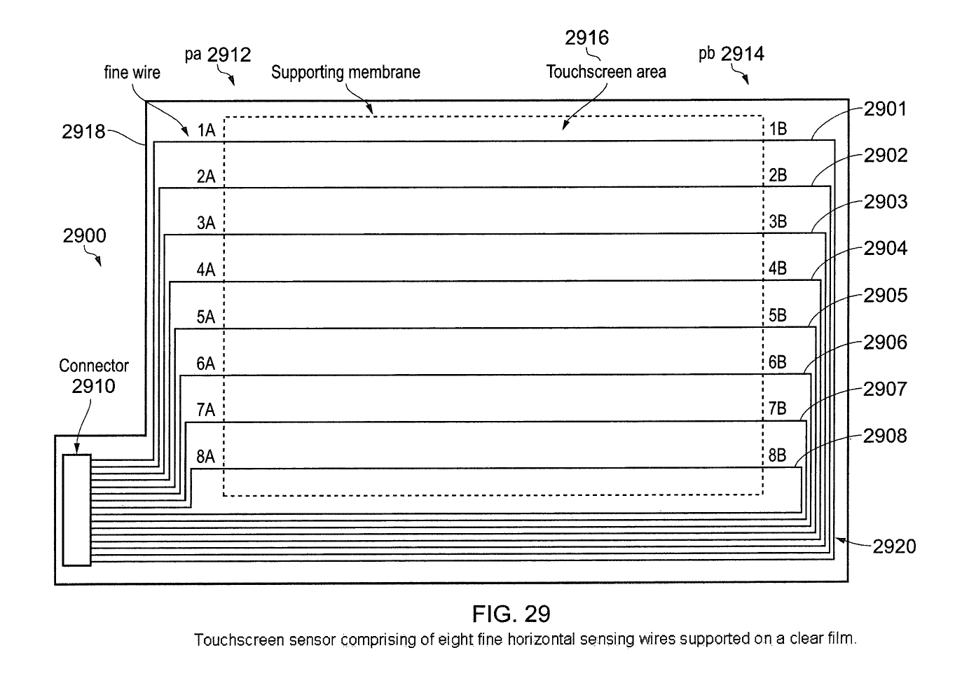

FIG. 29 illustrates another touch sensor, with wire as the sensing and routing medium, which eliminate terminations within the touch pad;

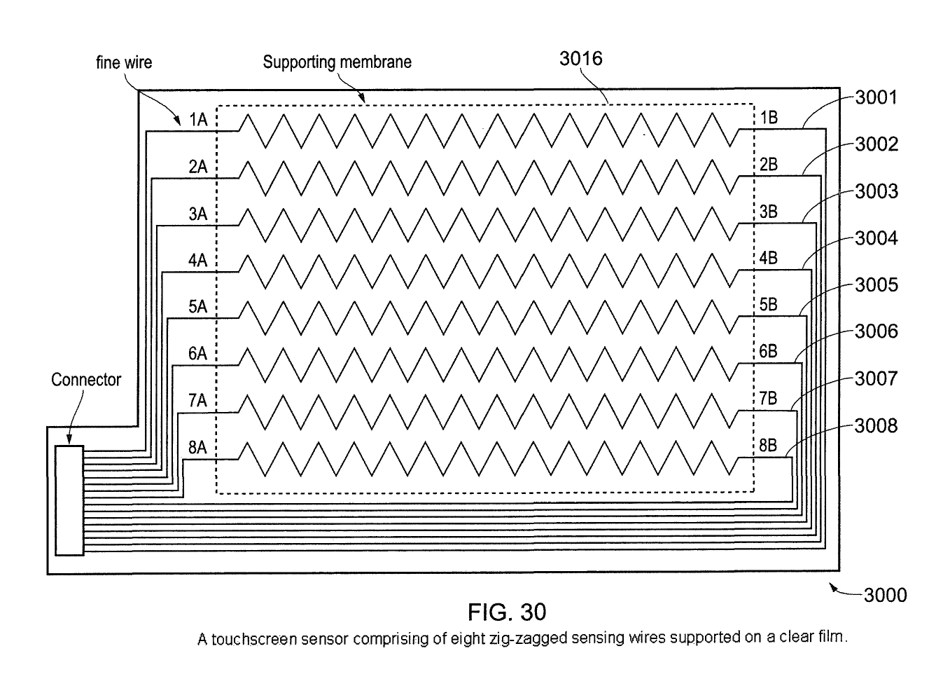

FIG. 30 illustrates another touch sensor with connections at either end of sensing elements of the touch sensor, suitable for use with a touch pad;

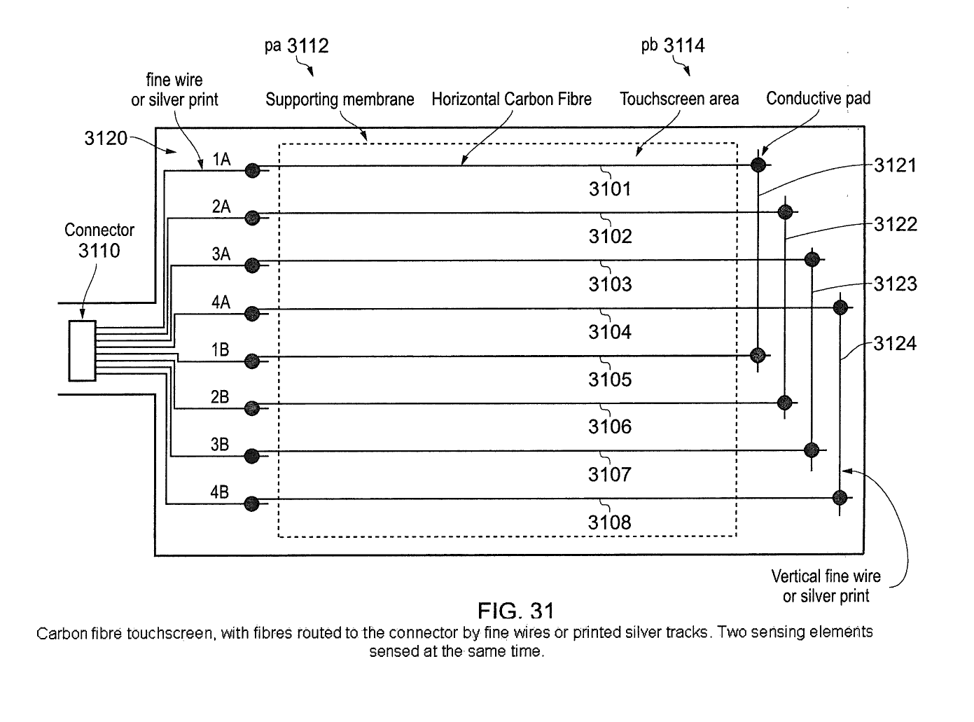

FIG. 31 illustrates another touch sensor with connections at either end of sensing elements of the touch sensor, suitable for use with a touch pad;

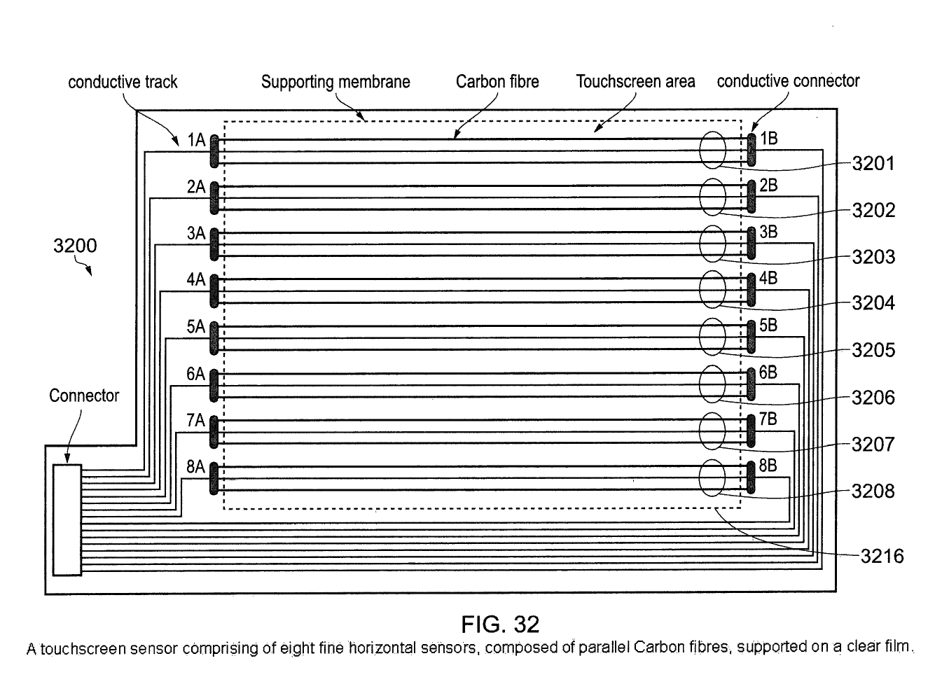

FIG. 32 illustrates another touch sensor with connections at either end of sensing elements of the touch sensor, suitable for use with a touch pad;

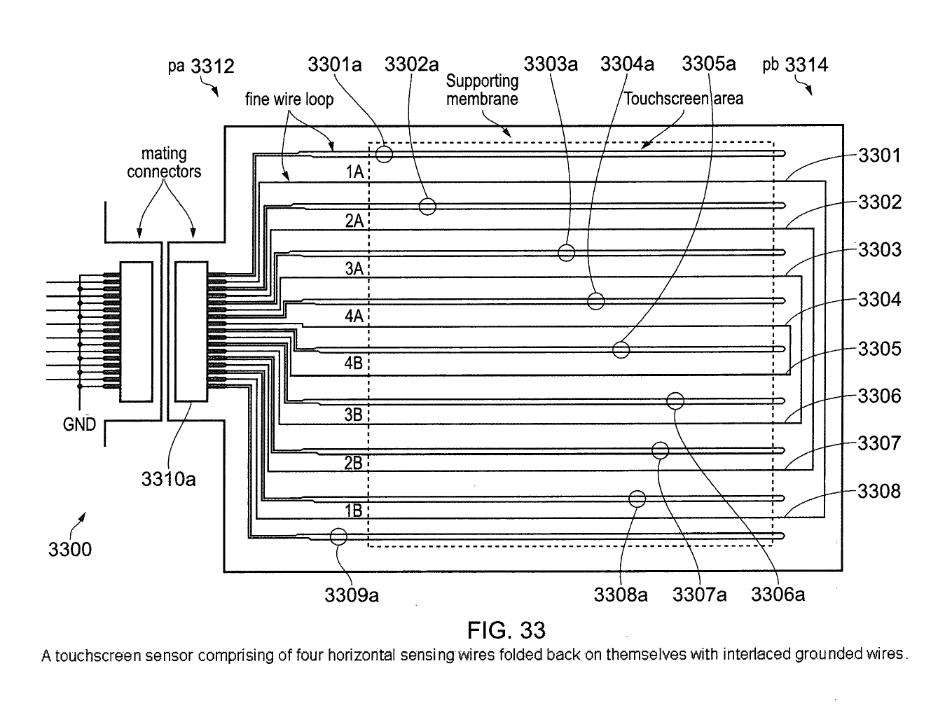

FIG. 33 illustrates another touch sensor with connections at either end of sensing elements of the touch sensor and an interface for use with a touch pad; and

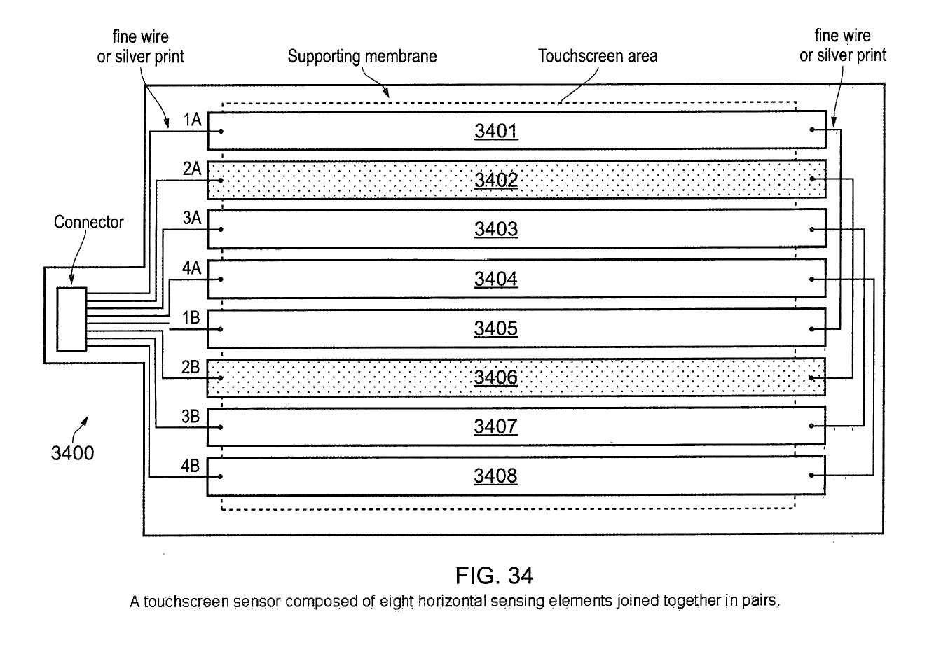

FIG. 34 illustrates another touch sensor with connections at either end of sensing elements of the touch sensor, suitable for use with a touch pad.

Unless otherwise specified, any reference to “touch” in the present specification, can relate to a finger touching a sensing element or alternatively may relate to the finger touching a protective coating surrounding the sensing element, or bringing the finger in to close proximity with the sensing element, but without directly touching the sensing element itself (in a capacitive system).

It is also to be understood that throughout the present specification, reference to a “finger” is intended to include any object capable of being used to locally modify the capacitance to an extent that detection is possible by way of capacitive sensing. Furthermore, any references to ‘touching’ or ‘touching action’ are to be taken to include both physical touching of a surface and the bringing of a finger into close proximity to a surface.

FIGS. 1A and 1B illustrates a touch pad 100 comprising a touch detection unit 101 coupled to a sensing element 102. FIG. 1 may be implemented using a capacitive touch sensor using projected capacitance deploying the self capacitance technique.

FIG. 1A illustrates a schematic representation of the touch pad. One part of the touch detection unit comprises a touch signal generator 101. The sensing element 102 comprises a single strip of conductive material (which may be poorly conductive with a resistance of 10,000 ohms over a length of a few centimetres, for example) supported on a non-conducting base material 103. The base material 103, or supporting medium, is encapsulated in a glassy overlay 104 having a top surface 106. The sensing element is connected at one end to the input of the touch signal generator 101.

In this example the touch signal generator touch signal generator 101 comprises a resistor/capacitor (RC) oscillator circuit. The oscillator circuit in this example comprises a Schmitt inverter 107 having a inverting input, an on/off control input and an output. A feedback resistor (Rf) 108 is coupled between the output and the inverting input. The frequency of oscillation of the oscillator circuit is dependent on the value of the feedback resistor 108 and the capacitance and resistance of the sensing element (SE) 102. When no finger is present, the output frequency of the oscillator circuit is at a base frequency.

A finger (not shown in FIG. 1A) can be brought into close proximity with the sensing element 102 at a touch position and may make contact with the top surface 106 of the glassy overlay 104. The glassy overlay prevents direct contact between the sensing element 102 and the finger. If the finger approaches the sensing element 102, a capacitance of the sensing element 102 increases at a touch position.

FIG. 1B illustrates an alternative representation of the touch pad 100 shown in FIG. 1A for the case where a finger is present in close proximity to the sensing element 102.

The sensing element 102 coupled to the touch signal generator 101 can be considered to provide a first plate 110a of a capacitor 110. The finger, which can be considered to be connected to a fixed potential 109 or ground, provides a second plate 110b of the capacitor 110. A capacitance is therefore provided between the sensing element 102 and the finger at the touch position. The capacitance is dependent on the strength of the touch; a harder touch will reduce the distance between the finger and the sensing element 102 and may also deform the finger so that a larger surface area is provided adjacent to the sensing element 102.

The sensing element 102 is resistive and so provides a resistance 111 between the touch position and the touch signal generator 101. The value of the resistance 111 will depend on where the touch position is along the length of the touch element.

The sensing element is therefore configured to present an electrical property associated with the touch properties of a finger along a length of the sensing element. The touch properties can include the touch position and the strength of the touch. The electrical property can be considered as the value of an impedance of the sensing element between the touch signal generator 101 and the touch, the value of a capacitance 110 created by the touch, or, in this example a resistive/capacitive time constant of the sensing element 102.

The increase in capacitance caused by bringing the finger into closer proximity with the sensing element 102 typically affects the resistive/capacitive time constant of the sensing element 102 and so results in a drop in the output frequency of the touch signal generator 101. The output of the oscillator can be considered to provide a touch signal, and a change in frequency of the touch signal indicates the proximity of a finger to the sensing element 102. In this way, the touch signal generator 101 generates a touch signal in accordance with the electrical property presented by the sensing element 102.

The finger detection method as employed by the touch signal generator 101 illustrated in FIGS. 1A and 1B may be referred to as time domain measurement. However, other methods may also be used. Possible other suitable methods include frequency domain measurement, where a fixed frequency signal is applied to the sensing element 102 and a change in an impedance of the sensing element 102 is measured directly. The impedance may be determined by measuring an increase or decrease in current from the sensing element 102 using a current sensing circuit.

FIG. 2 shows variation of a touch signal 216 generated by the touch signal generator as a function of touch position along the sensing element for a touch of a finger of a given touch strength.

The touch signal 216 is proportional to the amount by which the frequency drops as the finger approaches the sensing element. This relationship is dependent on the resistance of the sensing element at that point and need not be linear like the example shown because the resistivity of a touch sensor may vary possibly non-uniformly, along its length. Such variation may be exacerbated by aging of ITO materials. Also, the slope of the touch signal 216 depends on the strength of the touch.

For a circuit such as FIGS. 1A and 1B, the touch signal, or signal strength, shown on the vertical axis is related to a change in frequency of the TPDU, when compared with the base frequency when there is no touch. In circuits that use a current sensing circuit to detect the presence of a finger, the signal strength on the vertical axis may be related to the current obtained from the sensing element. The horizontal axis represents the distance along the sensing element at which a touch is experienced, which is reflected by the value of resistance between the touch position and the end of the sensing element that is connected to the TPDU. In the same way as FIG. 1A, the left-hand side of FIG. 2 represents a resistance of 0 ohms at position pa, and the right-hand side represents a resistance of ‘10×Rf’ at position pb. The graph of FIG. 2 can be considered as showing the change in signal strength (on the vertical axis) for a single touch as it is swiped along the length of the sensing element. It can be seen that a finger approaching the end of the sensing element nearest the connection to the TPDU, point pa, gives a greater reduction from the base frequency than a finger at the far end of the sensing element, point pb.

In this example, when the resistance of the sensing element is about ten times the resistance of the feedback resistor of the touch detection unit, the finger can no longer be detected at a position along the sensing element which will be referred to as the “null position”, or “null point” herein. This is because there is no change in frequency of the touch signal, as shown by the crossing of the horizontal axis at point pb. It is believed that the resistance between the null position and the point pa is sufficiently high that the reactance of the capacitance provided by the finger is fully attenuated, and therefore there is no effect on the frequency of operation. However, it has been observed that, at greater distances along the length of the sensing element beyond the null position, where the resistance is greater, the presence of the finger causes the output signal to unexpectedly increase in frequency. This effect provides a sharp “null” point, where the frequency is neither decreased, nor increased, by the approach of the finger. At the “null” point, the oscillator runs at the same frequency, irrespective of whether a finger is present or absent. In this example, the null point 218 is coincident with the point pb at the end of the sensing element furthest away from the touch detection unit.

In applications where a fairly large degree of error in the determination of the touch position is acceptable (that is, the precision of measurement required is low) or where it is possible to ensure that a “standard touch” with a known touch strength will always be used, then it may be possible to detect the position of the finger with just one measurement of the impedance of the sensing element. That is, using a single touch signal to determine the associated resistance of the sensing element between the touch detection unit and the touch, and then mapping the associated resistance to a physical location along the sensing element. A standard touch may be considered to be a touch that is applied with a consistent uniform pressure at a single position and where the finger does not deform during the touch. Such a situation occurs if discrete, isolated, conductive pads are fixed to the top surface of the glass overlay 104, such that the operator can directly touch one of the conductive pads thereby creating a standard repeatable touch.

However, without these conductive pads, it may not be possible to map a single touch signal (signal strength) to a position on the sensing element because the touch signal also varies as a function of touch strength. For applications where a standard touch cannot be assumed, it may not be possible to tell exactly, or in some cases even with a high degree of precision, where the finger is by using a single measure of touch signal generator 101 oscillator frequency. This uncertainty in position is due to the fact that a finger lightly touching the sensing element will result in a small change in the capacitance of the sensing element 102 and so a small change in the frequency of the oscillator. A finger heavily pressing the sensing element 102, that is, with more force, at exactly the same position along the sensing element 102 will cause a larger change in the touch signal generator 101 output frequency. There is therefore an inter-relation between touch strength and touch position; a finger lightly touching the top of the sensing element at position pa of FIG. 1 can result in a larger change in output frequency of the oscillator than a finger heavily pressing the top of the sensing element near to position pb.

However, it has been found that the position along the sensing element where the finger cannot be detected, the null point, is independent of touch strength. Embodiments of the present invention take advantage of this fact by moving the null point along the sensing element by modifying an attenuation setting (which may correspond to the value of a circuit component) within the TPDU. A finger in proximity with the sensing element 102 will cause a change in the impedance of the sensing element 102. Sweeping the null position across the sensing element by varying the attenuation setting allows the TPDU to determine the attenuation setting where the finger can no longer be detected. That is, the null point where the signal strength is zero. If it can be determined where the null point is (where the finger is no longer detectable) then, paradoxically, the position where the finger is can be determined more accurately.

FIG. 3 illustrates a schematic of a touch pad comprising a sensing element 302 and a touch position determining unit (TPDU) 301a. The TPDU 301a comprises a touch signal generator 301b and a variable resistor 320, although the variable resistor 320 may be provided separately to the TPDU 301a within the touch pad. The touch signal generator 301b and the sensing element 302 are largely similar to that described in FIG. 1.

The sensing element (SE) 302 in the example is shown surrounded by a conductive grounded plane shield 326, which, although not essential, can help to focus touch sensing to the area immediately along the sensing element 302. Provision of the shield 326 can alleviate bias caused by left or right handedness of the operator. The shield 326 can also reduce interference from neighbouring electronic devices, such as electronically noisy displays.

The position of the null point is related to a null resistance (Rn) between the touch signal generator 301b and the touch position. The value of the fixed total resistance (Rs) for any given application depends on the configuration of the touch signal generator 301b.

In FIG. 1A, the sensing element has a total resistance (Rmax) along its length between its two ends that is about ten times the resistance (Rf) of the feedback resistor of the oscillator in the touch signal generator. In the example of FIG. 1A, the null position for detecting a finger is at point pb. In FIG. 3, the circuit 300 has been modified over that shown in FIG. 1A so that the total resistance (Rmax) of the sensing element 302 is five times the resistance (Rf) of the feedback resistance 308. That is, Rs=5 Rf, rather than 10 Rf. However, the null position of the circuit 300 is still found at 10 Rf (Rn=10 Rf) so the null point cannot be found along the length of the sensing element 302 unless additional resistance is added in series with the sensing element 302.

The variable resistor 320 is coupled in series between an input of the touch signal generator 301b and a connection to the sensing element 302. An effect of the addition of the variable resistor 320 is that the null position may be moved along the sensing element by changing a resistance (Rv) of the variable resistor 320.

The TPDU 301a is configured to provide an attenuation setting signal (which may also be referred to as a control setting signal) to the variable resistor 320. The attenuation setting relates to a desired resistance setting of the variable resistor 320. In this example, the null point can be moved along the length of the sensing element 302 by changing the number of individual resistors (R1-R6) of the variable resistor 320 into a sensing line, between the sensing element 320 that are inserted and the touch signal generator 301b.

When the resistance of the variable resistor 320 is set to zero, the null position is not found along the length of the sensing element 302. When the resistance of the variable resistor 320 is increased to 10 Rf, the null position is moved to position pa 312. Setting the variable resistor 320 to values between 10 Rf and 5 Rf cause the null point to be provided at a position between pa 312 and pb 314 on the sensing element. It is therefore possible to move the null point anywhere along the sensing element by providing a suitable attenuation setting signal to the variable resistor 320, which in this example equates to introducing a suitable resistor into the sensing line.

It will be appreciated that the value of the fixed total resistance (Rmax)=10 Rf in this embodiment is merely an example. The relationship between Rs and Rmax will depend on the specific implementation of the TPDU 301a and/or the sensor element 302 configuration and materials used. The value 10 Rf, is based on the results found with a 10 inch (254 mm) long single carbon fibre, connected to a ‘555’ oscillator circuit running at 4 V, which is an alternative to the implementation of the touch signal generator 301b illustrated in FIG. 3.

The variable resistor 320 comprises a plurality of resistors (R1-R6) provided in a sensing line between the sensing element 302 and the touch signal generator 301b via a one of many multiplexor 322. The resistors (R1-R6) are connected as a chain, that is, in series, with one end of the chain coupled to an end of the sensing element approximate to position pa 312. Each of the junctions (B-F) between the respective resistors (R1-R6) is coupled to one of the many inputs of the multiplexor 322, as is the end of the resistor chain (G). The single output of the multiplexor 322 is coupled to the touch signal generator 301b. The TPDU 301a is configured to provide an attenuation setting signal to a select port 324 of the multiplexor 322 in order to control the variable resistor. The TPDU may initially set the multiplexor so that junction A is connected to the output of the multiplexor. In this state, no resistors are inserted between the sensing element 302 and the output of the multiplexor 322 on the sensing line. When the multiplexor output is directly coupled to position A, positioning of a finger anywhere along the sensing element results in a change in the output frequency of the oscillator 301b because the null position is not present along the length of the sensing element 302. The resistance of the sensing element between the touch position and the TPDU 301a may be much less than ten times the feedback resistor value of the oscillator in the touch signal generator 301b.

U.S. Pat. No. 4,954,823 (Binstead) discloses a very sensitive, accurate and stable method for detecting the position of a finger operating a keypad through very thick glass. The signal to be detected was so small that it could easily be swamped by changes in environmental conditions, such as temperature and humidity. By using information about how fingers operate a keypad or touch screen, separating out global from local changes using other keys as references, and using changes in capacitance only, as opposed to absolute capacitance values, a very sensitive capacitance detection method was created that was immune from environmental variations. At power-up, or on a reset, a value is stored for each input, and this is used as a “no-touch” reference for that input, which may be referred to herein as a background touch signal.

Similarly, the TPDU 301a may be configured to generate a background touch signal when no finger is present. A background touch signal may be generated for each of the resistance settings and may be stored in memory. Optionally, the background signal values may be regularly updated in order to take account of any drift in properties such as the resistivity of the sensing elements and environmental variations. The TPDU 301a may be configured to determine that a finger is present by comparing the touch signal (signal strength) generated by the touch signal generator 301b to the historic “no-touch” background touch signal. A change in the touch signal compared to the corresponding background signal for a specific resistance setting may indicate the presence of a finger.

After the TPDU 301a has detected the finger the TPDU 301a may attempt to determine the touch position and touch strength of the finger by varying the attenuation setting. The position of the finger and the touch strength may be determined by sequentially changing the attenuation setting. For example, the TPDU 301a may increase the attenuation setting of the multiplexor (also referred to as the multiplexor setting) so that additional resistance is gradually added in series with the sensing element 302 until a value of resistance is found that results in a minimal change, or no change, in the output frequency of the oscillator circuit of the touch signal generator 301b compared with the historic background touch signal (when no finger is present). The value of the resistance setting when the touch signal is within a threshold level of the background touch signal is related to the touch position along the sensing element where the finger is situated, as will be described below.

If, for example, the sensing element 302 has a resistance of 5 Rf, and a resistor value of 5 Rf is introduced into the sensing line, the total resistance (Rmax) will now be 10 Rf, so the null point (which occurs at 10 Rf in this example) will be at the far right end of the sensing element, at point pb 314. If a finger were positioned at the far end of the sensing element 302, it would have been readily detectable before the resistor was introduced but would be undetectable after the additional 5 Rf of resistance is introduced to the sensing line. If the finger is placed anywhere else along the sensing element 302, say half way along it will still be detectable, even though the signal strength would be diminished by the introduced resistance.

By successively selecting resistance setting corresponding to positions, A, B, C, D, E, F and G as shown in FIG. 3, the TPDU 301a can insert various resistances into the sensing line. If the resistances of each of the multiplexed resistors (R1-R6) is equal, a sequential increase in the number of resistors (R1-R6) included in the sensing line will result in the null position being shifted in equally spaced increments of distance along the sensing element. If a null point coincides with the touch position for any one of these settings, then the position associated with this resistance setting may be determined, and so the position of the finger may be determined. Selecting position G introduces a total resistance of 10×Rf into the sensing line and so moves the null point to point g at the very front end (position pa 312) of the sensing element 302.

The null resistance (Rn) related to the null position is fixed for a given touch pad. The sensing element may have a resistivity (f_rho) and so have a resistance (Rx) at each position (Xi) along its total length that is related to the distance (x) between the position (Xi) and the connection between the sensing element and the TPDU. Where the sensing element has a uniform resistivity f_rho is a constant (rho). The total resistance (Rmax) of the sensor element from the connection (pa) to an opposing end (pb) of the sensor element is equal to the resistivity (rho) of the sensing element multiplied by its total length, that is Rmax=rho*L. The null position (Xn) may therefore be swept along the length of the sensing element using a variable resistor (Rv) in series with the sensing element. Where the sensing element has a uniform resistivity, Xn=(Rn−Rv)/rho. This formulation holds for the case where the resistivity of the sensing element is constant. Therefore, in some embodiments, it may be beneficial to provide a sensing element with a constant cross section along its length and for the sensing element to be of homogeneous composition.

Null positions (b, c, d, e, f, g) of the sensor element 302 associated with multiplexor settings, or resistance settings, (B, C, D, E, F, G) are illustrated in FIG. 3 along the length of the sensing element 302. Point b corresponds to multiplexor setting B, point c corresponds to multiplexor setting C, etc. This relationship between the null positions (Xn=b, c, d, e, f, g) and the multiplexor settings (Rv=B, C, D, E, F, G) conforms to Xn=(Rn−Rv)/rho. FIG. 3 shows a finger F1 touching the sensing element 302 near its centre point, near position ‘e’. The sensing element 302 and TPDU 301a arrangement may be pre-calibrated so that the multiplexor settings correspond to null positions of the sensing elements by a known function.

Although FIG. 3 shows six resistors (R1-R6) that can be inserted in the sensing line by the multiplexor 322, it will be appreciated that more or less resistors can be used. Alternatively, the variable resistor 320 may comprise any arrangement of components or a single component that offers the functionality of a continuously variable resistor in addition to or instead of the arrangement shown in FIG. 3. A continuously variable resistor may offer the ability to modify the resistance by more precise increments. Use of a continuously variable resistor may also make it easier for the TPDU to distinguish between different fingers when there is a plurality of fingers touching the sensing element. Use of a continuously variable resistor may also enable the TPDU to “home-in” on the exact position of the finger, instead of relying on interpolation or extrapolation. That is, an iterative method may be employed to change the resistance of the variable resistor so as to obtain a more accurate value for the position of the finger.

As an alternative to varying the resistance of the sensing line, the null position may be moved along the sensing element by varying the resistance (Rf) of the feedback resistor 308 in the TPDU 301 or by varying both Rf and the resistance (Rv) of the variable resistor 320. However, varying Rf can cause very large changes in the oscillator frequency in some applications, whereas varying the series resistance may have only a slight effect on the oscillator frequency and therefore can enable more sensitive location determinations to be made.

A number of methods for determining one or more touch positions and/or one or more touch strengths are described further with reference to FIGS. 4 to 17. These methods may be implemented by a TPDU such as the TPDU 301a.

FIG. 4 illustrates variation in touch signals (signal strengths) as a function of touch position along the sensing element for several profiles 402-408, each profile is similar to the plot of FIG. 2 and corresponds to one of the attenuation settings (which in the example of FIG. 3 relates to a resistance setting or multiplexor setting), A (profile 402), B (profile 403), C (profile 404), D (profile 405), E (profile 406), F (profile 407) or G (profile 408) offset by the TPDU. The touch signals plotted in FIG. 4 may be background corrected touch signals for each attenuation setting. Null positions are present where a touch signal is zero. That is, the point where each profile 402-408 crosses the horizontal axis (zero touch signal) corresponds to the null position for the corresponding resistance setting (A to G).

The profile 402 associated with resistance setting A (which corresponds to the lowest resistance setting) results in the highest touch signal at all positions along the sensing element. An increase in resistance setting (moving from A to G) results in an overall decrease in the positive touch signal value. The profile 408 associated with resistance setting G (which corresponds to the highest resistance setting) has the lowest positive touch signal value.

The multiplexor settings A-G result in respective null positions a-g along the sensing element. Position ‘g’ is at the near end (position pa) of the sensing element with respect to the TPDU. Position ‘b’ is at the far end (position pa) of the sensing element. Position ‘a’ is not shown in FIG. 4 as it is beyond the far end of the sensing element of this example, given the resistivity of the sensing element and the resistance of resistance setting ‘A’ (which is zero).

The position of a finger F1 is indicated by the bold vertical line 401. Points 409-412 are defined by the intersection of the vertical line 401 (position of the finger) and the signal strength profiles 402-406 for each of the attenuation settings A-E and so shows the strength of the touch signal generated by the finger F1 when the TPDU changes the resistance setting. For example, the finger F1 results in a touch signal strength of the level at point 409 when resistance setting B is selected. This touch signal is reduced to the level at point 410 when resistance setting C is selected.

FIG. 4 shows that the presence of the finger F1 can readily be detected when resistance setting B is selected. When resistance setting C is selected the detected touch signal is weaker, but the finger is still detectable. Resistance setting D still shows some signal, but it is smaller than that for resistance setting C and much smaller than setting B. However, the finger no longer causes a decrease in the frequency of the oscillator output signal (touch signal) when the attenuation setting signal selects resistance setting E, and instead causes a small increase in frequency (resulting in a negative touch signal). The change in sign of the touch signal corresponds to the frequency of the output signal of the touch signal generator 301b starting to increase above a base frequency, rather than decrease below the base frequency. This response indicates to the TPDU that the finger is located somewhere between d and e on the sensing element.

FIG. 5 shows a plot of the touch signal measured for the finger F1 of FIG. 4 at various resistance settings plotted against the positions along the sensing element associated with the respective resistance settings. The touch signal strength generated in response to the presence of the finger F1 for a particular TPDU setting is plotted against the “null” position for that particular setting. For example, the signal strength of finger F1, when the TPDU is set to B, is plotted at b, the signal strength for finger F1, when the TPDU is set to C is plotted at c, etc. The data displayed in FIG. 5 are derived from the data points for the finger F1 of FIG. 4. A line 501 is plotted using points 502-505 which are the same data points shown on the vertical line at the touch position in FIG. 4. The four data points 502-505 correspond to the touch signal at respective resistance settings B, C, D and E. The points 502-505 are arranged right to left from the perspective of the resistance setting order (B→E). The point 505 related to resistance setting E has a touch signal less than zero. The points 502-504 related to resistance settings B, C and D have touch signals greater than zero. The gradient of the line 501 is positive with respect to the null position 507 along the sensing element for all of the resistance settings illustrated. Resistance settings F and G can be considered to move the null point such that the finger is beyond the null point. That is, at resistance settings F and G a small, typically non-linear negative change in the touch signal is generated when the finger F1 is at the touch position 507 shown in FIG. 5.

The TPDU can determine the data illustrated in FIG. 5 by, for example, sequentially selecting resistance settings starting with resistance setting B. The selection of resistance setting B results in a null point at position b along the sensing element. However, the magnitude of the touch signal determined whilst the resistance setting B is engaged and the touch position 507 is about 6.5 units, as seen in FIG. 5. The TPDU may record this value and perform the same procedure for further resistance settings (C, D, E, etc.). Optionally, the TPDU may stop taking measurements once the touch signal strength becomes negative, therefore stopping at E for the example of FIG. 5. The result of this process is the data of FIG. 5, which can be displayed as a curvilinear plot with a line 501 that passes through the horizontal axis when the touch signal has a zero value. The point where the line 501 of FIG. 5 crosses the horizontal axis (zero touch signal) corresponds to the touch position 507 of the finger F1, whereas the point where each profile of FIG. 4 crosses the horizontal axis (zero touch signal) corresponds to the null position for a corresponding resistance setting.

The TPDU may be configured to determine a null resistance setting for the touch position, the null resistance setting being the resistance setting at which the touch signal is substantially equal to the associated background touch signal. In other words, the resistance at which there is no change in the touch signal for a given touch. In this case, the TPDU may interpolate or extrapolate the measured touch signal strength values to determine the null resistance setting. The TPDU may be configured to calculate or look-up a touch position associated with the determined null resistance setting in order to identify the location of a touch.

The angle of slope, or gradient, of the line 501 (Angle 1) indicates the strength of touch of finger F1. The intercept point of the line 501 with the horizontal axis is indicative of the location of the touch. Using these principles, the TPDU can identify the position and strength of a touch. For example, the TPDU may be configured to generate a first differentiation of the touch signal, or corrected touch signal, with respect to resistance setting, dS/dR. The TPDU may be configured to calculate or look-up a touch strength associated with dS/dR.

The sensing element or TPDU may be calibrated so that can correctly associate the resistance settings with points on, or positions along, the sensing element.

Using the above methods discussed with regard to FIGS. 3 to 5, the position of a single finger can be determined by a minimum of two readings. The two readings can be considered to represent coordinates, each with two components: the touch signal (which can be proportional to output frequency shift) and the attenuation setting (which in the example shown relates to a setting of the variable resistor). In the case where a single finger is present, extrapolating the position at which a line between these two coordinates to determine the attenuation setting that corresponds with a zero touch signal provides the position of the finger. Therefore, just by measuring the touch signal at resistance settings B 502 and C 503 (shown within dotted circle 506), it is possible to extrapolate the touch position 507 to being near position ‘e’. The ability to perform this determination is, for the most part, irrespective of the strength of touch. If the two readings are slightly either side of the null point, one reading having a positive touch signal component and the other having a negative touch signal component, then the position of the finger F1 can be determined by interpolating between these two points. Conventional linear algebra may be used to perform the interpolation.

FIG. 6 illustrates variation in touch signal as a function of position along the sensing element for a plurality of attenuation settings (A, B, C, D, E, F, G) of the TPDU. FIG. 6 illustrates these data for a finger F1 located at the same touch position 601 along the sensing element as shown in FIG. 4, but where the finger presents a stronger touch.

In the same manner that FIG. 4 was translated in to FIG. 5, so FIG. 6 is translated into FIG. 7. FIG. 7 illustrates a plot of touch signal against position along the sensing element 702 when a finger F1 is present at the touch position. FIG. 7 shows a touch signal profile 701 plotted from four data points 702-705, corresponding to the touch signal related to resistance settings B, C, D and E. As before, the touch signal value generated for the finger (F1) for a particular TPDU setting is plotted against the position where that TPDU setting would create a corresponding “null” point. The touch signal strength generated at each resistance setting is plotted against the corresponding “null” position. The points 702-705 are arranged right to left from the perspective of the resistance setting order (B→E). All of the points 702-705 related to resistance settings B, C, D and E lie along a straight line 701 in this example as the sensing element has uniform resistivity. The gradient (related to Angle 1) of the line is positive. The points 702-704 related to resistance settings B, C and D have a touch signal greater than zero. The point 705 related to resistance settings E results in a touch signal less than zero.

FIG. 7 is derived from FIG. 6 in the same way that FIG. 5 is derived from FIG. 4. It is apparent from FIG. 7 that the same operation described above in relation to FIG. 5 may be performed to extrapolate the touch position 706 and the touch strength. The increased gradient of the touch signal profile 701 compared to the line of FIG. 5 indicates that the touch represented by the data of FIG. 7 represents a stronger touch than that of the finger of FIG. 4.

In FIG. 7, the positions related to resistance settings B and C still extrapolate to near the position related to setting E. If D and E were the only two readings taken, then position setting D would give a positive touch signal reading for the finger, and setting E would give a slightly negative touch signal reading. Interpolating between these two readings could be used to determine an indication of the position of the finger. There may be a small amount of error in the determined position, however, as the touch signal profile 701 may become more curved when the touch signal readings become negative. That is, when the resistance setting is set to a value that puts the position of the finger beyond the null point on the sensing element (further from the TPDU than the null point) then a non-linear, small touch signal may be generated by the TPDU. Such non-linearity of the touch signal may cause a small amount of positional error unless the system has already been calibrated to determine the actual curvature of the line/profile 701 at this point.

If two fingers touch the sensor at the same time the touch signal measured by the TPDU is the sum of the touch signals that results from the touch of each finger. That is, the electrical property presented by the sensing element to the TPDU is associated with a plurality of touch properties due to the plurality of fingers. The plurality of touch properties may each comprise a touch position and a touch strength related to a finger.

FIGS. 8 to 15 show profiles of the touch signals at a plurality of resistance settings for a sensing element with two fingers touching it at the same time. A null position along a length of the sensing element is associated with each of the resistance settings as described above for FIGS. 6 and 7.

FIGS. 8 and 9 present data for the case where two fingers each present a strong touch to the sensing element.

FIG. 8 shows several touch signal profiles, one profile for each of the attenuation settings A, B, C, D, E, F, G. The profiles in FIG. 8 are similar to those of FIG. 4 or 6. That is, FIG. 8 illustrates a number of spaced apart straight lines, each related to a touch signal strength associated with an attenuation setting, that linearly decreases as the resistance setting is decreased (as the displacement of the null position from the near end (pa) along a length of the sensing element increases). In FIG. 8, a first finger F1 at a first touch position and a second finger F2 at a second touch position are shown as bold vertical lines 801, 802 that intersect the touch signal profiles related to the attenuation settings A, B, C, D, E, F and G.

FIG. 9 shows a touch signal profile 901 plotted from six data points, corresponding to the measured touch signals for each of resistance settings B, C, D, E, F and G when the first and second fingers are present. The sum of the signal values, derived from the fingers F1 and F2 for a particular TPDU setting is plotted against the position where that TPDU setting would create a “null” point. That is, the signal strength generated for each TDPU setting is plotted against the corresponding “null” position. The points are arranged right to left from the perspective of the resistance setting order (B→G). The profile 901 is plotted as straight lines between resistance settings B and C; D and E; and F and G. Points of curvature are present in the line between resistance settings C and D and E and F. The points related to resistance settings F and G have a touch signal less than zero. The points related to resistance settings B, C, D and E have a touch signal greater than zero. The gradient of the profile 901 is 0 between resistance settings F and G. A first gradient (related to angle 1) of the profile 901 is positive between resistance settings E and D. A second gradient (related to angle 2) of the profile 901 is positive between resistance settings C and B. The second gradient is greater than the first gradient.

A TPDU may be configured to determine a number of touch positions of the one or more fingers by identifying the number of resistance settings where the second differentiation of the touch signal, or corrected touch signal, with respect to the change in resistance setting, d²S/dR², is above a threshold. The threshold may be set in accordance with the sensitivity of the system, for example.

The TPDU can further be configured to determine the one or more touch positions using the plurality of touch signals by calculating or looking-up touch positions associated with each of the resistance settings at which d²S/dR² is above the threshold.

FIG. 9 is derived from FIG. 8, in a similar way that FIG. 7 is derived from FIG. 6. However, the touch signals from first finger F1 and second finger F2 are effectively added together to give a combined signal for the curves associated with the attenuation settings (A, B, C, D, E, F, G). For example, when the multiplexor is provided with attenuation setting B, the first finger F1 contributes a touch signal of around 16 (where the vertical line 801 intersects with the B touch signal against position profile at point 803) and the second finger F2 contributes a touch signal of around 7 (where the vertical line 802 intersects with the B touch signal against position profile at point 804). The sum of these touch signals is about 23. This total is the touch signal coordinate for a data point associated with resistance setting B in FIG. 9. The corresponding position coordinate on the horizontal axis is ‘b’, which is the distance along the sensing element that corresponds to the “null” position for resistance setting B.

The TPDU can sweep the null position along the sensor element in a similar way to the example discussed with reference to FIG. 7. The attenuation setting can be sequentially changed so that each of the resistance settings A, B, C, D, E, F and G is assessed. A plot of touch signal may then be produced, such as that illustrated in FIG. 9. The profile 901 in FIG. 9 shows a distinct change in gradient between points 903, 904 associated with resistance settings C and D. That is, if a linear fit is applied based on measurements at attenuation setting B and C, this line 905 will intersect with a line 906 resulting from a linear fit based on measurements of the touch signal at attenuation settings D and E. The intersection of these two lines 905, 906 (where the slope changes) can be considered as a reasonable estimate of the touch position F2 of the second finger. The precision of the touch position measurements of the fingers may be improved in a practical application by providing more steps in the resistance of the variable resistor and/or by more sophisticated analysis of the measured touch signal values so as to remove or reduce the influence of the other touch position.

The point where the line 901 cuts through the line representing zero touch signal can be taken as an indication of the touch position of the first finger F1, as with the single figure example discussed for FIGS. 5 and 7. Two gradients, or angles 908, 909 can be determined from the data illustrated in FIG. 9. The two angles 908, 909 indicate the respective touch strengths for the first and second fingers F1, F2. The first angle 908 indicates the strength of touch for finger F1, and is equal to the angle between the horizontal axis and the line 906 which cuts through the horizontal axis. The second finger F2 has little effect on this angle as the touch signal strength will be relatively constant after the null point has been moved passed the second finger F2. The second angle 909 indicates the strength of touch of the second finger F2. The second angle 909 is defined between the line 906 that cuts the horizontal axis and passes through the points 904, 907 that relate to the resistance settings D and E, and the line 905 that passes through the points 902, 903 that relate to the resistance settings B and C. That is, the angle between the two touch signal lines. It is necessary to remove the influence of the first finger F1 from the second finger F2 as the touch signal caused by the first finger F1 is still increasing for the touch signal measurements that are also influenced by the second finger F2.

Due to the fact that the signal strength become negative when a finger touch is beyond the “null” point, that is, a finger is further from the connection of the sensing element than the null point, a small error is introduced into the negative touch signal measurements. This error is a small, typically non-linear resultant touch signal. The addition of a negative touch signal to a positive touch signal can cause a small error in the determination of the touch position of the fingers. The actual first touch position 910 of the first finger F1 may be determined to be at position F1? (as shown in FIG. 9) and the actual second touch position 911 of the second finger may be determined to be at position F2?. The error can be reduced by determining the shape of the touch signal against position plot when only a single finger is touching the sensing element. This data (absolute knowledge of a first touch position) may then be used to account for the negative values and non-linearity when an additional finger is beyond the null point.

At resistance settings where both of the fingers are beyond the null point, the resulting negative touch single values are added together.

The touch position determining unit (TPDU) may be configured to determine how many touch positions are associated with one or more fingers by identifying the number of resistance setting where the second differentiation of the touch signal, or corrected touch signal, with respect to the resistance setting, d²S/dR², is above a threshold. The TPDU may be configured to determine the one or more touch positions using a plurality of touch signals by calculating or looking-up touch positions associated with each of the resistance settings at which d²S/dR² is above the threshold. The threshold may be set according to the likely non-uniformity of resistivity of the sensing element, or may be zero where the sensing element has a uniform resistivity.

The TPDU may be configured to determine each touch strength of the plurality of fingers using a plurality of touch signals and associated resistance settings. Each touch strength is proportional to the first differentiation of the touch signal, or corrected touch signal, with respect to resistance setting, dS/dR. This first differential may be calculated or measured for a resistance setting that is slightly lower than the resistance setting directly associated with the corresponding touch position in order not to pick up the change in slope of the line that occurs at the touch position.

FIGS. 10 and 11 present data for the case where a first finger F1 provides a strong touch 2T at a first touch position 1001 nearer the left end of the sensing element and a second finger F2 presents a weak touch T at a first touch position 1002 nearer the right end of the sensing element.

Like FIG. 8, FIG. 10 shows a touch signal against position along the sensing element profile for a plurality of resistance settings where the first and second fingers F1, F2 are touching the sensing element. However, in FIG. 10 the first finger F1 provides a strong touch 2T but the second finger F2 provides only a weak touch T, whereas both fingers provide a strong touch in FIG. 8. In FIG. 10, a first series of profiles A(T), B(T), C(T), D(T), E(T), F(T), G(T) and a second series of profiles A(2T), B(2T), C(2T), D(2T), E(2T), F(2T), G(2T) are shown. The first series of profiles A(T) F(T) shows the contribution to the total touch signal of a weak touch, such as that provided by the second finger F2 for each respective attenuation settings. The second series of profiles A(2T) F(2T) shows the contribution to the total touch signal of a strong touch, such as that provided by the first finger F1 for each respective attenuation settings. As shown in FIG. 10, a strong touch causes a greater change in signal strength for a touch at a position that is nearer the TPDU than the null point. That is, the slope of the line is greater for a strong touch.

FIG. 11 is derived from FIG. 10, in a similar way that FIG. 9 is derived from FIG. 8. In FIG. 11, the touch signal from the first and second fingers F1, F2 are added together to give a combined signal for the curves associated with the attenuation settings (A, B, C, D, E, F, G). For example, when the multiplexor of FIG. 3 is provided with attenuation setting B, the first finger F1 contributes a touch signal of around 16 (where the vertical line 1001 intersects with the strong touch B touch signal against position profile B(2T) at point 1003) and the second finger F2 contributes a touch signal of around 4 (where the vertical line 1002 intersects with the weak touch B touch signal against position profile B(T) at point 1004). The sum of these touch signals is about 19. This total touch signal is the touch signal coordinate for resistance setting B at point 1102 in FIG. 11. The corresponding position coordinate takes the value b, the distance along the sensing element that corresponds to the “null” position for resistance setting B.

The TPDU can sweep the null position along the sensor element to provide the data for the profile 1101 illustrated in FIG. 11 in a similar way to the examples discussed with reference to FIGS. 7 and 9.

The profile 1101 in FIG. 11 shows a small change in gradient between points 1103, 1104 associated with resistance settings C and D. That is, if a linear fit is applied based on measurements at resistance settings B and C, a line 1108 of the linear fit will intersect with a line 1109 resulting from a linear fit based on measurements at attenuation settings D and E. The intersection of these two lines 1108, 1109 indicates the second touch position of the second finger (F2).

The point where the line 1101 cuts through the line representing zero touch signal can be used to indicate the touch position of the first finger F1, as with the example discussed for FIGS. 5, 7 and 9. Two gradients or angles 1110, 1111 can be determined from the data illustrated in FIG. 11. The two angles 1110, 1111 indicate the strength of touch 2T and T for the respective first and second fingers F1, F2. The first angle 1111 indicates the strength of touch 2T for the first finger F1, and is equal to the angle between the horizontal axis and the line 1109 which cuts through the horizontal axis. The second angle 1110 indicates the strength of touch T of the second finger F2. The second angle 1111 is defined between the line 1109 that cuts the horizontal axis and passes through the points 1104, 1105 that relate to the resistance settings D and E and the line 1108 that passes through the points 1102, 1103 that relate to the resistance settings B and C. In FIG. 11, the first angle 1111 is greater than the second angle 1110 because the touch strength (2T) of the first finger F1 is greater than the touch strength (T) of the second finger F2.

In FIG. 11, it can be seen that the position of both fingers F1, F2 may be determined. However, there is less error in the position of the first finger F1 because the second finger F2 provides a weak touch, and so creates only a weak error (relatively small negative touch signal) due to the negative value beyond its null point (as shown in FIG. 10). Due to the fact that finger F2 provides a weak touch at the far right end of the sensing element, that is, further from the output of the sensing element, it may be difficult to detect exactly where the angle of slope changes.

FIGS. 12 and 13 present data for the case where a first finger F1 presents a weak touch T at a first touch position near the left end of the sensing element and a second finger F2 presents a strong touch 2T near the right end of the sensing element at a second touch position.

The same first series of profiles A(T)→F(T) and second series of profiles A(T)→F(2T) showing touch signal against resistance are illustrated in FIG. 12 as were discussed above with reference to FIG. 10. However, in FIG. 12 the first finger provides a weak touch (T) and the second finger provides a strong touch (2T). This is the opposite situation to that described with reference to FIG. 10.

FIG. 13 is derived from FIG. 12, in a similar way that FIG. 11 is derived from FIG. 10. FIG. 13 shows a similar plot to that of FIG. 11, except that the first angle 1311 of FIG. 13 is less than the first angle in FIG. 11 and the second angle 1310 of FIG. 13 is larger than the second angle in FIG. 11. The fact that the first angle 1311 is small reflects the fact that the first finger F1 provides a weak touch T. The second angle 1310 is larger than the first angle 1310, reflecting the fact that the second finger F2 provides a stronger touch 2T than the first finger.

There is significantly more error, or imprecision, in the determination of the real position of the first finger F1 in FIG. 13 compared with the situation in FIG. 11. This increased error is due to the strong touch 2T provided by the second finger F2. The strong touch 2T of the second finger F2 creates a relatively strong negative touch signal when it is passed its null position. The negative value is added to the readings for the first finger F1, causing a relatively large error.

FIGS. 14 and 15 illustrate similar situations to those discussed in FIGS. 8 and 9, respectively. However, FIG. 14 illustrates touch signal against resistance profiles where the first and second fingers F1 and F2 are both weak touches.

FIG. 14 shows several touch signal profiles against position, one profile for each of the attenuation settings A, B, C, D, E, F, G when two weak touch signals are present. However, because the touch strength T of the first and second fingers F1, F2 of FIG. 14 are weaker than those in FIG. 8, the gradient of the touch signal profiles related to the attenuation settings A, B, C, D, E, F, G is less negative in FIG. 14 when compared with the touch signal profiles illustrated in FIG. 8.

FIG. 15 is derived from FIG. 14 in the same way that FIG. 9 is derived from FIG. 8. Both the first and second angles 1507, 1505 shown in FIG. 15 are smaller than the corresponding angles 907, 905 illustrated in FIG. 9, indicating that both the first and second fingers F1, F2 in FIG. 15 provide weak touches T. As in FIG. 9, it is possible to determine the positions of both the first and second fingers F1, F2, but in this example the touch positions F1, F2 may be determined with greater accuracy than the situation where both fingers F1, F2 provide strong touches 2T. The improved accuracy is due to the presence of the second finger F2 creating a weaker negative touch signal (error signal) at resistance settings where the second finger is beyond the null point than the second finger in FIG. 9 due to the difference in touch strength.

One application for which it can be important for a system to be able to simultaneously detect two fingers (possibly on the same sensing element) is to determine when two fingers are spreading apart, or closing together. These gestures are important in many user interfaces.

Although FIG. 7 shows a touch signal against position profile for a single strong touch (2T), a similar signal plot could also be obtained by a touch pad with a sensing element interacting with two fingers that are very close together. In contrast, FIG. 15 shows a touch signal against position profile 1501 for two fingers that are spread apart.

The two profiles of FIGS. 7 and 15 are very different from each other and may readily be distinguished from one another by a processor of a touch position determining unit (TPDU). If the processor detects a plot similar to that of FIG. 7 changing to a plot similar to that of FIG. 15, then the processor could determine that two fingers have been spread apart from one another from an initially coincident point of contact. Likewise, if the plot changed from that of FIG. 15 to that of FIG. 7, then the processor could determine that two fingers have been drawn together. In order to perform such analysis, the TPDU may be configured to compare a current plurality of touch signals with a previous plurality of touch signals. The TPDU may be configured to store a preset number of historical touch signals in memory and to store touch signals in memory at predetermined intervals.

Similar techniques to those described for systems used to detect two fingers, can be applied for three, four, or even more fingers; the measured touch signal will be the sum of all of the individual touch signals for each finger, irrespective of the number of fingers.

FIG. 16 shows several touch signal profiles, one profile for each of the attenuation settings A, B, C, D, E, F, G, similar to the profile of FIG. 14. The touch positions of three fingers are shown as vertical lines 1601-1603 in FIG. 16. The positions of a second finger F2 and a third finger F3 in FIG. 16 corresponds to the position of the first finger F1 and the second finger F2 in FIG. 14. The first finger F1 in FIG. 16 is at position g along the sensing element 302, that is, adjacent to the output of the sensing element. The first second and third fingers F1, F2, F3 all provide equal touch strengths in FIG. 16.

FIG. 17 is derived from FIG. 16 in the same way that FIG. 15 is derived from FIG. 14. The first second and third fingers F1, F2, F3 cause the touch signal against position profile 1701 of FIG. 17 to have three distinct gradients. From the profile 1701 it is apparent that a greater resolution of the variable resistor may be needed than is illustrated in these simplified examples in order to provide a sensor system that can accurately determine the position of multiple fingers. In general, a system designed to detect n fingers should generate touch signals for at least 2n resistance settings.

In FIG. 17, the points at which the profile 1701 changes gradient or crosses through the zero touch signal horizontal axis can be used to indicate the position of the individual fingers. The profile 1701 consists of a first line 1721 between points 1702-1704 that correspond to resistance settings A-C; a second line 1722 that passes through point 1705 that corresponds to resistance settings D and E; and a third line 1723 between points 1706-1708 that corresponds to resistance settings E-G. The intersection between the first line 1721 and the second line 1722 can be used to determine the position of the third finger F3. The intersection between the second line 1722 and the third line 1723 can be used to determine the position of the second finger F2. The position of the first finger F1 can be determined from the resistance setting where the third line 1723 crosses the horizontal axis. Touch positions associated with the determined resistance settings can be calculated or looked-up.

The strength of touch of the first finger F1 can be determined from the magnitude of a first angle 1709, defined between the horizontal axis and the third line 1723. The strength of touch of the second finger F2 can be determined from the magnitude of a second angle 1710, defined between the second line 1722 and the third line 1723. The strength of touch of the third finger F3 can be determined from the magnitude of a third angle 1703, defined between the first line 1721 and the second line 1722.

If four fingers were brought into proximity with the sensing element, four distinct slopes or gradients of the touch signal against position profile would be apparent. In general each additional finger will cause an extra gradient region in such a curve and result in an additional point of curvature along the profile. Error in the determined position may also accumulate with the addition of extra fingers. The greatest error source may be from the accumulation of negative values when fingers are passed their respective null points.

An alternative method for detecting the touch positions of more than one finger that are simultaneously touching the sensing element can utilise a determination that a first finger touches the sensing element before the other fingers. Once the first finger touches the sensing element, its position can be determined. The TPDU, or at least a portion of which may be implemented as a microprocessor, may then store data in memory representative of a “one-touch state” of a plurality of touch signals associated with the single finger touching the sensing element at a determined touch position. The TPDU can then treat this one-touch state (that is, the touch signals for a series of attenuation settings) as though there are no fingers touching it; treating the current set of values as though they were historical “no-touch” values. When a second finger subsequently touches the sensing element, the position of the second finger can then be determined as though it is the only finger there. The second finger can move about and still have its movement tracked accurately, as long as the first finger remains static. This process can be repeated for any number of fingers, leading to the possible detection of three or more fingers on a single sensing element at the same time.

A disadvantage to this method is that each earlier finger always has to remain in a fixed position. If an earlier finger were to move, the TPDU would detect a very strong negative touch signal reading for the first finger's position. Such a circumstance could, depending on the specific implementation of the TPDU, possibly cause a reset to occur.

Another downside is that the spreading apart, or closing together, of two fingers is usually symmetrical, whereas when using the method of finger detection described above, the first finger has to remain static while the second finger may move.

FIG. 18 illustrates an example of a touch pad 1800 for detecting a touch position of a finger. The touch pad 1800 comprises a plurality of sensing elements 1801-1808 that each extend in a first direction and are displaced from one another in a second direction in this example. The sensing elements 1801-1808 are placed side by side to form a two dimensional array of proximity sensing elements 1801-1808. The first direction of the sensing elements 1801-1808 is therefore perpendicular to the second direction.

Each of the elements 1801-1808 can be individually connected, usually one at a time, to a detector, or TPDU via conductive track and a touch pad connector 1810. Each sensing element 1801-1808 is configured to present an electrical property indicative of a first direction coordinate of the touch position when a touch position is proximal to that element. As discussed above, the electrical property is typically an impedance of the respective sensing element.

In this example, the plurality of sensing elements 1801-1808 are the only sensing elements of the touch pad 1800 and are provided in a single layer as ITO tracks on a polyester support film. Such a touch pad 1800 layout may allow for simplified manufacture techniques to be used compared to prior art designs and so may reduce the cost of manufacture. As only a single layer is required, and not multiple layers of sensing elements, the cost of materials of such a system may also be reduced.

A sensing film for a single ended touch screen comprising the sensing elements described herein may be very easily manufactured and at a very low cost on a reel to reel basis. Parallel conductive strips of ITO or parallel conductive wires running the whole length of polyester reels, which can be 100 metres long, may be used. The reels can be cut up at a later stage in the manufacturing process into individual touch sensor portions. A screen printed conductive silver or graphite connector may also be added, either to the individual touch sensor portions or, alternatively, to a number of portions on the reel. The touch sensor can be finished by covering the individual touch sensor portions with a protective polyester film, or laminating the portions direct onto a sheet of glass.

The touch sensing material such as ITO may be readily manufactured using reel-to-reel methods. Terminations to sensing elements can be added during final stages of manufacture. Typical applications of ITO implemented touch screens include tablets, mobile phones and large touch screens. Any permanently or temporarily grounded elements may also be made of ITO. The sensing elements and support material can, however, be made of a wide range of alternative materials. Some of the sensing element materials are listed in Table 1.

TABLE 1
TABLE OF MATERIALS, PROPERTIES, AND APPLICATIONS.

| | | STANDARD | | TYPICAL | RESISTANCE | | | TYPICAL |
|---|---|---|---|---|---|---|---|---|
| Material | FORM | RESISTANCE | | FORMAT | FORMATTED (R) | | Rf | APPLICATIONS |
| ITO | plate | 300 | ohms/sq | 0.2 inch wide | 15 | kohms | 3 k | Tablets |
| | | | | Strips, 10″ long | 150 | kohms | 30 k | Mobile phones |
| | | | | Strips 100″ long | | | | Large touch- |
| | | | | | | | | Screens |
| Carbon | 7 micron | 10 | kohms/inch | Single filament, | 100 | kohms | 20 k | Low cost |
| Fibres | filament | | | 10″ long | | | | roll-up |
| | | | | | | | | Touchscreens |
| Nichrome | 10 micron | 12 | k ohms/metre | Single 5 metre | 60 | kohms | 12 k | Very large |
| NiCr | Wire | | | wire - possible | | | | roll-up/ |
| | | | | zig-zag pattern | | | | creasable |
| | | | | | | | | Touchscreens |
| | | | | | | | | Interactive- |
| | | | | | | | | Worktops |
| Anti- | sheet | 20 | kohms/square | 1 inch wide | 200 | kohm | 40 k | flexible |
| Static | | | | strips, 10″ long | | | | roll-up |
| Plastic | | | | | | | | touchpads |
| Copper | 10 micron | 260 | ohms/metre | 10 metres long | 2 k 6 ohms | | 520 ohms | Very large |
| | Wire | | | possible zig- | | | | roll-up/creasable |
| | | | | zag pattern | | | | touchscreens |
| Tungsten | 10 micron | 700 | ohms/metre | 10 metres long | 7 | kohms | 1 k 4 | Very large |
| | Wire | | | possible zig- | | | | roll-up/ |
| | | | | zag pattern | | | | creasable |
| | | | | | | | | touchscreens |

| | | | | | | |
|---|---|---|---|---|---|---|
| Printed | Reticulated | print | Strip pattern | print | 20% | Small to |
| Graphite/ | print | pattern | 10″ long | pattern | of | large roll- |
| Silver | pattern | dependent | 5 metres long | dependent | R | up touch- |
| | | | | | | Screens |
| Graphene | mesh | very low | strip pattern | very low | 20% | Small to |
| | | | 2″ long | | of | large roll- |
| | | | 5 metres long | | R | up touch- |
| | | | | | | Screens |
| Sintered | Printed | medium | strip pattern | medium | 20% | Interactive |
| Metal | patterns | resistance | | | of | Ceramic |
| Oxides | | | | | R | Tiles |

It will be appreciated that a range of materials may be used in a touch pad, depending upon its application. Carbon fibres may be used as the sensing elements in low cost roll-up touch screens. Nichrome can be used in very large roll-up/creasable touch screens and interactive worktops. Anti-static plastic can be used in flexible roll-up touch pads. Copper or tungsten may be used in very large roll-up/creasable touch screens. Graphene or printed graphite or silver may be used in small to large roll-up touch screens. Sintered metal oxides can be used in interactive ceramic tiles.

If carbon fibre is used as the sensing element, the sensing elements may have a high resistivity and so a high total resistance. The resistivity of a single carbon fibre can be around 400 ohms/mm. A single carbon fibre sensing element of ten inch (254 mm) length will therefore have a resistance of about 100,000 ohms. The use of non-selected sensing elements for grounding will mean that the grounding at the end of the sensing element furthest away from the input to the TPDU will be weaker than it is at the end nearest the TPDU due to the resistivity of the grounded sensing elements; the grounding is through 100,000 ohm of carbon fibres at the far end, but through only a small fraction of that at the oscillator end. A sensing element may comprise several carbon fibres coupled in parallel in order to reduce the effective resistance of the sensing element. Reducing the resistivity of the sensing element also has the effect of improving grounding when the sensing element is used for as a grounding shield. Such grounding may be suitable for some applications. However, grounding of sensing elements may be further improved by placing less resistive wires between the carbon fibres of the sensing element, and grounding these. An equivalent length of Nichrome®, or tungsten wire, for example, could be used in addition to or instead of a carbon fibre wire. A ten micron diameter commercially available tungsten wire typically has a resistivity of around 0.8 ohm/mm. A ten inch (254 mm) length of ten micron diameter tungsten wire therefore has a resistance of about 200 ohms. The resistance of such a tungsten wire is about 500 times lower than that of a ten inch long single carbon fibre.

A TPDU suitable for use with the touch pad of FIG. 18 is illustrated in FIG. 19. The TPDU is configured to set an attenuation setting for each of the plurality of sensing elements; generate a plurality of touch signals for each of the plurality of sensing elements; and determine one or more touch properties using the pluralities of touch signals.

The TPDU comprises a mating connector 1910 configured to engage with the touch pad connector of FIG. 18. The mating connector 1910 is coupled to an input of a sensing element multiplexor 1905, which is an analogue multiplexor. An output of the sensing element multiplexor 1905 is coupled to a variable resistor 1920 that corresponds to the variable resistor discussed with regard to FIG. 3 (and will only be briefly discussed again here). An output of the variable resistor is provided to a touch signal generator 1901b that corresponds to the touch signal generator of FIG. 3.

The eight-way mating connector 1910 can be plugged into the touch pad connector of FIG. 18 when in use. The sensing element multiplexor 1905 of FIG. 19 enables the connection of one of the sensing elements of FIG. 18 to an input of a RC oscillator 1907 of the touch signal generator 1901b. This connection is routed through the variable resistor 1920, which can be configured to provide a range of resistance values, ranging from substantially no resistance (when resistance setting A is set at the control input 1924 of a resistance setting multiplexor 1922 of the variable resistor element 1920 by the TPDU), to one of a range of resistors (R1-R6) by the resistance setting multiplexor 1922 of the variable resistor element 1920 (when a corresponding resistance setting B-G is applied to the control input 1924 of the resistance setting multiplexor 1922 of the variable resistor 1920).

The touch signal generator 1901b differs from that of FIG. 3 in that the feedback resistor for the RC oscillator has been replaced by a variable feedback resistor 1908. The variable feedback resistor 1908 is implemented using an analog feedback multiplexor 1909 that is configured to select one of a number of feedback resistors Rf1-Rf4. The feedback resistors Rf1-Rf4 are illustrated in FIG. 19 as having a common connection with the inverting input of the Schmitt inverter 1907 and each having an output coupled to a selectable terminal of the feedback multiplexor 1909. An output of the feedback multiplexor 1909 is coupled to the output of the Schmitt inverter 1907. The values of the feedback resistors Rf1-Rf4 are all different in this example. It will be appreciated that the resistors could also be provided as a series chain similar to the variable resistor element 1920. It will equally be appreciated that the series chain of resistors R1-R6 provided in the variable resistor element 1920 may be provided by an arrangement of resistors similar to that provided by the variable feedback resistor 1908.

A TPDU may be configured to match the value of the feedback resistor (Rf) in use by the feedback multiplexor 1909 to the resistance of the sensing elements of FIG. 18. This variable resistor property of the feedback resistor 1908 is not necessary if the total resistance of each of the sensing elements of FIG. 18 is already known, in which case a suitable resistor for Rf can be preselected and directly wired in.

In operation, each of the sensing elements of FIG. 18 is selected in turn, one at a time, by the element multiplexor 1905 under the control of the TPDU. This sequence can start with a first sensing element and proceed through the remainder of the sensing elements of FIG. 18. The TPDU (which may comprise a microprocessor) may detect if one or more fingers is present along the selected sensing element 1801-1808 by recognising a deviation from the base frequency readings for each of the elements. If a finger is present, the position of the one or more fingers may be found for each sensing element 1801-1808 by any of the processes described previously with regard to FIGS. 3 to 17.

Once the first sensing element 1801 has been interrogated, the TPDU can provide an element selection signal to the element multiplexor 1905 in order for the second sensing element 1802 to be selected. The interrogation process to find the presence or position of any fingers that are present is then repeated for the second sensing element 1802. This process continues until all sensing elements (up to the last sensing element 1808) have been interrogated for the presence of fingers, after which, the process starts again with the first sensing element 1801. Such a process may be repeated continuously or periodically.

In this way, it is possible to detect the position of a plurality of fingers touching the screen at the same time. As each sensing element can be used to detect the presence of at least two fingers, and there are eight sensing elements, then it is possible to detect the position of at least sixteen fingers touching the screen at the same time. Some fingers may be present at a touch position between two sensing elements, but a suitable processor or microprocessor of a TPDU can detect this and interpolate the position of the finger between adjacent sensing elements, by means that will be apparent to the skilled person.

The sensing elements 1801-1808 of FIG. 18 may be scanned, one at a time, in a linear or non-linear sequence. Usually, only one sensing element 1801-1808 is sensed (or selected, in use) at any one time in order to prevent interference between neighbouring sensing elements 1801-1808. Sensing elements 1801-1808 that are not in use may be coupled to earth, to another fixed potential, to an active backplane signal or to some other appropriate signal, in order to further suppress interference from sensing elements 1801-1808 that are not in use. Sensing elements 1801-1808 may temporarily (or permanently) be joined together in parallel in adjacent pairs, or threes, or more, in order to reduce the resistance of the combined sensing elements 1801-1808 and increase the sensitivity of the touch sensor. A sensing element 1801-1808 may be joined to another sensing element by connecting the sensing elements 1801-1808 at the respective outputs 1810 of the sensing elements 1801-1808, that is, the position of the sensing element 1801-1808 that is configured to be electrically connected to a conductive track for connection to a TPDU. Such a touch sensor may electronically select whether it provides a high resolution mode, which may be beneficial for applications that operate through a thin glass screen (less than 2 mm, for example), or a lower resolution mode, which may be beneficial for applications that operate through a very thick glass plane (greater than 2 cm, for example).

In FIG. 19, signal paths from non-selected sensing elements of FIG. 18 are shown connected to ground via the sensing element multiplexor 1905. This arrangement helps focus a touch along the sensing element being sensed (the sensing element that is selected by the sensing element multiplexor 1905). The grounding arrangement also reduces bias caused by left or right handedness of a user and helps to prevent interference from neighbouring, non-selected sensing elements and any electrically noisy equipment that may be nearby.

Alternatively, the touch sensor may be configured to allow a plurality of sensing elements to be sensed at the same time. This arrangement could be provided by an element multiplexor configured to simultaneously connect several sensing elements to its output in response to receiving an appropriate select control signal. Instead of the 1 of 8 multiplexor 1905, a 2 of 8 multiplexor could be used to select 2 inputs at a time, each input connected to a different target signal generator 1901b. In such an arrangement, there may be provided sufficient grounding between the selected sensing elements in order to prevent interference from adjacent and intermediate sensing elements.

If a single voltage sweep is used instead of an RC oscillator, then the one voltage sweep could be used for all eight sensing elements at the same time without interference from adjacent sensing elements.

Although not shown in FIG. 18, there may be permanent grounded tracks between the sensing elements. Each of these tracks may be similar to the shield shown in FIG. 3. In general, any features described with reference to one example herein may be used in conjunction with features of any other example.

A touch pad and touch position determining unit (TPDU) such as in the examples of FIG. 19 may be implemented using self-capacitive detection. Alternatively, a mutual capacitive system can be provided in which a plurality of sensing elements are divided into transmitting (or driving) sensing elements and receiving sensing elements. The transmitting sensing elements and receiving sensing elements are provided proximal to one another.

In a mutual capacitive system, an RF signal is generated by a TPDU and applied to the transmitting elements. The TPDU monitors the receiving sensing elements. Bringing a conductive body into the vicinity of the touch pad changes the local electrical environment and so affects transmittance of the signals from the transmitting to receiving sensing elements. In this way, the TPDU can determine whether a finger has been brought into the proximity of the sensing elements.

The transmitting (or driving) sensing elements and receiving sensing elements may be provided in a single plane, such as the touch pad of FIG. 18, and may be interleaved with one another.

In one example, the role of the transmitting sensing elements and receiving sensing elements may be permanently assigned to different respective elements. In such an example, the transmitting sensing elements (or “emitting elements”) may have a lower resistance than the receiving sensing elements (or, simply, “sensing elements”) in order not to attenuate the transmitted signal. For example, the receiving sensing elements may have the resistivity described with reference to FIGS. 1 to 19, whereas the transmitting sensing elements may have a resistivity that is 10, 100 or 1000 times lower than that of the receiving sensing elements.

Alternatively, a TPDU may dynamically assign the role of transmitting and receiving to different sensing elements. It will be appreciated that in such an example the sensing and receiving sensing elements will have a similar resistance.

The TPDU may have a self-capacitive mode and a mutual-capacitive mode. The TPDU may therefore operate the sensing elements according to a self-capacitive regime for a first period and operate the sensing elements according to a mutual-capacitive regime for a second period.

Historical measurements from neighbouring sensing elements may be used to determine the positions of one, two, or more fingers on a particular element. This information may be particularly useful if other measurements are unable to adequately determine the position of a finger, or if the determined position is ambiguous. Any previous measurement can be considered to be an historical measurement as described with reference to the example in FIG. 15.

If a finger has already been tracked moving along a certain path, then it is more likely that it will continue to follow that path than a different path. Previous path information can be used to validate an indecisive or indefinite reading from a sensing element along a predicted path based on the previous path.

Also, if a very strong signal reading (high touch strength) is obtained for a finger then it is possible that the reading is actually due to two fingers that are very close together. Historical readings may be compared with current readings to determine a likelihood that two fingers were converging on the present detected touch position. This information may be used to confirm that the strong signal reading is, in fact, due to two fingers rather than one finger. It might be, however, that only one finger was moving towards that position, making it more likely than not that the strong signal measurement is due to only one finger.

The term “grounding” does not necessarily mean connecting directly to ground, it may be connecting to any fixed voltage, or a floating voltage and may only be present when the device is in use, in some examples. In some situations, “grounding” may mean connecting to a varying signal, such as an active backplane signal or even an anti-active backplane signal, as is known in the art. An example active back plane generator is described further with reference to FIG. 22.

If the touch signal generator of the TPDU does not produce a touch signal with a change in frequency that depends on the impedance of the sensing element and instead relies on a current measurement, for example, or if grounding is provided between the sensing elements, then several sensing elements may be sensed at the same time, thereby reducing the time taken to scan a complete touch screen. Alternative circuits to the Schmitt TPDU may, however, be used to provide a TPDU, as described with reference to FIG. 3. Alternative circuits may require different resistor values. It will be appreciated that there are many methods for providing a touch signal generator, and that an RC Schmitt oscillator circuit as disclosed herein is one such example that provides for an easily implementable solution.

Although all the diagrams presented herein show the sensing elements as extending horizontally, they may be at any angle to a line of reference, or indeed to each other. Indeed, a sensing element may be provided in a serpentine pattern, a zig-zag pattern, a curved pattern, or any other 2 dimensional shape. A serpentine arrangement may, with a sensing element of suitable resistivity, allow the two dimensional position of a touch on a surface to be determined using a single sensing element.

Sensing elements may be temporarily joined together, electronically, in order to increase their sensitivity to touch or usefulness for proximity detection. The sensing elements may be joined as pairs, as threes, or as any number in any combination. All sensing elements of a touch sensor may be joined together, if necessary, to make a more sensitive proximity sensor. Such an arrangement may be capable of detecting a hand as it approaches the touch sensor.

Two advantages of using the “single ended” sensing techniques described above are the simplicity of manufacture that it can provide for, and that an embodiment of the invention may have no connections (that is, be free of external connections) on three of its four sides.

Alternatively, “double ended” sensing elements can be provided; where connections are provided between a sensing element and the TPDU at different positions along the sensing element. Terminating the sensing element at both, opposite ends can provide advantages over single ended termination. For example, double ended termination may provide a more accurate and faster determination of the position of a finger compared to single ended termination sensors. Another advantage of using double ended sensing is the improved ability to sense two or more fingers on a single sensing element.

However, touch pads that use double termination may require more complicated manufacturing processes than those that have only single ended termination. In double terminated touch pads, two sides, at least, of the touch screen (or sensing elements) have terminals, as opposed to single ended termination where only one side of the touch screen (or sensing elements) has any terminals.

In a basic implementation of a sensor utilising the double ended method, one end of the sensing element may be left floating while the other end is being sensed by the TPDU. This arrangement may result in the sensing element appearing to be terminated at a single end. As such, all the features described under single ended termination can be deployed in double ended termination touch pads.

FIG. 20 illustrates a circuit 2000 comprising a TPDU 2001 and a sensing element 2002. The sensing element has a first output end (left, pa) 2012 and a second output end (right, pb) 2014. The TPDU 2001 is connected to the sensing element 2002 at the first output end 2012. The sensing element 2002 is coupled to the ground at the second output end 2014.

Grounding can occur through a resistor 2030 as shown in FIG. 20, or by direct termination to ground. The resistor 2030 enables some sensing to occur right up to the far end of the sensing element, if the total resistance of the sensing element is not too high. Termination directly to ground (without a resistor) may mean that no measurable sensing can occur right at the far end of the sensing element adjacent to the second output end (right, pb) 2014.

The ground coupling (via the resistor 2030) has the effect of preventing the sensing element giving a negative reading once the null point has been passed. In fact, the sensitivity slope (the touch signal against resistance setting curve described above) is quite different from the single ended termination case as there is no easily defined null point.

FIG. 21 illustrates the touch signal against position along the sensing element for the circuit configured as in FIG. 20. The touch signal linearly decreases from a positive value towards zero as a finger is moved from the first output end 2012 to the second output end 2014; the sensitivity of the sensing element appears to slowly fade away as a function of position along its length.

FIG. 22 illustrates a circuit 2200 comprising a TPDU 2201a and a sensing element 2202. In circuit 2200, the sensing element 2202 is coupled to the TPDU 2201 at both the first output end 2212 (left, pa) and the second output end 2214 (right, pb).

The first output end 2212 (left, pa) and the second output end 2214 (right, pb) are coupled to a connection point multiplexor 2238 that selects one of the output ends to be coupled to a touch signal generator 2201b which is similar to that of FIG. 3. In this way a plurality of connection points is provided.

In this example the electrical property of the sensing element 2202 is presented at one of a plurality of connection points that are each disposed at different positions along the length of the sensing element. Each of the connection points represents a different attenuation setting. The TPDU is configured to set the attenuation setting to a plurality of different attenuation settings by sequentially selecting different connection points using the connection point multiplexor 2238.

The TPDU input comprises a first input 2232 and a second input 2234, each of which is coupled to the respective first output end 2212 or second output end 2214 of the sensing element 2202. The first input 2232 and the second input 2234 can be coupled to one another using a single pole single throw analog switch. If closed, then this would allow sensing of both ends at the same time. Normally, however, this switch will be left open. The first input 2232 and the second input 2234 are coupled to a (double pole double throw switch) connection point multiplexor 2238 that selectably couples the first input 2232 to the input of the touch signal generator 2201b while the second input 2234 is connected to ground. Subsequently, the second input 2234 is connected to the input of the touch signal generator 2201b while the first input 2232 is connected to ground. The connection between the switch 2238 and the ground can be via a resistor 2242. Alternatively, the ground can be replaced by an active back plane signal. A significant improvement in finger detection can occur if the end of a sensing element that is not being sensed is connected to an active backplane signal through the resistor 2242.

In this example, an electrical property of the sensing element is presented at one of a plurality of connection points that are each disposed at different positions along the length of the sensing element. Each attenuation setting is associated with one of the connection points. The TPDU is configured to set the attenuation setting to a plurality of different attenuation settings by selecting different connection points.

One way to create an active backplane signal is to pass the sensed signal from the sensing element 2202 through a high speed unity gain, non-inverting amplifier/buffer 2244, a shown in FIG. 22. The buffer 2244 has an input that is coupled to the input of the touch signal generator 2201b. The output signal from the buffer 2244 is identical to the sensing signal, but is not sensitive to touch.

The active backplane resistor 2242 sets up an impedance divider circuit such that a fairly linear sensitivity response occurs along the length of the sensing element with the sensitivity at the active backplane end being determined by the ratio of the active backplane resistor to the resistance of the sensing element. If Rf is about 2 kohms, the sensing element is about 10 kohms, and the active backplane resistor 2242 is about 1 kohms, then the sensitivity at the active backplane end is about 10% of that at the sensing end (see FIGS. 24 and 25). That is, a touch signal for a given touch would be 10 times stronger at the sensing end than the opposite end.

By sensing at a first output end 2212 of the sensing element 2202, while a second end 2214 is connected to the active backplane through a resistor, and then sensing at the second output end 2214 of the sensing element 2202 while the first output end 2212 is connected to the active backplane, an improved estimate can be made of the position of the finger anywhere between the two ends 2212, 2214. Operating in this way can be considered as moving a null position from beyond one end of the sensing element to beyond the other end of the sensing element.

Both ends of the sensing element may be joined together, by electronic control switch 2236, to act as an extra sensitive sensing element. Such a sensing element can be used to detect the proximity, but not the position along the sensing element, of a finger. This arrangement may alternatively be used to provide a more accurate interpolation between two adjacent sensing elements. Once a finger has been detected, the circuit can be changed to detect the position of the finger from one end of the sensing element at a time. This may be done by a number of different means as disclosed herein.

Sensing, in the circuit 2200 of FIG. 22, may occur from alternate ends of the sensing element 2202. The first output end 2012 of the sensing element 2202 may be left at a floating potential while the opposite, second output end 2014 of the sensing element 2202 is used for sensing the position of the finger. The situation may then be reversed and the second output end 2014 of the sensing element 2202 may be left at a floating potential while the opposite, first output end 2012 of the sensing element 2202 is used for sensing the position of the finger. This alternating end method enables the verification of the results obtained by cross checking the two readings. The alternating end method also helps overcome the problem caused by difficulties in determining the position of two fingers when a weak touch occurs at the furthest end away from the sensor input. By switching the end of the sensing element used for sensing, a weak touch can then be sensed from the output end nearest the sensing input.

As with the floating method described above, grounding can be provided at alternate ends of the sensing element (see FIG. 22), assisting verification of results measured from the opposite end, and enabling fingers to be detected near both ends of the sensing element.

The methods described with reference to FIG. 23 do not require the variable resistor element of the TPDU of FIG. 3 in order to detect only one finger. If more than one finger is to be detected, however, then the variable resistor element will facilitate the detection of a plurality of fingers. It will be appreciated that a variable resistor element, such as that described above with reference to FIG. 3, can be provided, for example, between the sensing element 2202 and the touch signal generator 2201b of FIG. 22. The TPDU may then be configured to set the attenuation setting to a plurality of different attenuation settings by selecting a different connection point and/or a different resistance setting.

FIG. 23 illustrates a touch signal against position profile along the sensing element of the touch pad of FIG. 22. In this profile, the end that is not connected to the TPDU is left floating. FIG. 23 is similar to FIG. 2.

FIG. 24 illustrates the touch signal against position profiles for two touch strengths, (T and 2T) of a finger F1. The finger F1 is present at a position 2401 around ⅓ of the way along the sensing element from the first output end 2412 (left, pa). The touch element is connected to the TPDU at its left hand side. The right hand end is connected to the active backplane signal through a resistor.

A weak touch profile 2402 linearly decreases from a positive value to a lower positive value between the first output end 2412 and the second output end 2414. The touch signal due to the finger F1 at the position 2401 of the finger F1 is indicated at a first weak point 2404. A strong touch profile 2403 linearly decreases from a positive value to a lower positive value between the first output end 2412 and the second output end 2414. The touch signal due to the finger F1 at the position 2401 of the finger F1 is indicated at first strong point 2405. The strong touch profile 2403 has a higher touch signal than the weak touch profile 2402 at every position along the sensing element.

FIG. 25 illustrates touch signal against position profiles for two touch strengths of a finger. The finger F1 is present at a position 2501 that corresponds to the position of the finger F1 in FIG. 24. The touch sensing element is connected to the TPDU at its right hand side in FIG. 25, rather than at the left hand side as in FIG. 24. An extremity along a length of a sensing conductor that is not connected to the TPDU may be referred to as an “unsensed end” of the sensing conductor. In this example, the left hand end of the sensing element is an unsensed end that is connected to an active backplane signal through a resistor.

A weak touch profile 2502 linearly increases from a positive value to a higher positive value between the first output end 2512 and the second output end 2514. The touch signal due to the finger F1 at the position 2501 of the finger F1 is indicated at a second weak point 2504. A strong touch profile 2503 linearly increases from a positive value to a higher positive value between the first output end 2512 and the second output end 2514. The touch signal due to the finger F1 at the position 2501 of the finger F1 is indicated at a second strong point 2505. The strong touch profile 2503 has a higher touch signal than the weak touch profile 2502 at every position along the sensing element.

If finger F1 is positioned exactly at the centre of the sensing element then the touch signals measured from alternate first and second output ends of the sensing element would be identical, assuming that the resistivity of the sensing element is uniform. In the example illustrated in FIGS. 24 and 25, the touch signal measured from the left end is greater than the touch signal measured from the right end (about 8 to 6 is this example), thus indicating that the position of the finger F1 is left of the centre of the sensing element. The ratio remains the same regardless of whether the touch is weak or strong. This enables the position of the touch to be determined accurately, with one measurement taken from the left end and another measurement taken from the right end, the ratio of the two measurements being used to calculate the touch position. The measurement of one finger only does not need the TPDU. The TPDU could, however, be used to determine the position of the finger by methods previously described.

Instead of connecting the unsensed end of the sensing element to the active backplane signal, it could be left floating, or connected to ground through a resistor. Such arrangements may, however, produce less accurate results than the example shown in FIG. 22 where the unsensed end is connected to the active backplane through a resistor.

If the positions of two or more fingers are to be accurately measured, then the TPDU method can be used.

FIGS. 26 and 27 show how a first finger F1 and a second finger F2 can be detected using a resistance sweep of a variable resistor element added to the circuit 2200. The resistance sweep can be used to show where each of the two fingers is situated. FIG. 26 shows measurements taken from the left side and FIG. 27 shows measurements taken from the right side.

The horizontal, position axis relates to various null positions that correspond to variable resistor element resistance settings A (in the top diagrams), and D and E (in the bottom diagrams). When sensed from either end of the sensing element with a resistance setting of A, both fingers F1, F2 are detected simultaneously as illustrated by the top plots in FIGS. 26 and 27. Such a result could indicate that there may be one very large finger in the centre of the sensing element, or that several fingers are present. By a process identical to that described for FIG. 8, measurements taken from the left end can be used to show that there are two fingers present and identify their associated touch positions and touch strengths. Such results can be confirmed, and improved by taking another set of measurements from the right end. The lower graphs of FIGS. 26 and 27 show the results for resistor settings D and E only. Extrapolated lines on FIGS. 26 and 27 are plotted in the same way as those in FIG. 9.

Although the measurements shown in FIGS. 26 and 27 could be made with the unsensed end of the sensing element left floating, or connected to ground through a resistor, the accuracy of such measurement may be improved by having the unsensed end connected to the active backplane signal.

In a similar manner to finding the position of two fingers on one sensing element, it is possible to find the position of three or more fingers (as described for FIGS. 16 and 17)

FIG. 28 shows a touch pad 2800 similar to that of FIG. 18. The touch pad 2800 is composed of 10 sensing elements 2801-2810, side by side, forming a two dimensional array. Each of the elements 2801-2808 can be individually connected, usually one at a time, to a detector circuit via conductive track and a touch pad connector 2811. The sensing elements 2801-2810 each have a first output end 2812 and a second output end 2814. The sensing elements can be used as a touch screen or touchpad, capable of detecting the position of many fingers that are touching the screen at the same time.

Each sensing element 2801-2810 in this example is capable of detecting the position of at least two fingers, so the touch screen illustrated is capable of detecting at least 20 fingers simultaneously.

The touch pad 2800 also comprises first and second grounded conductors 2815, 2816. The first grounded conductor 2815 is situated on one side of the sensing elements 2801-2810 and coextends with the sensing elements 2801-2810. The second grounded conductor 2816 is situated on an opposite side of the sensing elements 2801-2810 and coextends with the sensing elements 2801-2810.

The hatched area of FIG. 28 represents the second sensing element 2802 being sensed. Readings may be taken from both the first output end 2812 of the second sensing element 2802 (left end) and then from the second output end 2814 (right end).

In this example, the first sensing element 2801 and the ninth sensing element 2809 each have one finger touching them (zeroth finger F0 and ninth finger F9, respectively). The third sensing element 2803 has two fingers (first finger F1 and second finger F2) finger touching it. The sixth sensing element 2806 has three fingers (fourth finger F4, fifth finger F5 and sixth finger F6) touching it. The fourth sensing element 2804 and the fifth sensing element 2805 have one finger (third finger 2803) touching the junction between them.

When the fourth sensing element 2804 and the fifth sensing element 2805 are sampled, each will show a weak touch at the position of the touch of the third finger F3. The TPDU, which may be implemented as a microprocessor, can be configured to interpret the fact that the signals from the fourth sensing elements 2804 and the fifth sensing element 2805 are weak, and that the positions of the detected ‘fingers’ F3 along the fourth and fifth sensing element 2804, 2805 are identical, as being indicative of a single finger touching the touch pad between the fourth sensing elements 2804 and the fifth sensing element 2805. The relative strengths of these signals can be used to interpolate more precisely how far the third finger F3 overlaps the fourth sensing element 2804 and how far it overlaps the fifth sensing element 2805. In this way, the precise position of the third finger F3 between the fourth sensing elements 2804 and the fifth sensing element 2805 can be calculated.

The eighth sensing element 2808 has two fingers touching it (seventh finger F7 and eighth finger F8). One of these fingers (seventh finger F7) also overlaps with the seventh sensing element 2807. The TPDU (or processor) can readily determine the position of the seventh and eighth fingers F7, F8 on element 2808 and the touch position of the weak touch of the seventh finger F7 on the seventh sensing element 2807. When the TPDU determines that the position of one of the fingers touching the eighth sensing element 2808 is identical to the position of seventh finger F7, and that both signals are relatively weak, then the TPDU can determine that these touches are both due to the same seventh finger F7. The position of the seventh finger F7, between the seventh and eighth sensing elements 2807, 2808, can be accurately determined by interpolating between them using the determined relative touch signal for the finger F7 on each of the seventh and eighth sensing elements 2807, 2808.

Errors may occur occasionally in some implementations. For example, the TPDU may misinterpret two side-by-side fingers that touch two neighbouring sensing elements at the same time as a single finger positioned between the two sensing elements. If both of the signals related to each of the sensing elements are weak, then the processor may decide that they are due to a single finger touching a position between the two elements. If both of the signals from the respective fingers are strong, then the processor may decide that the signals are representative of two fingers. Ambiguous readings can be resolved by using historical measurement data. If two distinct fingers have previously been detected and/or tracked by the TPDU, then the TPDU can calculate predicted trajectories of the fingers based on their previous trajectories. If the predicted trajectories of the fingers come together at a single point, then the TPDU may determine that two fingers are present when a strong reading is detected around the expected position. If however, only one finger has previously been determined to be coming to the expected position, then the processor may decide that there is only one finger that is touching the touchpad between two sensing elements.

The touch pad of FIG. 28 may be constructed from sensing elements 2801-2810 comprising ITO, supported by a polyester film base as in FIG. 3. The sensing elements 2801-2810 might be encapsulated within a top protective layer of polyester. Each ITO sensing element 2801-2810 may be connected to the connector 2811 by screen printed conductive silver tracks. The tracks overlap the ITO sensing elements 2801-2810 to ensure good electrical contact. During sampling, the sensing elements that are not being sampled may be connected to ground. An effect of this is that most sensing elements are sensed when both of their neighbouring sensing elements are grounded. The first and tenth sensing elements 2801, 2810 only have one neighbouring element, so a “dummy” grounded element 2814, 2816 may be used. The outer two grounded elements 2814, 2816, which are not used for touch sensing, are connected to ground, to ensure good shielding of the outermost sensing elements 2801, 2810. If this additional shielding is not provided, then the first and tenth sensing elements 2801 and 2810 would have a different capacitive environment to the inner sensing elements 2802-2809.

FIGS. 29 to 34 show a number of other different possible implementations of sensing elements. These are not the only possible embodiments, however. It will be appreciated that there too many possibilities to list herein.

FIG. 29 shows a touch pad 2900 where the sensing elements 2901-2908 comprise fine, resistive wire. The wire could be made of a number of different elements or alloys. Nichrome is a suitable material for some applications. Nichrome wire has a fairly high resistivity of about 20,000 ohms per metre when drawn to 10 microns diameter. Features that have been described with reference to other drawings will not necessarily be described again here.

The touch pad 2900 comprises a number of continuous wires of Nichrome, running from the connector 2910 through a sensing zone 2916 and back again to the connector 2910. The portion of each wire within the sensing zone 2916 provides a sensing element 2901-2908. A first output end 2912 of a sensing element is connected to the connector 2910 via a first portion 2918 of the wire. A second output end 2914 of a sensing element is connected to the connector 2910 via a second portion 2920 of the wire. The second portion 2920 of the wire extends around a periphery of the touch pad from the second output end 2914 of a sensing element to the connector. The arrangement of the touch pad 2900 has the advantage that there are no connections within the screen, apart from at the connector 2910. A disadvantage of such an arrangement is that the position of a finger touching the central line of the screen is at different lengths away from the connector, at the top of the screen, than it is at the bottom of the screen. When a finger touches the centre of the first sensing element 2901 the resistance of the wire, as measured at the connector, is about twice that of a finger touching the centre of the eighth sensing element 2908. This problem can be alleviated by calibrating the position of fingers touching the screen before use. Once a calibration has been undertaken it will not vary, and so one set of calibration measurements may be used for a batch of identical or similar products.

FIG. 30 shows a touch pad 3000 similar to that of FIG. 29. In touch pad 3000 the wire that comprises each of the sensing elements has a zig-zagged portion. The zig-zagged portion of a sensing element increases both the proportion of the sensing zone 3016 occupied by a sensing element, and the total resistance of the sensing element. This concentrates a greater proportion of the total length of resistive material in the resistive zone (sensing area) than the arrangement of FIG. 29.

FIG. 31 shows a touch pad that uses individual carbon fibres as sensing elements. The sensing zone comprises eight sensing elements 3101-3108, each comprising a carbon fibre, that runs parallel to its neighbour. At the first input end 3112 of the sensing elements 3101-3108, the fibres are connected to conductive tracks, such as screen printed silver or graphite conductive tracks 3120, which terminate at the connector 3110. At the second output end 3114 of the sensing elements, pairs of fibres are connected together by another conductive portion. The first sensing element 3101 is coupled to the fifth sensing element 3105 via a first conductive portion 3021. The second sensing element 3102 is coupled to the sixth sensing element 3106 via a second conductive portion 3122. The third sensing element 3103 is coupled to the seventh sensing element 3107 via a third conductive portion 3123. The fourth sensing element 3104 is coupled to the eighth sensing element 3108 via a fourth conductive portion 3124. In this example two sensing elements are connected together and the pair is sensed as though it is one sensing element. This has the advantage that the number of connector terminations is reduced compared to the touch pad of FIG. 29. A disadvantage is that the number of fingers that can be sensed at any one time may be reduced in some implementations of the circuit. Instead of sensing the carbon fibres in pairs the carbon fibre sensing elements may be individually sampled. Each element 3101-3108 being connected to conductive tracks that terminate at the connector 3110.

FIG. 32 shows a touch pad 3200 similar to that of FIG. 29, in which several carbon fibres are joined together in parallel to provide each of the sensing elements 3201-3208. Providing multiple carbon fibres in parallel reduces the overall resistance of a sensing element compared to an implementation where each sensing element consists of a single carbon fibre. The arrangement illustrated in FIG. 32 also increases the proportion of the sensing zone 3216 that is occupied by each sensing element 3201-3208. Carbon fibres typically have a resistivity of about 10,000 ohms per inch (approximately 4,000 ohm per centimetre). Three similar fibres connected together in parallel have a combined resistivity of a third of the resistivity of a single fibre. In generally, providing ‘n’ similar fibres in parallel reduces the resistivity by a factor of ‘n’.

It will be appreciated that a wide range of conductive materials may be used to provide the sensing elements of FIG. 31 or 32.

FIG. 33 shows a wire touch pad 3300 where the sensing elements 3301-3308 are connected to a connector 3310a at the first output end 3312. In the arrangement shown in FIG. 33, the wire order as viewed from the top to the bottom of the touch pad 3300 is: first sensing element 3301 (1A), second sensing element 3302 (2A), third sensing element 3303 (3A), fourth sensing element 3304 (4A), fifth sensing element 3305 (4B), sixth sensing element 3306 (3B), seventh sensing element 3307 (2B), eighth sensing element 3308 (1B). The sensing elements are coupled together in pairs at the second output end 3314. The first sensing element 3301 is coupled to the eighth sensing element 3308. The second sensing element 3302 is coupled to the seventh sensing element 3307. The third sensing element 3303 is coupled to the sixth sensing element 3306. The fourth sensing element 3304 is coupled to the fifth sensing element 3305. The pairs of sensing elements are, in fact, a single sensing element in which each sensing element is used twice, being looped back on itself, so that all of the wires are provided to the connector 3310a at the (left) first output end 3312 only.

This example demonstrates that a single uninsulated wire can be used to make a touchscreen without the requirement to cut tracks or provide electrical connections (except at the connector 3310a).

The arrangement illustrated in FIG. 33 may encounter problems related to ambiguous identification when sensing several fingers using a combination of the fourth and fifth sensing elements 3304, 3305, where the wire directly loops back on itself. The problem can be alleviated, however, by providing a grounded wire 3305a between the fourth and fifth sensing elements 3304, 3305, reducing cross coupling between the two halves of the combined sensing element. Historical reading can also be used to aid decision making in this or a similar situation.

Grounded wires 3302a-3308a can be permanently interleaved between the sensing elements 3301-3308. Grounded wires 3301a, 3309a are also provided on the outside of the outermost sensing elements 3301, 3308. The grounded wires 3301a-3309a are looped back on themselves to avoid wires crossing each other and causing a possible short circuit. If the wires 3301a-3309a are coated with an insulating material, such as enamel for example, then a simpler arrangement can be used that allows wires to cross over each other.

FIG. 34 shows a touch pad 3400 in which sensing elements 3401-3408 are joined together in pairs. The sensing elements 3401-3408 may comprise ITO. A substrate, or support membrane of the touch pad 3400 may comprise polyester. The arrangement of the sensing elements 3401-3408 in FIG. 34 is similar to that illustrated in FIG. 31, and will not be discussed further here.

Each of the pairs of sensing elements, or combined sensing elements can be sensed one end at a time, but all elements are only ever sensed from the left end. The sensing elements can be sensed in the order 1A, 2A, 3A, 4A, 1B, 2B, 3B, 4B. A combined sensing element is formed of a first half and a second half. Each half of a combined sensing element is separated by three other sensing elements so that any cross coupling is reduced or avoided.

For example, FIG. 34 shows the second sensing element 3402 (2A) and the sixth sensing element 3406 (2B), which are joined, being sensed. This sensing is depicted by the shading of these sensing elements 3402, 3406 in FIG. 34. Three other sensing elements 3403, 3404, 3405 (3A, 4A, 1B) are provided between each half of this combined sensing sensing element (2A, 2B). That is, between the second sensing element 3402 (2A) and the sixth sensing element 3406 (2B). These three sensing elements 3403, 3404, 3405 (3A, 4A, 1B) may be grounded during the sensing of the combined second and sixth sensing elements 3402, 3406 and so there is very little cross coupling between the respective second and sixth sensing elements 3402, 3406.

The relatively high resistance of ITO can restrict the maximum possible size of a touch screen. Usually, sensing elements have to be less than about 10,000 ohms, otherwise some parts of the touch screen become much less sensitive than other parts. Some embodiments of the present invention take advantage of the relatively high resistance of ITO and other materials, and can, therefore, be used to make very large touch screens. Sensing elements with resistances in the range of 1,000 ohms to 100,000 ohms are ideal. This enables thinner coats of ITO to be used, which has the advantage of improving transparency and reducing the amount of ITO required.

An ITO conductor can fracture if it is rolled up too tight. Fracture of the ITO conductor can cause a touch screen to malfunction permanently. Many materials, other than ITO, can be used as the sensing material, such as very fine wire. When laminated into a supporting film, these touch screens can be rolled up and even creased without causing damage or loss of functionality.

The resistance of ITO changes over time. The change in resistance can lead to a need to recalibrate the screen regularly. In contrast, fine wires of many other conducting materials, such as copper or tungsten, do not change their resistance significantly over time and so will not require recalibration.

Features of the invention may be found in the following statements.

A single elongated touch sensing element, made of electrically conductive material, capable, when one end is connected to an appropriate electronic circuit, of sensing the proximity and accurate position of one or more fingers through an insulating protective coating, anywhere along the element's length.

A single elongated touch sensing element, made of electrically conductive material, capable, when two opposite ends are connected to an appropriate electronic circuit, of sensing the proximity and accurate position of one or more fingers through an insulating protective coating, anywhere along the element's length.

An array of linear touch sensing elements, placed side by side, made of electrically conductive material, each element being capable, when one end of each element is connected to an appropriate electronic circuit, of sensing the proximity and accurate position of one or more fingers through an insulating protective coating, anywhere along each element's length.

An array of linear touch sensing elements, placed side by side, made of electrically conductive material, each element being capable, when two opposite ends of each element are connected to an appropriate electronic circuit, of sensing the proximity and accurate position of one or more fingers through an insulating protective coating, anywhere along each element's length.

The means of detection may be projected capacitance. The means of detection may be mutual capacitance. The means of detection may be inductance.

The touch sensing element may be indium tin oxide (ITO). The touch sensing element may be a single carbon fibre.

The touch sensing element may comprise any one or more of a range of electrically conductive materials, including, for example, iron rods, copper cables or wires, graphite or silver print, graphene, conductive gels, printed circuit traces, Nichrome wire, tungsten wire, aluminium wire, salt water, sintered metal oxides.

The electrically conductive element may comprise ITO. The electrically conductive element may be supported on a clear polyester film. The electrically conductive element may be covered by a layer of glass. All of the conductive elements may be connected to an electronic controller capable of scanning every element. The controller may be further configured to detect and track a plurality of fingers touching the top surface of the glass simultaneously.

The electrically conductive element may be a Nichrome wire, supported on a clear polyester film, and covered by a second clear polyester film. All of the conductive elements may be connected to an electronic controller capable of scanning every element and detecting and tracking many fingers touching the top surface of the polyester film at any one time. The film may be capable of being mounted behind a sheet of glass, for detection through the glass, or unmounted, providing a multiple touch sensing product capable of being folded or creased without loss of functionality.

A multi-touch touch screen, manufactured using a single layer of ITO coated polyester, may be provided in a variety of length scales, with diagonal screen measurements ranging from 10 mm to several metres.

The following description of the invention and its background is also provided.

### BACKGROUND

There are several problems with manufacturing multitouch touchscreens using Indium Tin Oxide(ITO).

1/there is the need for several layers, one in the x direction and another in the y direction, making manufacture relatively complex.
2/the relatively high resistance of ITO, restricts the size of screen to relatively small sizes. Sensing elements have to be less than about 10,000 ohms, otherwise some parts of the touchscreen become much less sensitive than others.
3/ITO touchscreens suffer from the problem that the ITO conductor fractures if it is rolled up too tight. This would cause the touchscreen to malfunction permanently.
4/ITO changes it's resistance over time, leading to a need to recalibrate regularly. This invention overcomes these problems in a number of different ways.
1/This invention uses only one layer, having an x layer, but no y layer, greatly simplifying manufacture on a roll to roll basis.
2/This invention takes advantage of the high resistance of ITO and other materials, and can, therefore, be used to make very large touchscreens. Sensing elements with resistances in the range of 1000 ohms to 100,000 ohms are ideal. This enables thinner coats of ITO to be used, which has the advantage of improving transparency and reducing the amount of ITO required.
3/Many materials, other than ITO, can be used as the sensing material, such as very fine wire. When laminated into a supporting film, these touchscreens can be rolled up and even creased without damage, or loss of functionality.
4/Most fine wires do not change their resistance significantly over time and so, will not need recalibration.

It is possible to have a hybrid ITO touchscreen which has both x and y sensing elements, to determine the x and y co-ordinates of a finger, but also uses various features of this patent, to allow very large ITO touchscreens to be used, where the high resistance of ITO is an advantage and not a problem.

The present document describes a single layered, proximity sensing element, composed of an electrically conductive material, which can detect the proximity and position of one or more fingers, or other objects, anywhere across its width, normally, though not always through a protective coating, and where a number of these elements, side by side can be used to form a two dimensional, single layered touchscreen, or touchpad, capable of detecting the position of many fingers at the same time, terminated along one edge only, or along two opposite edges.

The conductive material may be any one or more of a wide range of good, or poorly conducting materials, including Indium Tin Oxide, graphite impregnated plastic, fine silver or graphite traces, very fine wire, individual carbon fibres, nanowires, graphene, conductive gels, or liquids, etc.

The protective coating, which is also normally an insulator, may be plastic, thin or thick glass, paper, ceramic, concrete, etc.

The sensing element may be self supporting, but will normally have a supporting base, which is a non-conductor. This may be polyester film, paper, glass, ceramic, concrete etc.

The supporting base and the protective coating may be the same material, if the sensing element is completely encapsulated by it.

This method may be used for self or mutual capacitive sensors.

Unless otherwise specified, any reference to “touch” in the following text, refers to touching the top, protective coating, or very close proximity to the sensing element, but without directly touching the sensing element itself.

### The Single Ended Method.

Using the example of a Capacitive touch sensor deploying projected capacitance deploying the self capacitance technique; FIG. 1 shows a single strip of poorly conductive material, (possibly, for example, 10,000 ohms over its length) supported on a non-conducting base material. The sensing element is connected at one end to the input of a simple Resistor/Capacitor (RC) oscillator circuit. The frequency of oscillation is mainly dependent on the value of the feedback resistor (Rf) and the capacitance of the sensing element (SE). If a finger approaches, but does not touch, the sensing element, the capacitance of the sensing element increases, causing a drop in the frequency of the oscillator. This change in frequency can be used to indicate the proximity of the finger.

This detection method is known as time domain measurement. Other methods may also be used, such as frequency domain measurement, where a fixed frequency is used, and the change in impedance measured, usually by measuring an increase, or decrease in current.

FIG. 2 shows that the signal detected by the RC oscillator, measured by the amount by which the frequency drops as the finger approaches the sensing element, is dependent on the resistance of the sensing element at that point. A finger approaching the end nearest the connection to the RC oscillator, point pa, gives a greater reduction in frequency, than a finger at the far end of the sensing element, point pb. When the resistance of the sensing element is about ten times the resistance of the feedback resistor in the oscillator circuit (Rf), the finger can no longer be detected. At resistances greater than this, however, the finger causes the oscillator to increase in frequency. This effect gives us a sharp “null” point, where the frequency is neither to decreased, or increased, by the approach of the finger. At the “null” point, the oscillator runs at the same frequency, irrespective of whether a finger is present or absent.

If a fairly large degree of error is acceptable, or, if it is possible to ensure that a standard touch will always be used, then it is possible to detect the position of the finger with just one measurement.

Otherwise, it is impossible to tell exactly where the finger is by using a single measure of oscillator frequency. A finger, lightly touching the sensing element, will give a small change in frequency, whereas, a finger, heavily pressing the sensing element, at exactly the same position will cause a larger change in oscillator frequency. A finger, lightly touching the sensing element at pa (FIG. 1), will cause a larger change in frequency than a finger heavily pressing the sensing element at pb.

However, the position along the sensing element where the finger cannot be detected, the “null” point, is independent touch strength.

This invention takes advantage of this fact by moving the “null” point across the sensing element until a finger, that has already been detected, can no longer be detected. If we know where the “null” point is, when the finger is no longer detectable, then, paradoxically, we know where the finger is.

The “null” point can be moved, simply by inserting different resistors into the sensing line, between the sensing element (SE) and the oscillator.

FIG. 1 shows a sensing element with a resistance that is about ten times the resistance of the feedback resistance in the RC oscillator (Rf). The “null” position for detecting a finger is at point pb. If, however, a resistance, similar in value to the sensing element, (10×Rf) were introduced into the line between the sensing element and the RC oscillator, then the “null” position would be moved to position pa. Values lower than 10×Rf would cause the “null” point to be somewhere between points pb and pa. It is, therefore, possible to move the “null” point anywhere along the sensing element by introducing a suitable resistor into the sensing line.

(The value 10×Rf, is based on the results found with a 10 inch long single Carbon Fibre, connected to a 555 oscillator circuit, running at 4 volts. This value will vary to some extent depending on the circuit and materials used).

FIG. 3 shows a simplified circuit for inserting resistors into the sensing line electronically. The sensing element (SE) is shown surrounded by a conductive grounded plane shield, which, although not absolutely essential, helps focus touch sensing to the area immediately along the sensing element. This helps alleviate the bias caused by left or right handedness of the operator. It also reduces interference from neighbouring electronic devices, such as electronically noisy displays.

Initially, the analog multiplexor (in FIG. 3) is set to position A, causing no resistors to be inserted into the sensing line. This allows the processor to detect a finger anywhere along the sensing element, due to the resistance of the sensing element being much less than ten times the feedback resistor value.

After the processor has detected the finger, the processor sequentially sends control signals to the analog multiplexor causing the multiplexor to introduce various resistors into the sensing line, until a value is found that gives minimal, or no change, in oscillator frequency compared with the situation when no finger is present.

The value of this resistor shows the position along the sensing element where the finger is situated.

If, for example, the sensing element(in FIG. 3) has a resistance of 5×Rf, and a resistor value of 5×Rf is introduced into the sensing line, the total resistance will now be 10×Rf, so the null point will be at the far right end of the sensing element, point pb. If a finger were at the far end of the sensing element, it would have been readily detectable before the resistor was introduced but would now be undetectable. If the finger had been anywhere else along the sensing element, say half way along, it would still be detectable, although the signal strength would have been diminished.

By successively selecting analog positions, A, B C, D, E, F and finally G, inserting various equal value resistors into the sensing line, equally spaced positions would be selected along the sensing element. If a “null” point occurs for any one of these settings, then it is known that this is where the finger is. Selecting analog position G introduces a total resistance of 10×Rf into the sensing line, and so, moves the “null” point to the very front end of the sensing element, point g.

As is common for projected capacitance, before testing for the presence of a finger, a frequency value for each analog switch setting, when no fingers are present, may have to be read and stored away for reference. This value may have to be regularly updated, to take account of any drift caused by environmental variations. Later readings are compared with these values to see if there is any change caused by the presence of a finger.

FIG. 3 shows positions along the sensing element that correspond to settings on the analog multiplexor. Point b corresponds to analog setting B, point c corresponds to analog setting C, d to D, e to E, f to F, and g to G.

FIG. 3 shows a finger (F1) “touching” the sensing element near its centre point. FIGS. 4 and 5 show that this finger, can readily be detected when analog position B is selected. When analog position C is selected, the signal strength is weaker, but, the finger is still detectable. Analog position D still shows some signal, but it is smaller than position C and much smaller than position B. By the time the analog multiplexor selects position E, the finger no longer causes a decrease in frequency of the oscillator, indicating that the finger is somewhere between D and E on the sensing element. Position E, in fact, shows a decrease in signal strength, showing that the “null” point has been passed.

(FIG. 5 is derived from FIG. 4. FIG. 5 shows the signal strength measured for finger F1 compared with where the “null” point would be for the resistor value chosen. Analog switch setting B, has a null point at b, but the signal strength for F1 is about 6.5, in the example. So, a point indicating a value of 6.5 on the vertical axis, is plotted at b, along the horizontal axis. The same procedure is applied to analog settings C, D E etc., creating a curvilinear plot which goes through the zero signal strength line. This is the “null” point for the finger F1, and indicates it's position along the sensing element. The angle of slope of this line (Angle 1) indicates the strength of touch of finger F1.)

The sensing element/oscillator arrangement may be precalibrated, so that it is known which analog multiplexor settings correspond exactly to which points on the sensing elements.

The position of a finger can be determined by a minimum of two readings, and extrapolating these values through to the zero signal strength line. If the two readings are slightly either side of the “null” point, one positive and the other negative, then the position of the finger can be determined by interpolating between these two points.

FIG. 5 shows, that, just by measuring analog positions B and C, (shown within the dotted circle), it is possible to extrapolate the finger position to being near position E. This is irrespective of the strength of touch, as shown in FIG. 7. Positions B and C still extrapolate to near position E. If D and E were the only two reading taken, then position D would give a positive reading for the finger, and E would give a slightly negative reading. Interpolating between these two readings would indicate the position of the finger. This would give a small amount of error, however, as the plot becomes more curved when the readings become negative.

Although FIG. 3 shows six resistors that can be inserted in the sensing line, in practice many more can be used, or a continuously variable resistor may be used. This gives higher precision, when determining the position of the finger, and makes it easier to distinguish between different fingers when there are many fingers on the sensing element. It also enable the processor to “home-in” on the exact position of the finger, instead of relying on interpolation or extrapolation.

As an alternative to varying the resistance of the sensing line, the “null” position may be moved by varying the value of the feedback resistor in the oscillator circuit, Rf, or by varying both Rf and the series resistors. Varying Rf, however, causes very large changes in the oscillator frequency, whereas varying the series resistance has only a slight effect on the oscillator frequency.

### Detecting Two, or More Fingers.

If two fingers are “touching” the screen at the same time, the signal strength measured is the sum of the signal strengths for each finger separately.

FIGS. 8 to 15, show the signal strengths for two fingers; two strong touches (FIGS. 8 and 9), a strong touch near the left end and a weak touch near the right end (FIGS. 10 and 11), a weak touch near the left end and a strong touch near the right end (FIGS. 12 and 13), and two weak touches (FIGS. 14 and 15).

FIGS. 8 and 9 show the signal strengths for two strong touches (T2) at different locations on the sensing element at the same time. When scanned by the analog multiplexor, for various series resistors A, B, C, D, E, F and G, a plot of signal strength is produced that shows a distinct change of slope at a point between C and D. This point, where the slope changes, indicates the position of finger (F2). The point, where the slope cuts through the line representing zero change in the signal strength, indicates the position of the other finger (F1). The two angles of slope indicate the strength of touch for each of the fingers. Angle 1 indicates the strength of touch for finger F1, and Angle 2 indicates the strength of touch for finger F2.

When both fingers are beyond the “null” point, their negative values continue to be added together.

Due to the fact that readings become negative when a finger is beyond the “null” point, a small error is introduced into the measurements, causing a small error in determining the position of the finger. Finger F1 is measured to be at position F1?, and finger F2 is measured to be at position F2?.

This error can be overcome by determining the exact shape of the plot when a single finger is touching the sensing element, and taking into account the negative values and non-linearity when a finger is beyond the “null” point.

FIGS. 10 and 11 show plots for a similar situation to that just described, but where the second finger (F2) is a weak touch (T) instead of a strong touch. As before, the position of both fingers is indicated, but there is less error for finger F1. This is due to the fact that finger F2 is weak, and so creates only a weak error, due to its negative value beyond its “null” point. Angle 2 is also smaller in FIG. 11 than it is in FIG. 9, indicating that F2 is a weak touch in FIG. 11, whereas it is a strong touch in FIG. 9. Due to the fact that finger F2 is a weak touch at the far right end of the sensing element, it may be difficult to detect exactly where the angle of slope changes

In FIGS. 12 and 13, the finger near the left end (F1) is a weak touch(T), and the finger near the right end(F2) is a strong touch(2T). FIG. 13 again shows a similar plot to that of FIG. 9, except that Angle 1 is much smaller in FIG. 13, and there is significantly more error between the real position of finger F1 and its measured position. This error is caused by the fact that finger F2 is a strong touch, and creates a relatively strong negative when it is past its “null” position. This negative value is added to the readings for finger F1, causing a relatively large error. The fact that Angle 1 is small reflects the fact that finger F1 is a weak touch. Angle 2 is large reflecting the fact that finger f2 is a strong touch.

FIGS. 14 and 15 are identical to the situation for FIGS. 8 and 9, except that both fingers F1 and F2 are weak touches. Angles 1 and 2 are both small, showing that both fingers are weak touches. Again, it is possible to determine the positions of both fingers, but with more accuracy than the situation where both fingers are strong touches. This is due to the fact that finger F2 does not create such a strong negative value as it does in FIG. 9, because in FIG. 15, F2 is a weak touch, whereas in FIG. 9, F2 is a strong touch.

### Why Detect Two Fingers?

One important reason for needing to detect two fingers, is to determine when two fingers are spreading apart, or closing together.

FIG. 7 shows the plot for a single strong touch. This could also be two fingers, very close together. FIG. 15 shows the plot for two fingers spread apart.

The two plots are very different from each other and would readily be detected by the host processor. If the host processor detected a plot similar to that of FIG. 7, changing to a plot similar to that of FIG. 15, then the processor could easily determine that two fingers had spread apart.

Likewise, if the plot changed from that of FIG. 15 to that of FIG. 7, then the processor could determine that two fingers had drawn together.

Similar techniques, to those described for two fingers, can be applied for three or four, or more fingers, since, the signal strength measured is still the sum of all of the individual signal strengths for each finger. Three fingers (FIG. 16) will cause three slopes to be seen, as shown in FIG. 17, the point at which the slopes change, or cross the zero line, indicating the position of the individual fingers. Four fingers will cause four slopes, etc. Errors will also accumulate, however, so extra vigilance will be needed so that these are taken into account. The greatest error source is the accumulation of negative values when fingers are past their respective “null” points.

### Alternative Method for Detecting Multiple Fingers.

Another method, for detecting the position of more than one finger at a time on the sensing element, relies on one of the fingers touching the sensing element before the other. Once the first finger touches the sensing element, its position can be found. The microprocessor remembers that a finger is already touching the sensing element, stores away its position, and then treats this state as though there were no fingers touching it. When the second finger touches the sensing element, its position can then be determined, as though it was the only finger there. This second finger can move about and still have its movement tracked accurately, but the first finger has to remain static. This process can be repeated for any number of fingers, leading to the possible detection of three or more fingers on the one sensing element at the same time.

The down side to this method, is that the first finger always has to remain in a fixed position. If it moved, the processor would detect a very strong negative reading for the first fingers position, and, depending on how it was programmed, possibly cause a reset to occur.

Another down side is that, the spreading apart, or closing together of two fingers is usually symmetrical, whereas, in this method, one of the fingers has to remain static while the other moves.

### Use of Multiple Sensing Elements.

FIG. 18 shows several sensing elements placed side by side to form a two dimensional array of proximity sensing elements. Each element can be individually connected, usually one at a time, to a detector circuit (FIG. 19).

With reference to the simplified diagram of FIG. 19, the 8 way connector plugs into the connector of FIG. 18. Analog multiplexor 1, of FIG. 19, connects one sensing element at a time to the input of the RC oscillator. This connection is routed through either no resistors, or a range of resistors by analog multiplexor 2. The feedback resistor for the RC oscillator is selected by analog multiplexor 3. Multiplexor 3 matches the value of the feedback resistor (Rf) to the resistance of the sensing elements (see Table 1). This multiplexor is not necessary if the resistance value of each of the sensing elements is already known, in which case a suitable resistor for Rf can be preselected and directly wired in.

In operation, each of the sensing elements is selected, one at a time, by multiplexor 1, starting at sensing element 1A, and interrogated by the microprocessor, via analog multiplexor 2, to detect if one or more fingers is present along that sensing element. If so, their positions are found by the process described previously. Once that input has been interrogated, multiplexor 1 moves onto sensing element 2A, and the interrogation to find the position of any fingers is repeated. This process continues until all sensing elements (up to 8A) have been interrogated for the presence of fingers, after which, the complete process is starts again at 1A, and the process is repeated continuously.

In this way, it is possible to detect the position of many fingers touching the screen at the same time. If each sensing element can detect the presence of two fingers, and there are eight sensing elements, then it is possible to detect the position of up to sixteen fingers touching the screen at the same time. Some fingers may be touching between two sensing elements, but the microprocessor will be able to detect this and interpolate the position of the finger between adjacent sensing elements, by known means.

The sensing elements may be scanned, one at a time, in a linear or non-linear sequence. Usually only one element is sensed at any one time, due to interference between neighbouring sensing elements. Sensing elements may, however, temporarily (or permanently) be joined together in adjacent pairs, or threes, or more, to reduce the resistance of the combined sensing elements and increase sensitivity. One standard touchscreen could then be used which can electronically select whether it has high resolution for working through thin glass, or lower resolution for working through very thick glass.

Non-selected inputs are shown (in FIG. 19) connected to ground. This helps focus touch along the sensing element being sensed, reduces bias caused by left or right handedness, and helps prevent interference by neighbouring, non-selected, sensing elements, and any electrically noisy equipment that may be nearby. It may also allow several sensing elements to be sensed at the same time, so long as there is sufficient grounding between them to prevent interference. One RC oscillator may be required for every input sensed at the same time, so, in a simple circuit such as FIG. 19, to sense three inputs at once may require three RC oscillators. More sophisticated circuits could, however, eliminate this requirement.

Although not shown in FIG. 19, there may be permanent grounded tracks between the sensing elements, similar to that shown in FIG. 3.

### Use of Historical Measurements to Aid Decision Making.

Historical measurements from neighbouring sensing elements may be used to determine the positions of one, two, or more fingers on a particular element, if other measurements are indecisive or ambiguous.

If a finger has already been tracked moving along a certain path, then it is likely that it will continue to follow that path. This information can then be used to help validate an indecisive reading on an element in the way of that path.

Likewise, if a very strong reading is made for a finger, then, it is possible that it might alternatively be two fingers very close together. Historical readings may show that two fingers were converging on that position, confirming that the reading is, in fact, for two fingers. It might be, however, that only one finger was moving towards that position, making it more likely than not, that the measurement is for only one finger.

### Types of Materials Used.

FIG. 19 shows an arrangement that may use Indium Tin Oxide (ITO) as the sensing elements, these elements possibly being supported on a polyester film base. Any permanently grounded elements may also be made of ITO. The sensing elements and support material can, however, be made of a wide range of alternative materials. Some of the sensing element materials are listed in Table 1.

Problems with Very Highly Resistive Conductors.

If carbon fibre is used as the sensing element, it will have a high resistance. A ten inch length will have a resistance of about 100,000 ohms. The use of non sensed sensing elements for grounding will mean that the grounding at the end of the sensing element furthest away from the input to the oscillator will be weaker than it is at the end nearest the oscillator, the grounding being through 100,000 ohm carbon fibres at the far end, but through only a small fraction of that at the oscillator end. Several carbon fibres may be used, in parallel, to reduce the effective resistance.

The sensing element should still work well under these conditions, but, grounding could be improved by placing less resistive wires between the carbon fibres, and grounding these. An equivalent length of Nichrome, or Tungsten wire, for example, could be used. A ten inch length of ten micron diameter Tungsten wire has a resistance of about 200 ohms. This is about 500 times lower than a ten inch carbon fibre.

### Grounding.

Grounding does not necessarily connecting direct to ground, it may be connecting to a fixed voltage, or a floating voltage. In some situations, it may mean connecting to a varying signal, such as an active backplane signal or even an anti-active backplane signal.

If the sensing mechanism does not involve a change in frequency, or, if there is plenty of grounding between them, several sensing elements may be sensed at the same time, thereby speeding up the time taken to scan a complete touchscreen. Alternative circuits to the Schmitt oscillator circuit may, however, be used requiring different resistor values. There are many methods for doing this but they are not as simple as the method using the RC oscillator.

Although all the diagrams show the sensor strips as horizontal, they may be at any angle.

Sensing strips may be temporarily joined together, electronically, to increase their sensitivity to touch, or proximity detection. They may be joined as pairs, as threes, or in any combination, including all being joined together, if necessary, to make a very sensitive proximity sensor, detecting a hand as it approaches the screen.

### Manufacturing.

The sensing film, for a single ended touchscreen is very easily manufactured, at very low cost, on a reel to reel basis, with parallel conductive strips of ITO, or parallel conductive wires running the whole length of polyester reels, possibly 100 metres long. These reels can be cut up later into individual touchscreen sizes, and a screen printed conductive silver, or graphite, connector added. The product is finished by covering with a protective polyester film, or laminating direct onto a sheet of glass.

### Advantages/Disadvantages of Single Ended Termination.

Two advantages of using single ended sensing are simplicity of manufacture and a product that has no connections on three of its four sides.

The touch sensing material is readily manufactured reel to reel, with terminations added during final stages of manufacture.

Two disadvantages of using single ended sensing are lower accuracy and more restricted ability to sense two or more fingers on the one sensing element.

### The Double Ended Method.

Sensing elements can be terminated at opposite ends with many advantages over single ended termination. Many of the techniques used in single ended termination, however, may be deployed with double ended termination.

Both ends may be joined together, under electronic control (FIG. 21), to act as an extra sensitive sensor, to detect the proximity, but not the position along the sensing element, of a finger. (This may be used, however, to give more accurate interpolation between two adjacent elements). Once a finger has been detected, the circuit can be changed to detect the position of the finger. This may be done by a number of different means.

At its simplest, one end may be left floating. This will result in the sensing element appearing to be terminated as a single ended device. As such, all the features described under single ended termination can be deployed.

Sensing may occur from alternate ends, with one end floating and the opposite end sensing, followed by the opposite end sensing while the first end floats. This enables verification of the results obtained, by cross checking the two readings. It also helps overcome the problem caused by difficulties in determining the position of both fingers when a weak touch occurs at the furthest end away from the sensor input. By switching sensing ends, the weak touch is then sensed from the end nearest the sensor input.

The sensing element may be connected to ground at one end, and sensed from the opposite end (FIG. 20). This has the effect of preventing the sensing element giving a negative reading once the “null” point has been passed. In fact, the sensitivity slope is quite different from single ended termination, with no easily defined “null” point. Sensitivity appears to slowly fade away (see FIG. 23).

As with the floating method described above, grounding can occur at alternate ends (FIG. 21), assisting verification of results measured from the opposite end, and enabling fingers to be detected near both ends.

Grounding can occur through a resistor (FIG. 20), or by direct termination to ground. The resistor enables some sensing to occur right up to the far end of the sensing element, if the resistance of the sensing element is not too high. Termination direct to ground (without a resistor) means that no measurable sensing can occur right at the far end of the sensing element.

A significant improvement in finger detection occurs if the end of the sensing element, that is not being sensed, is connected to an active backplane signal through a resistor. One way to create this active backplane signal is to pass the sensing signal through a unity gain, non-inverting buffer/amplifier (FIG. 21). The output signal is identical to the sensing signal, but is not sensitive to touch.

The resistor sets up an impedance divider circuit, such that, a fairly linear sensitivity response occurs along the length of the sensing element, with the sensitivity at the active backplane end being determined by the ratio of the active backplane resistor to the resistance of the sensing element. If Rf is about 2 k, the sensing element is about 10 kohms, and the active backplane resistor is about 1 k, then the sensitivity at the active backplane end is about 10% of that at the sensing end (see FIGS. 24 and 25).

By sensing at one end first, while the other end is connected to the active backplane, and then sensing at the second end, while the first end is connected to the active backplane, a very good estimate can be made for the position of the finger, anywhere between the two ends.

FIGS. 24 and 25 show how the ratio of the signal values for a finger, measured from alternate ends of the sensing element, can be used to determine the position of the finger, no matter how hard the finger presses on the sensing element. If finger F1 was exactly at the centre of the sensing element, the signal strengths measured from alternate ends of the sensing element would be identical. In the example of FIGS. 24 and 25, the strength, measured from the left end, is greater than the signal strength measured from the right end (about 8 to 6 is this example) showing that F1 is left of centre.

Two, or more fingers, touching the same element, can also be measured, using techniques, similar tot those used for single ended termination, but with greater accuracy. The sensitivity graphs, shown in FIGS. 22, 23 and 24, are all slightly different, but can be used in similar manner. Single ended termination has the advantage that the signal has a “null” point, after which the plot becomes slightly negative. This makes it easy to determine where the “null” point is. The signal becoming negative, however, means that a small error is introduced, when two or more fingers are being detected. This error can be compensated for by determining, through earlier single touch resistor sweeps, the exact shape of the negative going plot, and calculating the error out in the microprocessor.

The plot, where one end is grounded, has a similar plot to the situation described above, except that it does not go negative. There is also an error introduced by the non-linearity, at the far end of the sensing element, but this, likewise, can be compensated for, by measuring the exact shape of the slope during earlier single finger detection resistor sweeps, and calculating the error out in the microprocessor.

A similar process occurs where one end is connected to the active backplane through a resistor. Again, the slope is different to each of the two above situations, but it can be measured and the results used to calculate out the error.

Although the slopes for the three methods, floating, grounding, and connecting to the active backplane, are slightly different, they can all be used to find the position of a finger, through the insertion of series resistors.

FIGS. 26 and 27, show how two fingers F1 and F2 can be detected, a resistance sweep used to show where each of the two fingers is situated. When sensed from either end, with a series resistance setting of A, both fingers are detected together. This could signify a very large finger in the centre of the sensing element, or several fingers. When the series resistors are changed, however, it is possible to determine that there are, in fact, two fingers. Two measurements taken from the left end, with series settings D and E show the exact position of finger F1. Similarly, measurements taken from the right end with series settings D and E show the exact position of finger F2.

In a similar manner to finding the position of two fingers on the one sensing element, it is possible to find the position of three or more fingers.

FIG. 28 shows a touchscreen composed of 10 sensing elements, side by side, forming a two dimensional array. This can be used as a touchscreen r touchpad, capable of detecting the position of many fingers touching the screen at the same time. Each sensing element is capable of detecting the position of, at least two fingers, so the touchscreen illustreated is capable of detecting, at least 20 fingers.

The hatched area, shows sensing element 2 being sensed, first from the left end (2A), then from the right end (2B).

Sensing elements 1 and 9 each have one finger touching them (F0 and F9). Element 3 has two fingers (F1 and F2), and element 6 has three fingers (F4, F5 and F6). Element 4 and 5 have one finger touching the junction between them(F3).

When elements 4 and 5 are sampled, each will show a weak touch, at the appropriate position, along their lengths. The microprocessor will be able to interpret the fact that the signals are weak, and their positions along these elements are identical, that the finger is touching between these two elements. The relative strengths of these signals can be used to interpolate, more precisely, how far the finger overlaps element 4 and how far it overlaps element 5. In this way, the precise position of the finger between the two elements can be calculated.

Element 8 has two fingers touching it (F7 and F8), but one of these fingers(F7) overlaps with element 7. The processor can readily determine the position of the two fingers on element 8, and the position of the weak touch of finger F7 on element 7. When the processor determines that the position of one of the fingers touching element 8 is identical to the position of finger F7, and that both signals are relatively weak, then it may determine that these are the same finger. Its position, between the elements 7 and 8, can be accurately determined by interpolating between them using the relative signal strengths for this finger on each element.

Errors may occur occasionally, misinterpreting two fingers, side by side, touching two neighbouring elements at the same time, as one finger sited between these two elements. If both signals are weak, then the processor may decide that they are one finger touching between the two elements. If both signals are strong, it may decide that they are two fingers. This ambiguity may be alleviated by using historical measurements. If two fingers had previously been tracked, and calculated to be coming together at this point, then the processor will decide that they are two fingers. If however, only one finger had been calculated to be coming to this position, then the processor will decide that there is only one finger, and that it is touching between the two sensing elements. FIGS. 29 to 34 show a number of different possible implementations of this technology. These are the only embodiments, however, as there too many possibilities to list in this patent.

FIG. 28 may be constructed from sensing elements of ITO, supported by a polyester film base. This might be encapsulated within a top protective layer of polyester. Each ITO element is connected to a connector by screen printed conductive silver tracks. These tracks overlap the ITO to ensure good electrical contact. The outer two elements, which are not used for touch sensing, are connected to ground, to ensure good shielding when sensing elements 1 and 10. If this shielding was not there, then sensing elements 1 and 10 would be sensed in a different capacitive environment to elements 2 to 9. This is because, during sampling, non-sensed elements may be connected to ground, so most elements are sensed when both of their neighbouring elements are grounded. Elements 1 and 10, only have one neighbouring element, so a “dummy” grounded element may be used instead.

FIG. 29 shows a touchscreen where the sensing material is fine resistive wire. The wire could be made of a number of different elements or alloys. Nichrome has a fairly high resistance of about 20 thousand ohms per metre, when drawn to 10 microns diameter.

A touchscreen could be made from this, using one continuous wire, running from the connector, through the sensing zone, and back again to the connector. This has the advantage that there are no connections, apart from at the connector. A disadvantage is, that, the position of a finger touching the central line of the screen, is at different lengths away from the connector, at the top of the screen, than it is at the bottom of the screen. When touching the centre of element 1 (in FIG. 29), the resistance of the wire, from there to the connector, is about twice that when touching the centre of element 8.

This problem can be alleviated by calibrating the position of fingers touching the screen beforehand. Once a calibration has been undertaken, however, the one calibration may be used for a run of any identical products.

FIG. 30 shows how the wire in a screen may be zig-zagged, to increase both its sensing area, and its resistance. This concentrates the resistive zone, more effectively than the arrangement of FIG. 29, into the touch sensing area.

FIGS. 31 and 32 show two touchscreens that use individual Carbon Fibres as the sensing elements.

In FIG. 31, a single fibre is used for each sensing element. These fibres are connected to screen printed conductive silver or graphite tracks which terminate at the connector. This examples shows, however, that two sensing elements can be connected together and sensed as though they are one sensing element. This has the advantage that the number of connector terminations is reduced, but at the expense of the number of fingers that can be sensed at any one time.

FIG. 32 shows how several Carbon Fibres can be joined together, in parallel, to reduce their resistance, and increase their sensing area. Carbon Fibres have a resistance of about 10 thousand ohms per inch. Three fibres connect together, in parallel, reduce this to about 3 thousand three hundred ohms per inch.

FIG. 33 shows a wire touchscreen, where grounded wires are permanently interleaved with sensing wires. This figure shows wires looped back on themselves to avoid wires crossing each other and causing a possible short circuit. If enamel coated wires are used, then a simpler arrangement can be used which allows wires to cross over each other. Each sensing element is used twice, being looped back on themselves, so that all the wires are connected at the left end only. In the arrangement shown in FIG. 33, the wire order is 1A, 2A, 3A, 4A, 4B, 3B, 2B, 1B. Wires 4A and 4B are the same sensing element by looped back so that each half is next to the other half. This could cause a problem, when sensing several fingers on this element, or sensing a finger placed between the two elements. The problem is alleviated, however, by the fact that there is a grounded wire between the two halves, reducing cross coupling between the two halves. The sensing element is capable of sensing several fingers at the same time, so, if a finger is placed between the two parts of the sensing element, two weak touches will appear to be detected on the one element. The position of these will be interpreted by the microprocessor as a touch between the two parts of the sensor if their individual positions match this situation. Historical reading can also be used to aid decision making in this situation.

FIG. 34 shows a touchscreen, possibly made of ITO supported by polyester, in which the sensing elements are joined together in pairs. The figure shows 2A and 2B and 2B being sensed, one end at a time, but all elements are only ever sensed from the left end. These elements are sensed in the order 1A, 2A, 3A, 4A, 1B, 2B, 3B, 4B. Each half sensing element is separated by three other sensing elements from its other half, so the problem, described for the arrangement in FIG. 33, does not exist. FIG. 34 shows sensing element 2 being sensed. Three other sensing elements are between each half of this sensing element. As each of these three elements (3A, 4A, 1B) are grounded at this time, there is very little cross coupling between parts 2A and 2B of sensing element 2.

### Advantages/Disadvantages of Double Ended Termination.

### Advantages

More accurate, and speedier determination of the position of a finger.

### Disadvantages.

More complicated manufacturing process than single ended termination.

Two sides, at least, of the touchscreen have terminals, as opposed to single ended termination where only one side of the touchscreen has any terminals, leaving three sides free of terminals.

### Single Element, Single Ended.

A single elongated element, made of electrically conductive material, capable, when one end is connected to an appropriate electronic circuit, of sensing the proximity and accurate position of one or more fingers, or other conductive objects, anywhere along its length.

With Grounding on One Side

A single elongated element, made of electrically conductive material, capable, when one end is connected to an appropriate electronic circuit, of sensing the proximity and accurate position of one or more fingers, or other conductive objects, anywhere along its length, a conductive grounded element running along one side of the element, but electrically isolated from it.

### With Grounding on Both Sides

A single elongated element, made of electrically conductive material, capable, when one end is connected to an appropriate electronic circuit, of sensing the proximity and accurate position of one or more fingers, or other conductive objects, anywhere along its length, with conductive grounded elements running along both sides of the element, but electrically isolated from it.

### Sensing Through Insulator

A single elongated element, made of electrically conductive material, capable, when one end is connected to an appropriate electronic circuit, of sensing the proximity and accurate position of one or more fingers, or other conductive objects, anywhere along its length, through an insulating coating.

### Multiple Elements, Single Ended.

An array of elongated elements, placed side by side, made of electrically conductive material, each element being capable, when one end of each element is connected to an appropriate electronic circuit, of sensing the proximity and accurate position of one or more fingers, or other conductive objects, anywhere along each element's length, through an insulating coating.

### With Grounding

An array of elongated elements, placed side by side, made of electrically conductive material, each element being capable, when one end of each element is connected to an appropriate electronic circuit, of sensing the proximity and accurate position of one or more fingers, or other conductive objects, anywhere along each element's length, through an insulating coating, with conductive, grounded, elements being placed between each sensing element.

### Multiple Elements Sampled at the Same Time

An array of elongated elements, placed side by side, made of electrically conductive material, each element being capable, when one end of each element is connected to an appropriate electronic circuit, of sensing the proximity and accurate position of one or more fingers, or other conductive objects, anywhere along each element's length, through an insulating coating, means being provided to sense one or more elements at the same time.

### Scanning Mechanism

An array of elongated elements, placed side by side, made of electrically conductive material, each element being capable, when one end of each element is connected to an appropriate electronic circuit, of sensing the proximity and accurate position of one or more fingers, or other conductive objects, anywhere along each element's length, through an insulating coating, means being provided to sense one or more elements at a time, in a sequence, until all elements have been sensed.

### Grounding Unsensed Elements

An array of elongated elements, placed side by side, made of electrically conductive material, each element being capable, when one end of each element is connected to an appropriate electronic circuit, of sensing the proximity and accurate position of one or more fingers, or other conductive objects, anywhere along each element's length, through an insulating coating, means being provided to sense one or more elements at a time, while other unsensed elements are grounded.

### Joining Elements Together

An array of elongated elements, placed side by side, made of electrically conductive material, each element being capable, when one end of each element is connected to an appropriate electronic circuit, of sensing the proximity and accurate position of one or more fingers, or other conductive objects, anywhere along each element's length, through an insulating coating, means being provided to join various elements together and sense as one element.

### Double Ended—One End Grounded

One end of each sensing element may be connected to an appropriate electronic sensing circuit. The other end of each sensing element may be connected to a fixed voltage or ground through a resistor.

### One End Connected to the Active Backplane Signal

One end of each sensing element may be connected to an appropriate electronic sensing circuit The other end of each sensing element may be connected to the active backplane signal, through a resistor.

### Both Ends Sensing, Alternately

Both ends of each sensing element may be connected to an appropriate electronic sensing circuit. One end of the sensing element at a time can be used to sense, while the other end is either left floating, connected to a fixed voltage or ground, or connected to an active backplane signal through a resistor.

### Both Ends Sensing at the Same Time

Both ends of each sensing element can be electronically connected together and sensed as one sensing element. The combined sensing element can be very sensitive.

### Use of Projected Capacitance

The means of sensing may be projected capacitance.

### Measurement by Ratio

The position of a finger may be calculated as a ratio of two readings, one reading taken from each end of the sensing element.

### Use of Series Resistors

The means of detecting the position of the fingers can rely on the insertion of one of a range of resistors in the sensing line.

### Changing the Rf Value in the RC Oscillator

The means of detecting the position of the fingers can rely on changing the feedback resistor value in the RC oscillator circuit.

### Use of Series Resistor and Varying the Rf Value

The means of detecting the position of the fingers can rely on the insertion of a range of resistors in the sensing line and changing the feedback resistor value in the RC oscillator circuit.

### Use of Two or More Measurements to Find the Position of a Finger

At least two readings can be made, from at least one end of a sensing element, the series resistor being different for each measurement, in order to determine the position of a finger, anywhere along the length of the sensing element.

### Use of at Least 2×N Measurements to Find the Position of N Fingers

At least twice as many readings can be made as there are fingers to detect in order to determine the position of those fingers anywhere along the length of any one sensing element. The positions of individual fingers may be determined by mathematical procedures undertaken by the microprocessor.

### Use of Extrapolation and Interpolation

The position of a finger may be determined by extrapolation along a line formed from at least two measurements, or interpolated between at least two measurements.

### Use of Sensing Elements Sensed at Both Ends but Connected at One Side Only

Each individual sensing element may be bent back on itself. Sensing may be from one side of the sensing element only.

### Use of Multiple Elements to Detect the X-Y Co-Ordinates of Multiple Fingers

A touchscreen, or touchpad, where the positions of multiple fingers may be accurately determined on each one of many individual parallel conductive sensing strip elements, placed side by side in one direction only, forming a touch sensing area, where measurements are dependant on the sensing elements having a reasonably high resistance value, the results being interpreted by the microprocessor as the x/y co-ordinates of many individual, accurately positioned fingers placed anywhere over the whole touch sensing area.

### Use of ITO on Polyester

A touchscreen made of a single layer of many parallel tracks of ito, running in one general direction only, supported on a clear plastic film, or a sheet of glass, where the positions of multiple fingers may be accurately determined on each one of the many individual sensing elements, the results being interpreted by the microprocessor as the x, y co-ordinates of many individual, accurately positioned fingers.

### The Use of a Single Wire

The conductive sensing elements may be a fine wire.

### Use of Nichrome

The fine wire may be Nichrome.

### Zig_Zagging Wires

The fine wire may be zig-zagged in the touch sensing area.

### Use of Carbon Fibres

A touchscreen made of a single layer of many individual parallel carbon fibres, running in one general direction only, supported on a clear plastic film, or a sheet of glass, where the positions of multiple fingers may be accurately determined on each one of the many individual sensing elements, the results being interpreted by the microprocessor as the x, y co-ordinates of many individual, accurately positioned fingers.

### Parallel Carbon Fibres

Two or more carbon fibres may be joined together to be sensed, in parallel, as one sensing element.

### Interleaved Grounded Carbon Fibres

Carbon fibres may be interleaved between sensing elements. Carbon fibres may be permanently connected to a fixed voltage or ground.

### Parallel Interleaved Grounded Carbon Fibres

Two or more carbon fibres may be joined together in parallel to act as one grounding element.

### Interleaved Grounded Wire

Fine wires may be interleaved between sensing elements. The fine wires may be permanently connected to a fixed voltage or ground.

### Looped Back Grounded Wires

The wires may be looped back on themselves.

### A Range of Sensing Materials

The conductive sensing elements may be any one, or more, of a wide range of conductive materials, including indium tin oxide, graphite impregnated plastic, fine silver or graphite traces, very fine wire, individual carbon fibres, nanowires, graphene, conductive gels or liquids, etc.

### A Range of Support Materials

A wide range of support materials may be used including polyester film, paper, glass, ceramic, concrete etc.

### A Range of Insulating Overlay Materials

A wide range of protective overlay materials may be used including plastic, thin or thick glass, paper, ceramic, concrete, etc.

### Inductance

The sensing means may be inductance.

1.-61. (canceled)

62. A self-capacitive touch pad comprising an electrically conductive wire sensing element which extends in a first direction and has a minimum electrical resistance of 10 ohms along its length in the first direction, wherein the touch pad is configured to determine one or more positions of one or more fingers along the length of the sensing element, the touch pad further comprising an insulator positioned between the wire element and the finger when in use.

63. The touch pad of claim 62 wherein a touch position of a finger is determined by sensing from both ends alternately.

64. The touchpad of claim 63 provided with means to calculate the touch position by comparing a ratio of the results from measurements taken at both ends of the sensing element.

65. The touch pad of claim 62 wherein the sensing element loops back on itself such that the sensing element is arranged with no electrical connection at an extremity in the first direction.

66. The touch pad of claim 62 wherein the sensing element is configured to present an electrical property associated with one or more touch properties of the one or more fingers, the touch pad further comprising a touch position determining unit, TPDU, configured to:
set an attenuation setting to a plurality of different attenuation settings;
generate a plurality of touch signals, wherein each of the plurality of touch signals is generated in accordance with the electrical property at a different attenuation setting; and
determine one or more of the touch properties using the plurality of touch signals.

67. The touch pad of claim 66 comprising a variable resistance unit, wherein the sensing element is a resistive sensing element, wherein each touch property comprises a touch position, wherein each attenuation setting of the TPDU is associated with a resistance setting of the variable resistance unit, and wherein the TPDU is configured to:
determine the number of touch positions using a differentiation of the plurality of touch signals, or corrected touch signals calculated using background touch signals associated with each of the respective attenuation settings, with respect to the different resistance settings; and
determine one or more of the touch properties of the number of touches using the plurality of touch signals.

68. A touch pad of claim 62 wherein the touch pad comprises a plurality of sensing elements that each extend in a first direction and are displaced from one another in a second direction, wherein the plurality of sensing elements is provided in a single layer.

69. The touch pad of claim 68 wherein the plurality of sensing elements are the only sensing elements of the touch pad.

70. The touch pad of claim 68 wherein each sensing element is configured to present an electrical property indicative of a first direction coordinate of the touch position when that element is proximal to the touch position.

71. The touch pad of claim 70 wherein the electrical property is an impedance of the respective sensing element.

72. The touch pad of claim 68 wherein the first direction is perpendicular to the second direction.

73. The touch pad of claim 68 wherein each of the plurality of sensing elements is associated with a single second direction coordinate of the touch position.

74. The touch pad of claim 68 wherein the plurality of sensing elements are each displaced from one another in the second direction along an entirety of their length in the first direction.

75. The touch pad of claim 68 wherein each sensing element is configured to present an electrical property in accordance with a plurality of touch positions, each touch position associated with a different finger.

76. The touch pad of claim 62 wherein the sensing element has a minimum electrical resistance of 100 or 1000 ohms along its length in the first direction.

77. The touch pad of claim 62 wherein the sensing element has an insulating coating.

78. The touch pad of claim 68 comprising one or more shielding elements that each extend in the first direction and are disposed between the plurality of sensing elements, wherein the one or more shielding elements are coupled to ground, a fixed potential, an active backplane signal or an anti-active back plane signal.

79. The touch pad of claim 68 wherein the sensing elements comprise, or can alternatively act as, a shielding element.

80. The touch pad of claim 62 wherein the sensing element is arranged to be connected to a fixed potential, a varying potential or ground at an extremity in the first direction.

81. The touch pad of claim 63 wherein the end not being sensed is: connected to an active backplane signal through a resistor; connected to ground through a resistor; or left electrically floating.

82. The touch pad of claim 62 wherein the sensing element comprises a zig-zagged portion.
